(19) United States
(12) Patent Application Publication
(10) Pub. No.: US 2019/0073238 A1
(43) Pub. Date: Mar. 7, 2019

(54) SOFTWARE CONTROLLED TRANSPORT AND OPERATION PROCESSES FOR FLUIDIC AND MICROFLUIDIC SYSTEMS, TEMPORAL AND EVENT-DRIVEN CONTROL SEQUENCE SCRIPTING, FUNCTIONAL LIBRARIES, AND SCRIPT CREATION TOOLS

(71) Applicant: NRI R&D PATENT LICENSING, LLC, San Antonio, TX (US)

(72) Inventors: Lester F. LUDWIG, San Antonio, TX (US); Catherine LUK, San Francisco, CA (US); Sulu LALCHANDANI, San Francisco, CA (US); Ying CHEN, San Francisco, CA (US)

(21) Appl. No.: 16/179,849

(22) Filed: Nov. 2, 2018

Related U.S. Application Data
(60) Provisional application No. 62/580,841, filed on Nov. 2, 2017.

(51) Int. Cl. G06F 9/48; G06F 9/30; B01L 3/00

(52) U.S. Cl. CPC G06F 9/48; B01L 3/5027; G06F 9/30072; G06F 9/3017

(57) ABSTRACT

Although most contemporary and envisioned microfluidic systems are entirely passive or have limited control capabilities, future microfluidic systems require detailed sequenced control of valves and other elements. For this software-control of transport and processes for microfluidic systems under the control of temporal and/or event-driven scripts, script authoring and editing, functional libraries, and other development tools for process and configuration control are proposed with intent towards future standardization. Scripts can respond to external inputs and can comprise conditional-logic, temporal-logic, calculations, hierarchical structure, subroutines, macros, multi-thread and parallel execution operations, procedural calls, interrupts, real-time regulatory control calculations, and element resource allocation.

Scripts can be executed by a script reader, responsive to incoming signals and information, to produce temporal control sequences for operating microfluidic devices, emulation hardware, simulation software, process visualization, etc.

Script authoring/editing tools and readers can record and store information, and can interface to with commercial software, systems, languages, and protocols.

### CROSS-REFERENCE TO RELATED CASES

This application claims the benefit of U.S. Provisional Application No. 62/580,841, filed Nov. 2, 2017, which is incorporated herein in their entireties by reference.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### BACKGROUND OF THE INVENTION

### 1. Field of the Invention

The present application pertains to the software-control of fluidic transport and operation processes for microfluidic systems and the related aspects of temporal and event-driven sequence scripting, functional libraries useful in the creation of scripts, and software-based script authoring and editing tools.

### 2. Related Art

There is a great deal of literature on “Micro Total Analysis Systems” (μTAS). The New Renaissance Institute's “Fluidic Microprocessors” and component technologies such as its “Microfluidic Bus” are described in the at least the following U.S. patents and U.S. patent applications, among others:
New Renaissance Institute software-reconfigurable microfluidic system technologies:
   U.S. Pat. No. 9,636,655 “Software-Reconfigurable Conduit and Reaction Chamber Microfluidic Arrangements for Lab-On-A-Chip and Miniature Chemical Processing Technologies”
   U.S. patent application Ser. No. 15/499,767 “General-Purpose Reconfigurable Conduit and Reaction Chamber Microfluidic Arrangements for Lab-On-Chip and Miniature Chemical Processing” (PGP 2017/0225163)
   U.S. patent application Ser. No. 13/815,757 “Removable Fluidics Structures for Microarray, Microplates, Sensor Arrays, and Other Removable Media” (PGP 2014/0274814)
   U.S. patent application Ser. No. 13/761,142 “Microprocessor-Controlled Microfluidic Platform for Pathogen, Toxin, Biomarker, and Chemical Detection with Removable Updatable Sensor Array for Food and Water Safety, Medical, and Laboratory Applications” (PGP 2013/0217598);
New Renaissance Institute software-controlled microfluidic transport bus technologies:
   U.S. Pat. No. 8,032,258 “Multi-Channel Chemical Transport Bus for Microfluidic and Other Applications”
   U.S. Pat. No. 8,606,414 “Multi-Channel Chemical Transport Bus Providing Short-Duration Burst Transport Using Sensors for Microfluidic and Other Applications”
   U.S. Pat. No. 8,812,163 “Multi-Channel Chemical Transport Bus with Bus-Associated Sensors for Microfluidic and Other Applications”
   U.S. patent application Ser. No. 14/335,763 “Multi-Channel Chemical Transport Bus with Bus-Associated Sensors for Microfluidic and Other Applications;”
New Renaissance Institute software-controlled microfluidic chemical synthesis and analysis:
   U.S. Pat. No. 8,734,732 “Chemical Synthesis and Analysis via Integrated, Sequential and Series-Parallel Photochemical and Electrochemical Processes for Microfluidic, Lab-On-A-Chip, and Green-Chemistry Applications”
   U.S. Pat. No. 8,877,143 “Chemical Synthesis and Analysis via Integrated, Sequential and Series-Parallel Photochemical and Electrochemical Processes for Microfluidic, Lab-On-A-Chip, and Green-Chemistry Applications”
   U.S. patent application Ser. No. 14/530,779 “Chemical Synthesis and Analysis via Integrated, Sequential and Series-Parallel Photochemical and Electrochemical Processes for Microfluidic, Lab-On-A-Chip, and Green-Chemistry Applications;”
New Renaissance Institute software-controlled emulation of microfluidic system technologies:
   U.S. Pat. No. 8,560,130 “Software-Controlled Lab-on-a-Chip Emulation”
   U.S. Pat. No. 9,802,190 “Modular computer-controlled multistep chemical processing system for use in laboratory automation or chemical production spanning a plurality of scales”
   U.S. Pat. No. 8,594,848 “Reconfigurable Chemical Process Systems”
   U.S. patent application Ser. No. 15/717,024 “Modular Computer-Controlled Multistep Chemical Processing System for Use in Laboratory Automation or Chemical Production” (PGP 2018/0015463);
New Renaissance Institute software and system development environment:
   U.S. Pat. No. 8,396,701 “Software Systems for Development, Control, Programming, Simulation, and Emulation of Fixed and Reconfigurable Lab-on-a-Chip Devices.”

As a first step towards a standardizable framework for multi-step microfluidic control software that could be used for at least New Renaissance Institute's “Fluidic Microprocessors” and potentially future implementations of envisioned “Micro Total Analysis Systems” (μTAS), the present invention employs the use of scripts for representing multi-step microfluidic control software.

New Renaissance Institute software-controlled of fluidic transport and operation processes for fluidic and microfluidic systems have been presented, for example, in the following New Renaissance Institute patents and patent applications:
U.S. Pat. No. 9,636,655 and U.S. patent application Ser. No. 15/499,767 describe various approaches to and aspects of software controlled multichannel microfluidic systems with cleaning, clearing, drying, and reconfiguration capabilities.
U.S. Pat. Nos. 8,032,258, 8,606,414, and 8,812,163 which describe various approaches to and aspects of software controlled multichannel microfluidic chemical transport busses and related fluidic systems and methods;
U.S. Pat. No. 8,396,701 and pending U.S. patent application Ser. No. 13/757,662 which describe software systems and methods for development, control, programming, simulation, and emulation of fixed and reconfigurable lab-on-a-chip devices;
U.S. Pat. No. 9,636,655 and pending U.S. patent application Ser. No. 15/499,767 which describes software reconfigurable conduit and reaction chamber microfluidic arrangements for lab-on-a-chip and miniature chemical processing technologies;
Pending U.S. patent application Ser. No. 13/761,142 and PCT/US 2013/025002 which describe microprocessor-controlled microfluidic platform for pathogen, toxin, biomarker, and chemical detection with removable updatable sensor array for food and water safety, medical, and laboratory applications;
Pending U.S. patent application Ser. No. 13/815,757 which describes removable fluidics structures for microarray, microplates, sensor arrays, and other removable media;
U.S. Pat. No. 9,994,889 which describes fluidic and microfluidic based cell incubator and cellular culture technologies;
U.S. Pat. No. 9,646,133 and pending U.S. patent application Ser. No. 14/216,420 which describe computer-controlled microfluidic systems and instrumentation for next-step biological signaling network research, disease research, drug discovery, cell biology, and other applications;
U.S. Pat. Nos. 8,560,130 and 9,802,190 which describe systems and methods for emulation of fixed and reconfigurable lab-on-a-chip devices and modular computer-controlled multistep chemical processing systems for use in laboratory automation or chemical production;
U.S. Pat. No. 8,594,848 which describes laboratory-glassware-based reconfigurable chemical process systems, using for example controllable stopcock adapters such as that taught in U.S. Pat. No. 8,734,736 and pending U.S. patent application Ser. No. 12/899,551.
   As mention above, U.S. Pat. No. 8,396,701 describes software systems and methods for development, control, programming, simulation, and emulation of fixed and reconfigurable lab-on-a-chip devices such as those described in U.S. Pat. Nos. 8,606,414; 8,560,130; 9,646,133, 9,636,655; 9,994,889 and pending U.S. patent application Ser. Nos. 13/761,142; 14/216,420; 13/815,757, and related cases.

### 3. Overview of the Invention

Although most microfluidic systems in the literature to date are either entirely passive or have limited process control capability, future microfluidic systems (such as New Renaissance Institute's “Fluidic Microprocessors” and component technologies such as its “Microfluidic Bus”) and longer-term programs such as “Micro Total Analysis Systems” (μTAS) entail the sequenced control of a great number of valves and other controllable entities (motorized or sequenced-pulse pumps, photochemical and optical sensor illumination, thermal processing, sensor measurement capture, active mixer elements, electrochemical electrodes and hardware, sonochemical and surface-acoustic wave elements, etc.) to implement a one-pass or continuous process.

Further, in the case of multiple-use systems supporting repeated operation of one-pass processes on different analysis samples or for repeated batch extraction or synthesis, there can beneficially be fluid-based clearing, gas-based clearing, solvent-based cleaning, solvent-drying operations, and drying operations, and in some cases current process shutdown and new process startup steps.

Additionally, for microfluidic system maintenance, servicing, replacement, or hibernation purposes there can also be similar sorts of sequenced control of many valves and other controllable entities for the purposes of process shutdown, device shutdown, device startup, and process startup steps.

Yet further, in the case of reconfigurable microfluidic systems, there can beneficially be current process shutdown, fluid-based clearing, gas-based clearing, solvent-based cleaning, drying operations, reconfiguration, and new process startup steps.

Accordingly, there is a need for multi-step control software to operate new, evolving, and future software-controllable microfluidics systems. Such software typically would include one or both of time-driven and event-driven capabilities. Time-driven operation initiates one or (likely far) more control operation step(s) to occur “open loop” in a timed sequence. Time-driven operation initiates one or (likely far) more control operation step(s) to occur as a result of a stimulus which can be “open loop” (for example the result of user operation of a control button or sequencing sensor measurements) or “closed loop” (for example the result of regulatory sensor measurements).

Further, such software could be extended to include additional types of (non-step) continuous-time regulator control with non-binary values, for example regulating the brightness of a photochemical or sensor light source in response to sensor measurements.

Additionally, in many situations it can be advantageous for a microfluidic device or system to operate several processes simultaneously. Such multiple processes can be completely independent, be coordinated to some degree, or result from split and join operations. Software models for these can comprise execution threads, UNIX operating system models, parallel processing language commands such as ParDo (“parallel do loop”), and many other known, evolving, and future new programming approaches and frameworks. Many aspects of the points in this paragraph are described in New Renaissance Institute U.S. Pat. Nos. 8,396,701, 9,636,655, and U.S. patent application Ser. Nos. 13/761,142, 13/815,757, 15/499,767.

Such (multi-step and continuous-time regulator) microfluidic control software could be initially provided by manufacturers, but at some point programming libraries and software development environments will become available so that users of the controlled microfluidic systems. There is developing need for users in the field to be able to readily and easily create and/or modify their own custom multi-step microfluidic control software for developing and operating future microfluidic systems (such as New Renaissance Institute's “Fluidic Microprocessors” and component technologies such as its “Microfluidic Bus”) and “Micro Total Analysis Systems” (μTAS). Ideally (informal or formal) standards could be formulated and adopted that are device independent and extensible to incrementally accommodate new features, technologies, and needs. It is also noted that such software could be used to control not only an actual software-controllable microfluidic device (or system comprising multiple software-controllable microfluidic devices) but also in place of that control a software simulation (or system comprising multiple software simulations), an emulation prototype (or system comprising multiple emulation prototype), or any mix-type combination of two or more of actual software-controllable microfluidic device(s), software simulation(s), and/or emulation prototypes. Many aspects of the points in this paragraph are described in New Renaissance Institute U.S. Pat. Nos. 8,396,701, 8,560,130, 8,594,848, 9,802,190, 9,636,655, and U.S. patent application Ser. Nos. 13/761,142 and 13/815,757.

The current invention addresses several aspects of these needs.

### SUMMARY OF THE INVENTION

For purposes of summarizing, certain aspects, advantages, and novel features are described herein. Not all such advantages can be achieved in accordance with any one particular embodiment. Thus, the disclosed subject matter can be embodied or carried out in a manner that achieves or optimizes one advantage or group of advantages without achieving all advantages as taught or suggested herein.

1. Process and Configuration Specification Aspects

In an aspect of the invention, the invention provides for the use of process operating step representation information, for example contained within “process-specification” files, to specify and/or store an actionable process step.

In another aspect of the invention, the invention provides for the use of configuration representation information, for example contained within “configuration-specification” files, to specify and/or store configuration.

2. Script Aspects

In an aspect of the invention, a script can be structured to be purely time-driven, purely event-driven, or a combination of time-driven and event-driven aspects.

In another aspect of the invention, a script can be structured so that the steps are read out and enacted by the system, one after another, at periodic intervals. This type of script can be referred to as “clock-driven.”

In another aspect of the invention, a script can be structured so that the steps are read out and enacted by the system, one after another, for a specific time interval provided in the script for that specific step. This type of script can be referred to as “duration-specified.”

In another aspect of the invention, a script can be structured so that the steps are read out and enacted by the system, one after another, after a specific time delay provided in the script for that specific step. This type of script can be referred to as “delay-specified.”

In another aspect of the invention, a script can be structured so that at least actions taken in at least some of the steps depend on specific conditions, for example ranges of sensor values and/or the value of one or more of outside control signal(s), user interface events, and user interface settings. This type of script, or aspect of a script, can be referred to as “conditional.”

In another aspect of the invention, a configuration-script can be created that includes conditional and/or time-driven reconfiguration events.

In another aspect of the invention, a script could be regarded as a thread in a parallel or multitask system.

In another aspect of the invention, a script could be defined in a way to include multiple threads involved in the operation of a parallel or multitask system.

In another aspect of the invention, a script can include multi-thread and parallel execution operations such as thread-split, thread rejoin/merge, parallel-“Do,” etc.

In another aspect of the invention, scripts could be used as a first step towards a standardizable framework for multi-step microfluidic control software that could be used for at least New Renaissance Institute's “Fluidic Microprocessors” and potentially future implementations of envisioned “Micro Total Analysis Systems” (μTAS), and other advanced microfluidic, sensor array, and chemical process devices.

3. Script Reader Aspects

In an aspect of the invention, scripts can be executed by a script reader.

In another aspect of the invention, the script reader can be responsive to incoming signals and information.

In another aspect of the invention, a script reader can be additionally arranged to receive one or more of incoming control signals from a user interface, incoming actual sensor and status information from an actively-operating microfluidic device, incoming actual sensor and status information from an actively-operating microfluidic emulation system, incoming control signals from a simulation, incoming control signals from another executing process, or incoming control signals from other hardware or software entities.

In another aspect of the invention, the script reader can be responsive to resource allocations.

In another aspect of the invention, script reader can provide resource allocations.

In another aspect of the invention, the script reader produces temporal sequences of control signals for operating microfluidic devices, emulation hardware, simulation software, process visualization, etc.

In another aspect of the invention, the script reader can be responsive to real-time regulatory control calculations.

In another aspect of the invention, the script reader can record and store information.

In another aspect of the invention, the script reader can interface with commercial software, systems, languages, and protocols.

4. “Macro” Aspects

In an aspect of the invention, “macro” control operations can be created and used to operate groups of controllable elements at the same time.

In another aspect of the invention, “macro” control operations can be created and used to operate groups of controllable elements in a time-defined sequence.

In another aspect of the invention, implementations involving “macro” control for operating groups of valves can include provisions for at least one conditional input that can affect the behavior of the group operation by a macro.

In another aspect of the invention, implementations involving “macro” control for operating groups of valves can include provisions for at least one parameter that can affect the behavior of the group operation by a macro.

In another aspect of the invention, “macro” control be implemented in one or more of software, firmware, and/or hard-wired logic.

5. Visualization Aspects

In an aspect of the invention, visualization graphics can be abstract, schematic, representational, or combinations of these.

In another aspect of the invention, visualizations of fluid flows and fluid accumulations that respond directly to only control messages from the script reader can often be stateless (memoryless) and avoid calculations.

In another aspect of the invention, visualization software can include state and calculation so as to graphically convey for example the evolving locations of the heads and tails of fluid flows, the amount of fluids in reaction chambers and reservoirs after flow events, etc.

In another aspect of the invention, a visualization system directly accepts and directly renders from the control message set that would be used to control the particular microfluidic device to be visualized.

In another aspect of the invention, a visualization system receives translated control message produced by a message translator which in turn directly accepts and renders from the control message set that would be used to control the particular microfluidic device to be visualized.

In another aspect of the invention, a visualization system can be arranged to receive actual sensor and status information from an actual microfluidic device that can be operated in parallel from very same control messages, so that the visualization system and actual microfluidic device are simultaneously controlled by the output from the script reader.

In another aspect of the invention, a visualization system can be arranged to receive simulated sensor and status information from a simulation of the same microfluidic device that the visualization system represents, with the simulation system and visualization system operated in parallel from very same control messages, so that the visualization system and simulation system are simultaneously controlled by the output from the script reader.

In another aspect of the invention, a visualization system can be arranged to receive emulated sensor and status information from a hardware emulation of the same microfluidic device that the visualization system represents, with the emulation system and visualization system operated in parallel from very same control messages, so that the visualization system and emulation system are simultaneously controlled by the output from the script reader.

6. Model and Simulation Aspects

In an aspect of the invention, a simulation system can be arranged to receive actual sensor and status information from an actual microfluidic device that can be operated in parallel from very same control messages, so that the simulation system and actual microfluidic device are simultaneously controlled by the output from the script reader.

In another aspect of the invention, a simulation system can be arranged to receive emulated sensor and status information from a hardware emulation of the same microfluidic device that the simulation system represents, with the emulation system and simulation system operated in parallel from very same control messages, so that the simulation system and emulation system are simultaneously controlled by the output from the script reader.

In another aspect of the invention, a simulation system can be arranged to provide simulated sensor and status information to a conditional software and macros provided by the output from the script reader.

In another aspect of the invention, a simulation system can be arranged to provide simulated sensor and status information to a visualization of the same microfluidic device that the visualization system represents, with the simulation system and visualization system operated in parallel from very same control messages, so that the visualization system and simulation system are simultaneously controlled by the output from the script reader.

In another aspect of the invention, outputs of a model or numerical simulation can drive real-time graphical visualizations, auditory indications, etc.

7. Emulation Aspects

In an aspect of the invention, an emulation system can be arranged to receive actual sensor and status information from an actual microfluidic device that can be operated in parallel from very same control messages, so that the simulation system and actual microfluidic device are simultaneously controlled by the output from the script reader.

In another aspect of the invention, an emulation system can be arranged to receive emulated sensor and status information from a simulation of the same microfluidic device that the emulation system represents, with the emulation system and simulation system operated in parallel from very same control messages, so that the simulation system and emulation system are simultaneously controlled by the output from the script reader.

In another aspect of the invention, an emulation system can be arranged to provide measured sensor and status information to a conditional software and macros provided by the output from the script reader.

In another aspect of the invention, an emulation system can be arranged to provide measured sensor and status information to a visualization of the same microfluidic device that the visualization system represents, with the simulation system and visualization system operated in parallel from very same control messages, so that the emulation system and simulation system are simultaneously controlled by the output from the script reader.

8. Simultaneous Multiple-Target Partitioned-Operation Aspects

In an aspect of the invention, a script reader produces a temporal sequence of control signals or control messages directed to two or more cooperating target systems, for example at least two of a microfluidic system, a prototype fluidic system, an emulation of a fluidic system, a model of a fluidic system, a simulation of a fluidic system, a status-depicting visualization of a fluidic system, etc.

In another aspect of the invention, the invention provides for both interfacing with an emulation system and a model and/or numerical simulation.

In another aspect of the invention, part of a process could be emulated and another part could be simultaneously simulated.

In another aspect of the invention, part of a fluidic system under design, review, or analysis can be partially emulated, partially modeled, and partially numerically simulated.

9. Authoring/Editing Tool Aspects

In an aspect of the invention, scripts can be created by authoring/editing tools.

In another aspect of the invention, an authoring tool can use a graphical user interface slider or other input means to set the time duration until a next step is taken in the script.

In another aspect of the invention, a numerical entry field can be used to override or substitute for data entry by graphical user interface slider or slider or other input means.

In another aspect of the invention, an authoring tool can be used to build a script step-by-step.

In another aspect of the invention, an authoring tool can copy an existing step or selected group/range of steps and paste as a next step in the script, appended to the script beginning, or elsewhere in the script.

In another aspect of the invention, an authoring tool can edit or delete any existing step.

In another aspect of the invention, functional libraries can be used in the creation of scripts.

In another aspect of the invention, authoring/editing tools can record and store information.

In another aspect of the invention, authoring/editing tools can interface with commercial software, systems, languages, and protocols.

10. Systems-Level Script Aspects

In an aspect of the invention, a system is enabled and described for software-controlled transport and operation processes for microfluidic systems that comprise a plurality of controllable elements, each of the controllable elements controlled by a control signal, the control signal comprising at least two control values, the system comprising:
A data structure comprising a plurality of data values, each value associated with a particular controllable element from the plurality of controllable elements, the value in the data structure for controlling the control value of a control signal to be generated at a later time,
A first instance of the data structure comprising a first plurality of data values, and a second instance of the data structure comprising a second plurality of data values,
A list (script) of a plurality of instances of the data structure, the list comprising at least the first instance of the data structure and second instance of the data structure, the list further comprising one or both of at least a time value and at least a conditional statement, and
A computational processor for executing an algorithm, the computational processor and algorithm arranged to process the list of pluralities of instances of the data structure and responsive to the list to produce a plurality of control signals for providing to the plurality of controllable elements within the microfluidic system, wherein the computational processor and algorithm are further configured so that the control values comprised by one or more control signals that are associated with an instance of the data structure are responsive to the plurality of data values comprised by that instance of the data structure, and wherein the one or more control signals that are associated with that instance of the data structure begin transmission to the microfluidic device at a time determined by the computational processor and algorithm, the transmission time determination responsive to one or both of the at least a time value and the at least a conditional value.

In another aspect of the invention, the list (script) does not include a time value.

In another aspect of the invention, each instance of at least some of the data structures comprised by the list is associated with a separate individual time value.

In another aspect of the invention, the aforementioned time value represents a time duration from an incoming starting indication.

In another aspect of the invention, the aforementioned time value represents a time duration from time of the transmission of the at least one control signal associated with a previous instance of the data structure in the list and the beginning of the transmission of the at least one control signal associated with a next instance of the data structure in the list.

In another aspect of the invention, the list (script) does not include a conditional statement.

In another aspect of the invention, the aforementioned computational processor and algorithm are arranged to be able to receive and respond to incoming input information.

In another aspect of the invention, each instance of at least some of the data structures comprised by the list is associated with a separate individual conditional statement.

In another aspect of the invention, transmission of at least one control signal associated with an instance of the data structure in the list begins after at least some received input information satisfies the conditional statement associated with that instance of the data structure.

In another aspect of the invention, transmission of at least one control signal associated with an instance of the data structure in the list does not begin until after a time condition responsive to a time value in the list is also satisfied.

In another aspect of the invention, the aforementioned list (script) further comprises temporal-logic.

In another aspect of the invention, the aforementioned list (script) further comprises calculations.

In another aspect of the invention, the aforementioned list (script) further comprises a hierarchical structure.

In another aspect of the invention, the aforementioned list (script) further comprises a subroutine.

In another aspect of the invention, the aforementioned list (script) further comprises a macro operation.

In another aspect of the invention, the aforementioned list (script) further comprises a macro.

In another aspect of the invention, the aforementioned list (script) further comprises a multi-thread operation.

In another aspect of the invention, the aforementioned list (script) further comprises a parallel execution operation

In another aspect of the invention, the aforementioned list (script) further comprises a procedure call.

### BRIEF DESCRIPTION OF THE DRAWINGS

FIG. 1, adapted from FIG. 6b of U.S. Pat. No. 8,396,701, depicts an example comprehensive development environment or system that integrates a specification system, a fabrication design system, a graphical layout system, a graphical rendering system, a numerical simulation system, a software-controlled reconfigurable LoC physical emulation system, a data visualization system, and a control software development system.

FIG. 2, adapted from FIG. 7b of U.S. Pat. No. 8,396,701, depicts an example global view of an example software environment embodiment of an integrated system such as that depicted in FIG. 1.

FIG. 3, adapted from FIG. 14d of U.S. Pat. No. 9,636,655, shows an example of elements and interconnections among elements in a complex microfluidic system that can be arranged to be configured under software control.

FIG. 4a, adapted from FIG. 14 of U.S. Pat. Nos. 8,032,258 and 8,606,414, depicts simple example contiguous flow transport through a simple example transport bus for microfluidic and other applications; the depicted fluidic flow (signified with superimposed heavy line) is enabled by the two open valves at the top of the figure, one of these valves connecting the second-to-left vertical conduit with the top horizonal tapped bus conduit, and the other of these valves connecting the second-to-right vertical conduit with the same top horizonal tapped bus conduit. The many passive “T”-topology junctions throughout the simple example microfluidic bus system are noted.

FIG. 4b, adapted from FIG. 9d of U.S. Pat. Nos. 8,032,258 and 8,606,414, depicts example contamination processes (signified with superimposed dashed heavy lines) resultant from the fluid flow (signified with superimposed heavy line) depicted in FIG. 4a.

FIG. 4c, adapted from FIG. 9a of U.S. Pat. Nos. 8,032,258 and 8,606,414, depicts an example enhanced variation of the chemical transport bus of FIG. 4a wherein additional local valves are added so as to closely surround each “T”-topology junction with three valves, one for each conduit meeting at the 3-way junction point.

FIG. 4d, adapted from FIG. 18b of U.S. Pat. Nos. 8,032,258 and 8,606,414, depicts the example enhanced chemical transport bus depicted in FIG. 4c in the process of transporting two bursts of fluidic material which can transported through the chemical transport bus conduits, for example, by applied controlled propelling gas pressure and/or electrokinetic forces.

FIG. 5 depicts an example transaction-myopic system-level operation of a software controlled chemical transport bus system comprising sequences among five classes of example states, idle, fluid flow, gas-pressure clearing, solvent-based cleaning, and gas-based drying.

FIG. 6 depicts the fluidic system. Operation of the system is sequenced in five classes of states, idle fluid flow, gas-pressure clearing, solvent-based cleaning, and gas-based drying. Input chosen in this example is as follows, unit 2 (U₂) valve-2 is used as a fluid input fed by a reagent or fluidic source, unit 3 (U₁) valve-3 is used as a fluid output to feed a reagent or fluidic destination.

FIG. 7 represents the idle state. In the idle state, all the valves are turned off, no fluid or solvent is flowing, and no gas pressure is applied. The valves that are involved in this example are valve T1, valve T2, U₁ valve-7, U1 valve-8, U₂ valve-7, U₂ valve-2, U₂ valve-8, U₃ valve-7, U₃ valve-3, U₃ valve-8, U₄ valve-7, U₄ valve-8, and valve T4.

FIG. 8 represents the fluid flow state. In the fluid flow state, the fluid flows from one input to an output. In this example, the fluid flows from U₂ valve-2 to U₃ valve-3. Thus, the valves U₂ valve-2, U₂ valve-8, U₃ valve-7, and U₃ valve-3 are turned on to allow the fluid to flow from U₂ valve-2 to U₃ valve-3 during a desired period of time or until a desired quantity of fluid is delivered. After the fluid has been delivered from U₂ valve-2 to U₃ valve-3, the U₂ valve-2 valve is turned off.

FIG. 9 represents an example Gas-Pressure Clearing state. In the Gas-Pressure Clearing state, the gas pressure pushes further the remaining fluid present in the fluidic pathways into the output. In this particular example, the remaining fluid in the fluidic pathways is pushed into the output U₃ valve-3. Valve T1 needs to remain turned off so that the NO and COM are connected, whereas valve T2 valve needs to be turned on so that the NC and COM are connected together. U₁ valve-7, U₁ valve-8, U₂ valve-7, U₂ valve-8, U₃ valve-7, and U₃ valve-3 are turned on while U₂ valve-2, U₃ valve-8, U₄ valve-7, U₄ valve-8, and valve T4 remains turned off.

FIG. 10 represents the solvent-based cleaning state. In the solvent-based cleaning state, the fluidic pathways are cleaned by allowing a cleaning solvent to flow into the fluidic pathways which are then deposited into the drain. This way, the next fluid flowing from a new input to a new output will flow into clean fluidic pathways without contaminations from the previous fluid flow. In the example, after the gas pressure transports the remaining fluid into U₃ valve-3 output, the valve U₃ valve-3 is turned off so that the solvent-based cleaning state can begin.

FIG. 11 represents the gas-based drying state. In the gas-based drying state, applied gas pressure is used to push and dry the remaining cleaning solvent into the drain as well as drying any volatile components. In order to let the AP flow, T1 valve needs to be turned off so that the NO and COM are connected again. The valve T2, U₁ valve-7, U₁ valve-8, U₂ valve-7, U₂ valve-8, U₃ valve-7, U₃ valve-8, U₄ valve-7, and U₄ valve-8 remain turned on, while the valve U₂ valve-2, U₃ valve-3, and valve T4 remain turned off.

FIG. 12 depicts the fluidic system. In the following example, operation of the system is sequenced through the same five classes of states as the previous example. An example sequence of these classes of states is depicted in FIG. 5. Inputs and outputs are chosen in this example is as follows: Unit 1 (U₁) valve-2 is used as a fluid input fed by a reagent or fluidic source, Unit 3 (U₃) valve-3 is used as a fluid output to feed a reagent or fluidic destination.

FIG. 13 represents the idle state. In the idle state, all the valves are turned off, no fluid or solvent is flowing, and no air pressure is applied. Thus, valves T1 and T2, U₁ valve-7, U₁ valve-2, U₁ valve 8, U₂ valve-7, U₂ valve-8, U₃ valve-7, U₃ valve-3, U₃ valve-8, U₄ valve-7, U₄ valve-8, and valve T4 are all turned off.

FIG. 14 represents the fluid flow state. In the fluid flow state, the fluid flows from one input to an output.

In this example, the fluid flows from U1 valve-2 to U3 valve-3. Thus, the valves U₁ valve-2, U₁ valve-8, U₂ valve-7, U₂ valve-8, U₃ valve-7, and U₃ valve-3 are turned on to allow the fluid to flow from U₁ valve-2 to U₃ valve-3 during a desired period of time or until a desired quantity of fluid is delivered. After the fluid has been delivered from U₁ valve-2 to U₃ valve-3, the U₁ valve-2 valve is turned off.

FIG. 15 represents an example Gas-Pressure Clearing state. In the Gas-Pressure Clearing state, the gas pressure pushes further the remaining fluid present in the fluidic pathways into the output. In this particular example, the remaining fluid in the fluidic pathways is pushed into the output U₃ valve-3. Valve T1 needs to remain turned off so that the NO and COM are connected. On the contrary, valve T2 needs to be turned on so that the NC and COM are connected together. U₁ valve-7, U₁ valve-8, U₂ valve-7, U₂ valve-8, U₃ valve-7, and U₃ valve-3 are turned on while U₁ valve-2, U₃ valve-8, U₄ valve-7, U₄ valve-8, and valve T4 still remain turned off.

FIG. 16 represents the solvent-based cleaning state. In the solvent-based cleaning state, the fluidic pathways are cleaned by allowing a cleaning solvent to flow into the fluidic pathways which are then dumped into the drain. This way, the next fluid flowing from a new input to a new output will flow into clean fluidic pathways without contaminations from the previous fluid flow. In this example, after the gas pressure transports the remaining fluid into U₃ valve-3 output, the valve U₃ valve-3 is turned off so that the solvent-based cleaning state can begin.

FIG. 17 represents the gas-based drying state. In the gas-based drying state, applied gas pressure is used to push and dry the remaining cleaning solvent into the drain as well as drying any volatile components. In order to let the AP flow, T1 valve needs to be turned off so that the NO and COM are connected again. The valves T2, U₁ valve-7, U₁ valve-8, U₂ valve-7, U₂ valve-8, U₃ valve-7, U₃ valve-8, U₄ valve-7, and U₄ valve-8 remain turned on while the valve U₁ valve-2, U₃ valve-3, and valve T4 remain turned off.

FIG. 18 depicts the fluidic system. In the following example, operation of the system is sequenced in the same five classes of states as the previous two examples. Inputs and outputs chosen in this example is as follows: Unit 4 (U₄) valve-6 is used as a fluid input fed by a reagent or fluidic source, Unit 1 (U₁) valve-3 is used as a fluid output to feed a reagent or fluidic destination.

FIG. 19 represents the idle state. In the idle state, all the valves are turned off, no fluid or solvent is flowing, and no air pressure is applied thus blocking fluid, solvent and gas flow. e.g. valves T3 and T4, U₄ valve-8, U₄ valve-6, U₄ valve-7, U₃ valve-8, U₃ valve-7, U₂ valve-8, U₂ valve-7, U₁ valve-8, U₁ valve-3, U₁ valve-7, and valve T2 are all turned off.

FIG. 20 represents the fluid flow state. In the fluid flow state, the fluid flows from U₄ input to U₁ output. In the following example the fluid flows from U₄ valve-6 to U₁ valve-3. Thus, the valves U₄ valve-6, U₄ valve-7, U₃ valve-8, U₃ valve-7, U₂ valve-8, U₂ valve-7, U₁ valve-8, and U₁ valve-3 are turned on to allow the fluid to flow from U₄ valve-6 to U₁ valve-3 during a desired period of time or until a desired quantity of fluid is delivered. After the fluid has been delivered from U₄ valve-6 to U₁ valve-3, the U₄ valve-6 is turned off.

FIG. 21 represents an example Gas-Pressure Clearing state. In the Gas-Pressure Clearing state, applied gas pressure pushes the remaining fluid present in the fluidic pathways into the output. In the example, the remaining fluid in the fluidic pathways is pushed into the output U₁ valve-3. T3 valve needs to be turned off so that the NO and COM are connected. T4 valve needs to be turned on so that the NC and COM are connected together and U₄ valve-8, U₄ valve-7, U₃ valve-8, U₃ valve-7, U₂ valve-8, U₂ valve-7, U₁ valve-8, and U₁ valve-3 are turned on while U₄ valve-6, U₁ valve-7 and T2 are turned off.

FIG. 22 represents the solvent-based cleaning state. In the solvent-based cleaning state, the fluidic pathways are cleaned by allowing a cleaning solvent to flow into the fluidic pathways which is then dumped into the drain. The next fluid burst or segment flowing from a new input to a new output will flow into clean fluidic pathways without contaminations from the previous fluid flow. In this example, after the gas transports the remaining fluid into U₁ valve-3 output, the valve U₁ valve-3 is turned off so that the solvent-based cleaning state can begin.

FIG. 23 represents the gas-based drying state. In the gas-based drying state, applied gas pressure is used to push and dry the remaining cleaning solvent into the drain as well as drying any volatile solvent components. In order to let the AP flow, T3 valve needs to be turned off so that the NO and COM are connected again. The valves T4, U₄ valve-8, U₄ valve-7, U₃ valve-8, U₃ valve-7, U₂ valve-8, U₂ valve-7, U₁ valve-8, and U₁ valve-7 remain turned on while the valve U₄ valve-6, U₁ valve-3, and T2 remain turned off.

FIG. 24 depicts a first example arrangement for supporting transport of short fluid burst whose transport is driven by applied gas pressure. In this example, SPDT valves are connected to every port 7 and port 8 of each of four 8-branch valve cluster units and are denoted T1-T8 as indicated in FIG. 24.

FIG. 25 depicts the fluidic system. Inputs and outputs utilized in this example include Unit 1 (U₁) valve-1 is used as a fluid input fed by a reagent or fluidic source, Unit 4 (U₄) valve-4 is used as a fluid output to feed a reagent or fluidic destination. The following operational example illustrates a sequence of events that facilitates a fluid flow from U₁ to U₄.

FIGS. 26-27 represents the idle state. In the idle state, all the valves are turned off, no fluid or solvent is flowing, and no air pressure is applied. Thus, valves T1, U₁ valve-7, U₁ valve-1, U₁ valve-4, U₁ valve-8, U₂ valve-7, U₂ valve-8, U₃ valve-7, U₃ valve-8, U₄ valve-7, U₄ valve-4, U₄ valve-8, and valve T8 are all turned off.

FIGS. 28-32 represents the fluid flow state in detail with the fluid visibly flowing from U₁ valve-1 to U₄ valve-4. In the fluid flow state, the fluid flows from one input to an output. In this example, the fluid flows from U1-1 to U₄ valve-4. Thus, the valves U₁ valve-1 and U₄ valve-4 are turned on while U₁ valve-7, U₁ valve-8, U₂ valve-7, U₂ valve-8, U₃ valve-7, U₃ valve-8, U₄ valve-7, and U₄ valve-8 are already on. This allows the fluid to flow from U₁ valve-1 to U₄ valve-4 during a desired period of time or until a desired quantity of fluid is delivered. After the fluid has been delivered from U₁ valve-1 to U₄ valve-4, the U₁ valve-1 valve is turned off.

FIGS. 33-38 represents the gas-pressure clearing state in detail with the gas moving represented with a dashed line. In the gas-pressure clearing state, the gas pressure pushes further the remaining fluid present in the fluidic pathways into the output. In this particular example, the remaining fluid in the fluidic pathways is pushed into the output U₄ valve-4. Valve T1 needs to remain turned off so that the NO and COM are connected. U₁ valve-7 needs to be turned off so that the NO is connected to the COM of valve T1. U₁ valve-8, U₂ valve-7, U₂ valve-8, U₃ valve-7, U₃ valve-8, U₄ valve-7, and U₄ valve-4 remain turned on.

FIGS. 39-46 represents the solvent-based cleaning state in detail with the cleaning fluid flowing in both directions. In the solvent-based cleaning state, the fluidic pathways are cleaned by allowing a cleaning solvent to flow into the fluidic pathways which is then dumped into the output U₁ valve-4, here used as a drain. The next fluid burst or segment flowing from a new input to a new output will flow into clean fluidic pathways without contaminations from the previous fluid flow. In this example, after the gas pressure transports the remaining fluid into U₄ valve-4 output, the valve U₄ valve-4 is turned off so that the solvent-based cleaning stage can begin.

FIGS. 47-54 represents the gas-based drying state in detail with the air flowing in both directions. In the gas-based drying state, applied gas pressure is used to push and dry the remaining cleaning solvent into the drain U₁ valve-4 as well as drying any volatile solvent components. In order to let the drying gas (AP) flow, valves T1 and T8 needs to be turned off again so that the NO and COM are connected again. The valves U₁ valve-7, U₁ valve-4, U₁ valve-8, U2 valve-7, U2 valve-8, U3 valve-7, U3 valve-8, U4 valve-7, and U4 valve-8 remain all turned on.

FIG. 55 depicts a simplified example system comprising two chambers, each comprising a dedicated valve-gated pressure passage and a fluid transport port.

FIG. 56 depicts a valve-chaperoned “T”-topology comprising three SPST (on/off) gate valves connected on one side to an associated external port (Port A, Port, B, and Port C respectively) and on the other side to a flow T-juncture.

FIG. 57 comprises a “triangle”-topology valve-cluster having Port A connected to the COM port of its associated SPDT valve and having Port B connected to the COM port of its associated SPDT valve.

FIG. 58 depicts a variation on example “triangle”-topology valve-cluster arrangement shown in FIG. 56 comprising having the COM port of the SPDT valve associated with Port A connected to the COM port of the SPDT valve associated with Port B.

FIG. 59 illustrates an example transport flow (top drawing), an example clearing/cleaning flow between valve C and valve B (middle drawing), and an example clearing/cleaning flow among valve C and valve A (bottom drawing) for the example arrangement of FIG. 56.

FIG. 60 illustrates an example transport flow (top drawing), an example clearing/cleaning flow among valve C and valve B (middle drawing), and an example clearing/cleaning flow among valve C and valve A (bottom drawing) for the example arrangement of FIG. 57.

FIG. 61 illustrates an example transport flow (top drawing), an example clearing/cleaning flow among valve C and valve B (middle drawing), and an example clearing/cleaning flow among valve C and valve A (bottom drawing) for the example arrangement of FIG. 58.

FIG. 62 depicts a simplified example system comprising two chambers, each comprising a dedicated valve-gated pressure passage and a fluid transport port, and further incorporating multiple instances of the valve cluster depicted in FIG. 56 into the configuration depicted in FIG. 55; FIG. 62 further depicts an example initial situation where a fluid present in Chamber 1. In this example, Chamber 1 can be regarded as the fluid source.

FIG. 63 depicts an example situation where gas pressure provided by pressure passage 1 going through the gas-pressure gating valve 1 powered now into an open position, resulting in pushing a fluid front into the outgoing conduit. Valves 2Y, 2Z, 3Y, 3Z, 4Y, 4Z, 5Z, and pressure passage 6 valves are open to vent the displaced gas ahead of the fluid front out of Chamber 2 through pressure passage 6.

FIG. 64 depicts an example situation where gas pressure provided by pressure passage 1 further pushing a fluid front into valve cluster 2 (comprising valves 2X, 2Y, 2Z), wherein flow valves 2Y and 2Z are open and gas-pressure gating valve 2X remains closed as it was in FIGS. 12 and 13. Valves 3Y, 3Z, 4Y, 4Z, 5Z, and pressure passage 6 valves are open to vent the displaced gas ahead of the fluid front out of Chamber 2 through pressure passage 6.

FIG. 65 depicts an example situation where the pressure passage valve 1 closed and pressure passage valve 2X open, letting the pressure passage 2 open, further pushing a fluid front past valve cluster 2 approaching valve 3Y. Valves 3Y, 3Z, 4Y, 4Z, 5Z, and pressure passage 6 valves are open to vent the displaced gas ahead of the fluid front out of Chamber 2 through pressure passage 6.

FIG. 66 depicts an example subsequent situation where gas pressure passage valve 2X and flow valve 3Y are closed and valve 3X is open allowing gas pressure from pressure passage 3 to travel past valve 3Z. Valves 4Y, 4Z, 5Z, and pressure passage 6 valves are open to vent the displaced gas ahead of the fluid front out of Chamber 2 through pressure passage 6.

FIG. 67 depicts an example situation where gas pressure passage valve 3X is closed and gas pressure passage valve 4X is open allowing the pressure from gas pressure passage 4 to transport fluid through valve 4Z, pushing the fluid towards valve 5Y. Valves 5Z and pressure passage 6 valves are open to vent the displaced gas ahead of the fluid front out of Chamber 2 through pressure passage 6.

FIG. 68 depicts an example situation where gas pressure passage valve 4X closed and gas pressure passage valve 5X is open allowing the pressure from pressure passage 5 to push the fluid front past valve 5Z into Chamber 2 (the destination).

FIGS. 69-73 depict similar example operation steps for the same arrangement that result in a flow travelling in the opposite direction, employing Chamber 2 as the source and Chamber 1 as the destination.

FIG. 74 depicts a simplified example system comprising two chambers, each comprising a dedicated valve-gated pressure passage and a fluid transport port, and further incorporating multiple instances of the valve cluster depicted in FIG. 58 into the configuration depicted in FIG. 55.

FIG. 75 depicts an example initial situation where a fluid present in Chamber 1. In this example, Chamber 1 can be regarded as the fluid source.

FIG. 76 depicts gas pressure provided by pressure passage 1 going through the gas-pressure gating valve 1 powered now into an open position.

FIG. 77 depicts the pressure passage valve 1 closed and pressure passage valve 2 open, letting the pressure passage 2 open.

FIG. 78 depicts the fluid going further and exceeding valve 2B with the pressure coming from pressure passage 2 and approaching valve 3A.

FIG. 79 depicts the valve 2 turned off and valve 3 turned on allowing the pressure from pressure passage 3 to circulate through 3C, 3A, and finally 3B pushing the fluid further passed valve 3B.

FIG. 80 depicts the valve 3 turned off and valves 4 turned on allowing the pressure from pressure passage 4 to circulate through 4C, 4A, and 4B pushing the fluid even further passed valve 4B.

FIG. 81 depicts the valve 4 turned off and valve 5 turned on allowing the pressure from pressure passage 5 to circulate through 5 C, 5A, then 5B pushing the fluid into Chamber 2, the destination.

FIGS. 82-86 depict example operation steps for the same arrangement that result in a flow travelling in the opposite direction, employing Chamber 2 as the source and Chamber 1 as the destination.

FIG. 87 depicts a selected computer screen shot of the fluidics system software created using “Mathematica”. This software allows controlling all the valves.

FIG. 88 depicts a selected computer screen shot of the fluidic system software after selecting the first step of the script by clicking on the “Start a Script with Current Valve Status”. In this first step none of the valves are selected as in the default setting.

FIG. 89 depicts a selected computer screen shot of the fluidic system software after selection of the second step of the script. This second step shows that all ports 7 and ports 8 of the 4 units are selected.

FIG. 90 depicts a selected computer screen shot of the fluidic system software after selection of the third step of the script. This third step shows that in addition to all ports 7 and 8 of all 4 units, U1-2 and U4-6 are selected as well.

FIG. 91 depicts a selected computer screen shot of the fluidic system software after selection of the fourth step of the script. In this fourth step U1-2 and U1-7 are unselected leaving its represented square blank again. This represents the gas-pressure clearing state of the fluidic bus transport.

FIG. 92 depicts a selected computer screen shot of the fluidic system software after selection of the fifth step of the script. In this Fifth step U1-3, T1, and T2 are selected and U4-8 is unselected. This represents the solvent-based cleaning state of the fluidic bus transport.

FIG. 93 depicts a selected computer screen shot of the fluidic system software after selection of the sixth step of the script. In this sixth step T1 and T2 are unselected. This represents the gas-based drying state of the fluidic bus transport.

FIG. 94 depicts a selected computer screen shot of the fluidic system software after selection of the seventh step of the script. In this seventh step the valves U1-7 and U4-8 are selected again to go back to the idle state of FIG. 89.

FIG. 95 depicts a selected computer screen shot of the fluidic system software after selection of time (sec) for each step. In this software the time chosen under each step will be the time gap before that same step starts.

FIG. 96 depicts example content of a scripting window at the start of an authoring and/or editing session wherein nothing has yet been created or imported.

FIG. 97 depicts an example specification of an example first step in a script to be created. The specification of this step can be done, as shown here, in a window that is different and separate from the scripting window of FIG. 96.

FIG. 98 depicts the result of an example capture of the current state of the example first step created by user interaction actions and operations associated with FIG. 97. Graphics depicting the state can be display as shown. Additionally, FIG. 98 also depicts the result of a user typing “eee” in a field associated with the import of a previously-created script or library element.

FIG. 99 depicts the result of executing the import of a three-step previously-created script or library element “eee” that had been entered in FIG. 98 by selecting the “1” button. Note further in FIG. 99 that any of the four steps in the four-step script can be deleted or appended to the end of the current script.

FIG. 100 depicts an example result of selecting of steps 2 and 3 as part of a subsequence that can be used in later editing.

FIG. 101 depicts an example result of selecting to insert the subsequence (selected in FIG. 100) at the end of the current script depicted in FIG. 99.

FIG. 102 depicts an example result of selecting to append a copy of step 4 at the end of the six-step script depicted in FIG. 101.

FIG. 103 depicts the result of a user typing the text string “fff” in a field associated with saving the current script.

### DETAILED DESCRIPTION

In the following description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention.

In the following description, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

### 1. Background

The present application pertains to the software-control of fluidic transport and operation processes for microfluidic systems and the related aspects of temporal and event-driven sequence scripting, functional libraries useful in the creation of scripts, and software-based script authoring and editing tools.

Although most microfluidic systems in the literature to date are either entirely passive or have limited process control capability, future microfluidic systems (such as New Renaissance Institute's “Fluidic Microprocessors” and component technologies such as its “Microfluidic Bus”) and longer-term programs such as “Micro Total Analysis Systems” (uTAS) entail the sequenced control of a great number of valves and other controllable entities (motorized or sequenced-pulse pumps, photochemical and optical sensor illumination, thermal processing, sensor measurement capture, active mixer elements, electrochemical electrodes and hardware, sonochemical and surface-acoustic wave elements, etc.) to implement a one-pass or continuous process.

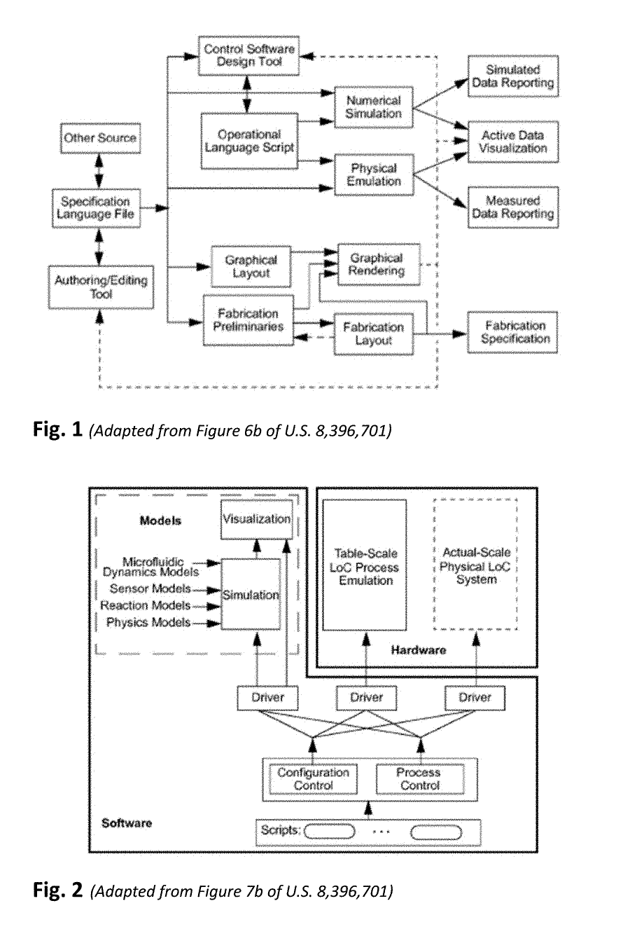

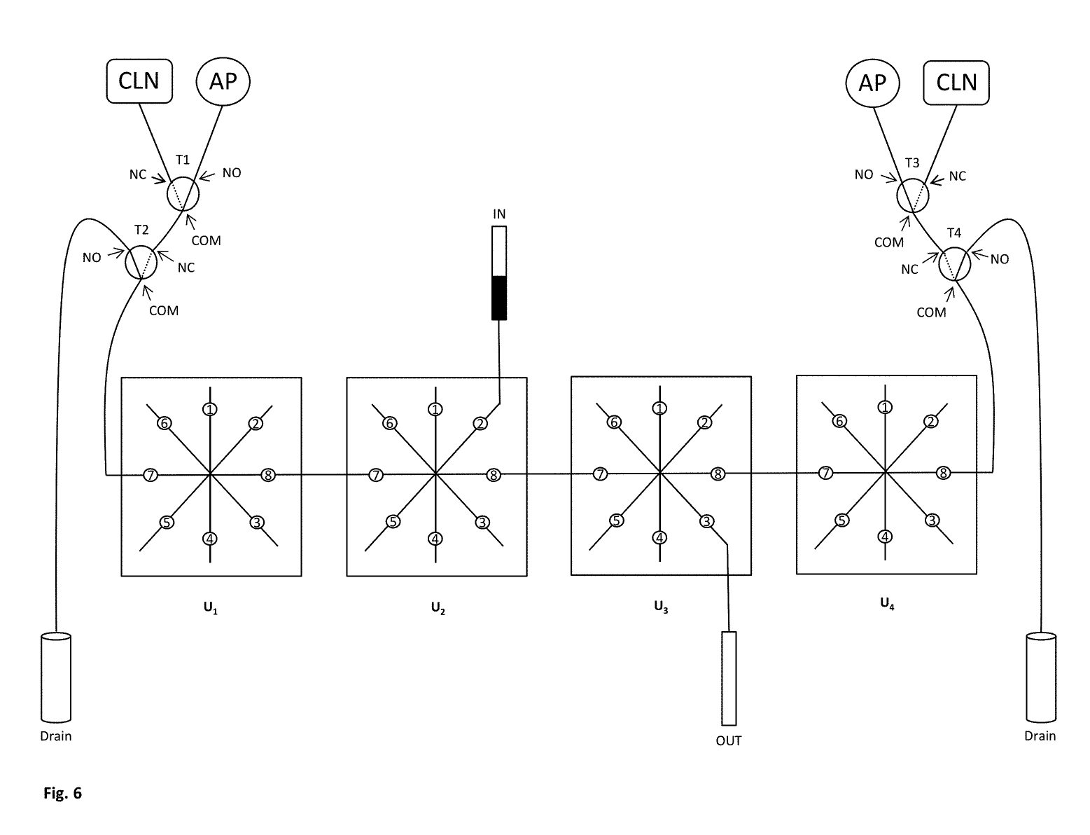

FIG. 1, adapted from FIG. 6b of U.S. Pat. No. 8,396,701, depicts an example comprehensive development environment or system that integrates a specification system, a fabrication design system, a graphical layout system, a graphical rendering system, a numerical simulation system, a software-controlled reconfigurable LoC physical emulation system, a data visualization system, and a control software development system. Such an arrangement could, for example, be configured so that the same specification file(s) to be used for defining a common underlying design model to the graphical layout system, the numerical simulation system, the software-controlled reconfigurable “Lab on a Chip” (LoC) emulation system, the fabrication design system, and the control software development system. Such specification files can be created and/or provided from an authoring/editing tool or an outside source. The specification files can be stored in a file system or database.

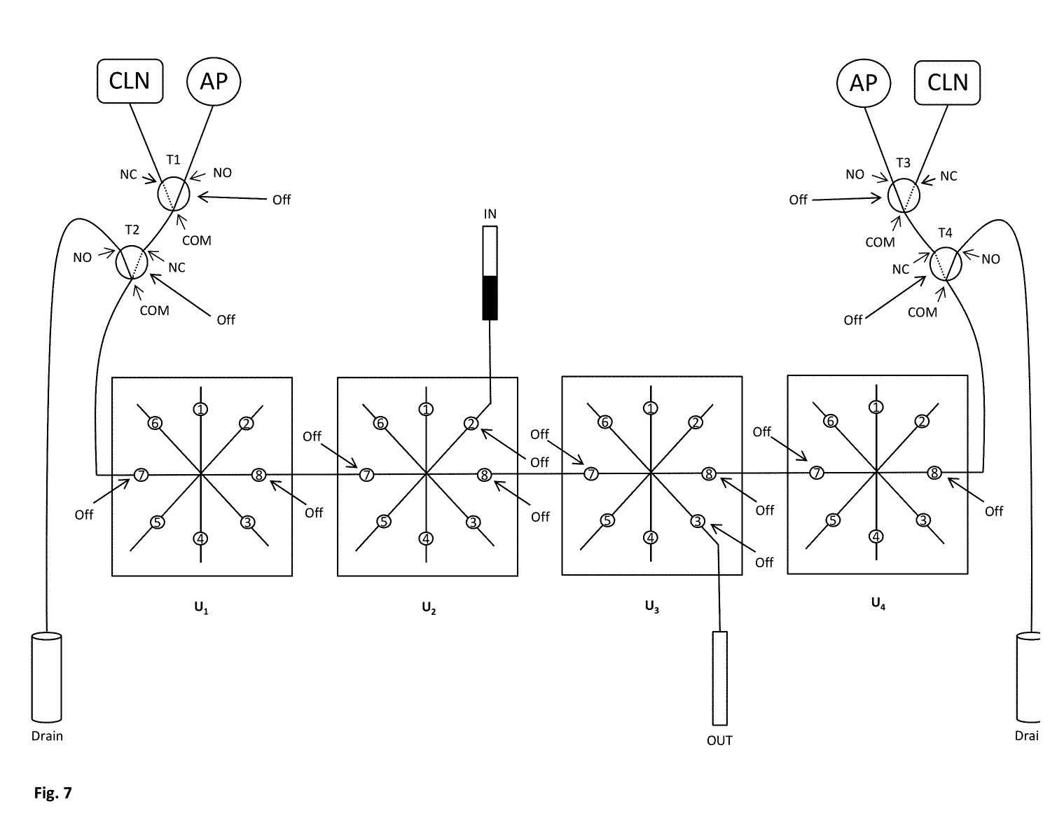

FIG. 2, adapted from FIG. 7b of U.S. Pat. No. 8,396,701, depicts an example global view of an example software environment embodiment of an integrated system such as that depicted in FIG. 1. Such a software environment embodiment could, for example, be configured or directed to the development, study, or operation of fluidic devices which do or do not have controllable configuration or reconfiguration abilities. Such a software environment embodiment can, for example, be used for progressive and/or interspersed simulation, emulation, and, where applicable, direct control of fluidic devices from one or more scripts and/or files. Such a software environment embodiment can, for example, employ common configuration scripts, files, or other techniques to configure the numerical simulation system, the physical emulation system, as well as actual fluidic devices. The same configuration scripts, files, or techniques can, for example, be used to configure numerical modeling system and emulation systems. This allows for the actual or prototype controllable microfluidic device to be operated by the system and compared with simulation and/or emulation results. Additionally, arrangements can include integration of configuration control together with process control, permitting scripts, files, or other techniques to freely combine configuration commands and process commands. Other approaches are possible as is clear to one skilled in the art.

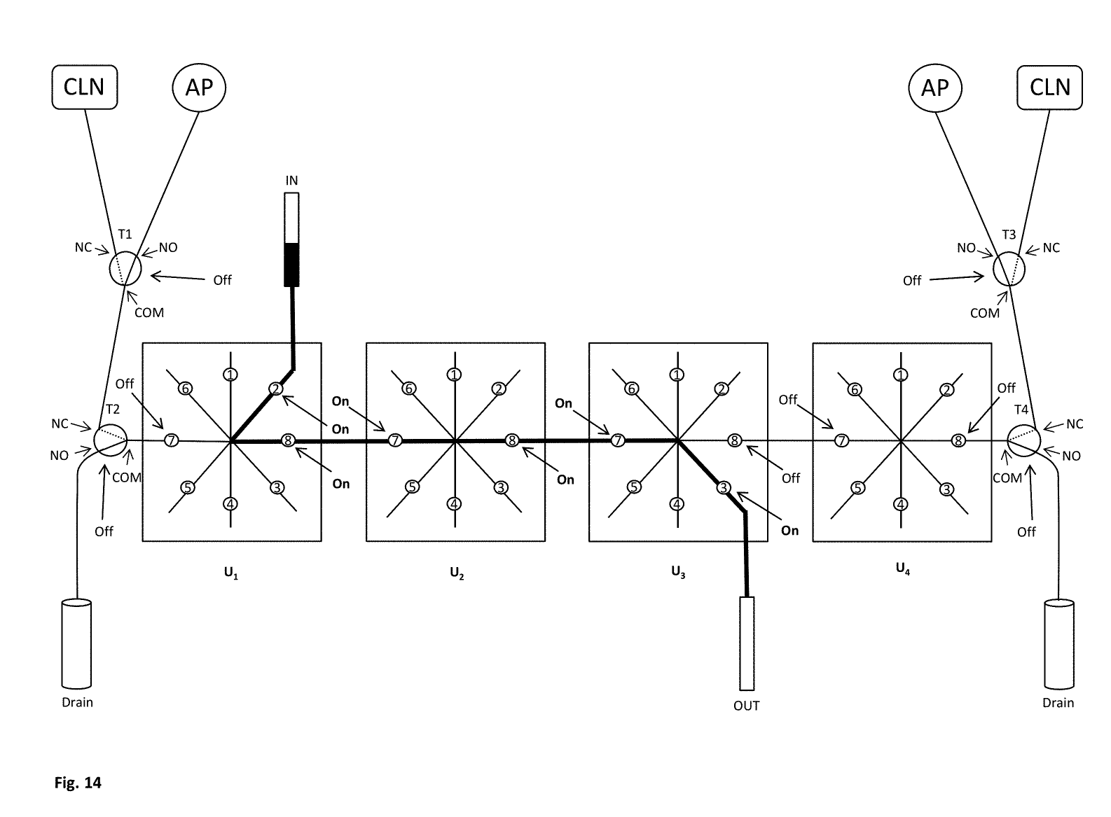

FIG. 3, adapted from FIG. 14d of U.S. Pat. No. 9,646,133, depicts an example software-controlled/software-reconfigurable conduit and reaction chamber microfluidic arrangements for lab-on-a-chip and miniature chemical processing technologies. Example software controllable elements include fluid/gas/slurry routing and gating valves, chemical/biochemical reaction chambers, pumps or other (e.g. electrokinetic) flow-drivers, mixers, thermoelectric devices, light-emitting devices (for photochemical excitation, photosensitization stimulation (for example for localized nitric-oxide donor molecules), florescent marker stimulation, absorption/transmission spectroscopy, colorimetric analysis, etc.), electrochemical synthesis electrodes, electrochemical (amperometry/voltammetry/coulometry) analysis electrodes, instrumentation and imaging systems, etc.

Further regarding transport, as mentioned above, U.S. Pat. Nos. 8,032,258, 8,606,414, and related cases describe various approaches to and aspects of software controlled multichannel microfluidic chemical transport busses and related fluidic systems and methods.

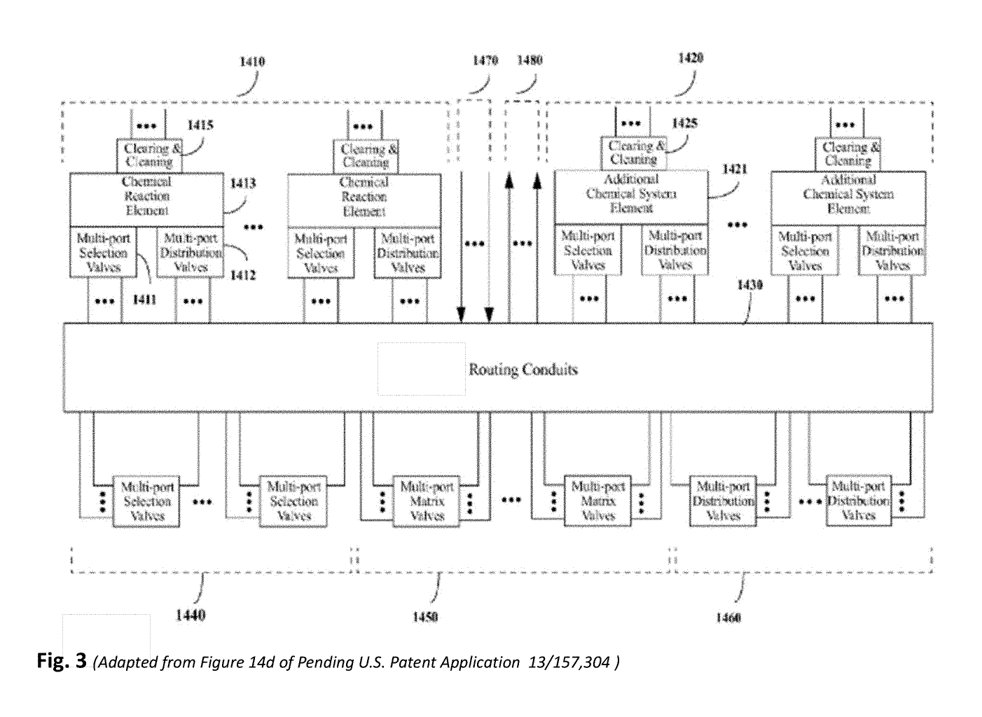

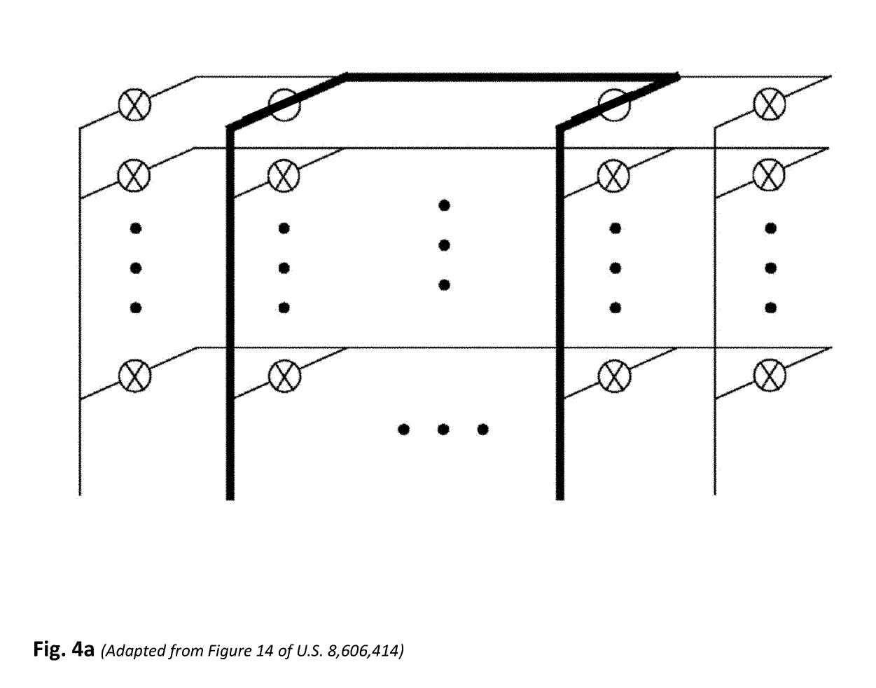

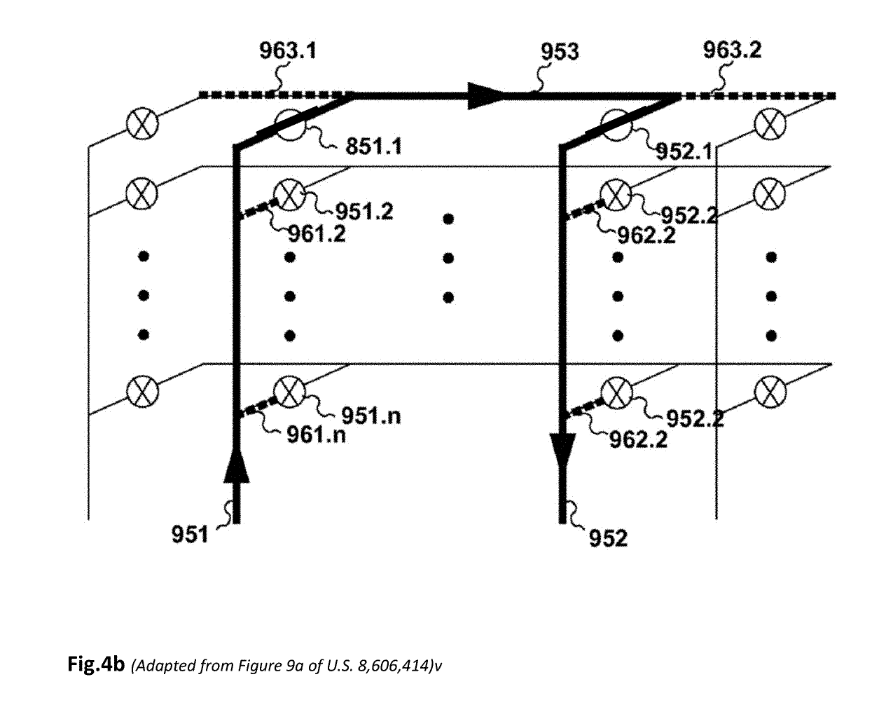

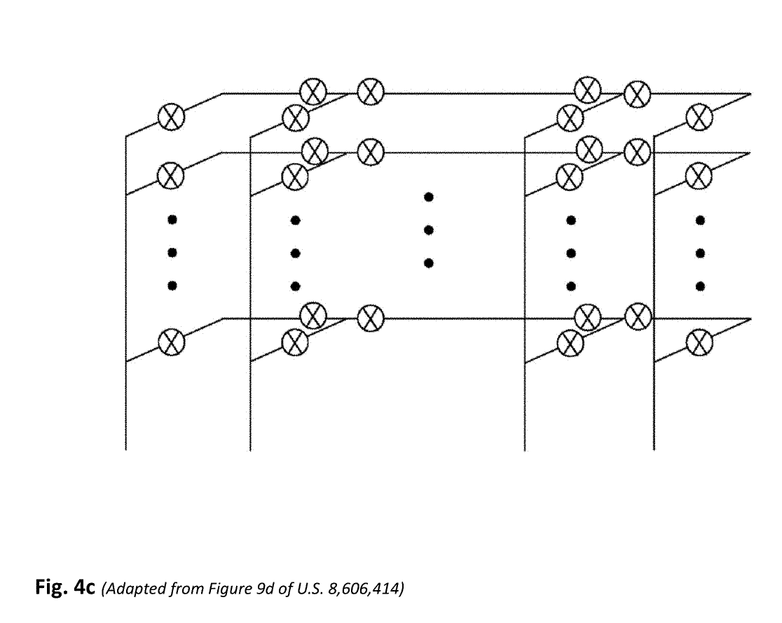

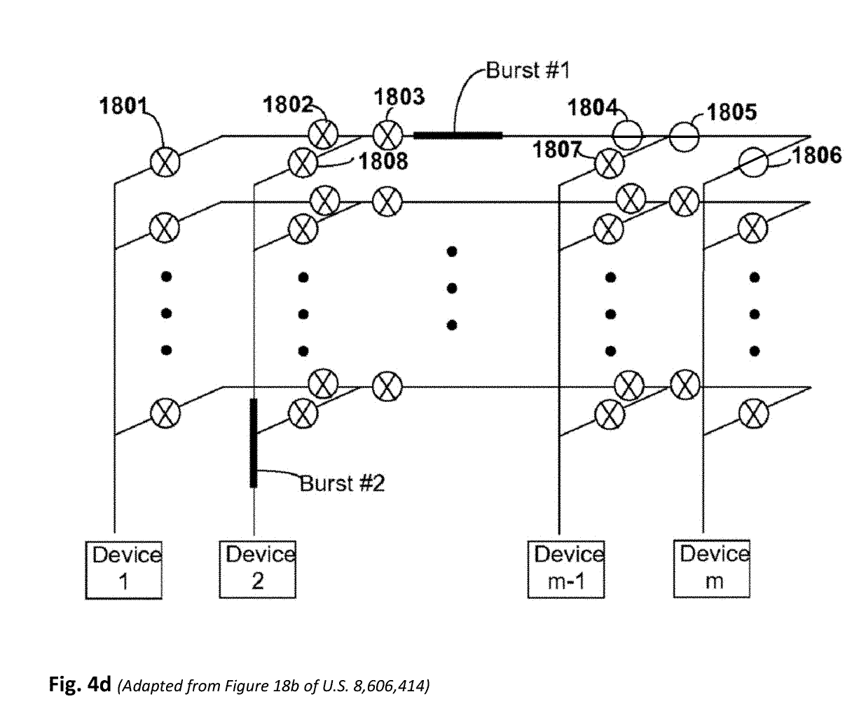

FIG. 4a, adapted from FIG. 14 of U.S. Pat. Nos. 8,032,258 and 8,606,414, depicts simple example contiguous flow transport through a simple example transport bus for microfluidic and other applications; the depicted fluidic flow (signified with superimposed heavy line) is enabled by the two open valves at the top of the figure, one of these valves connecting the second-to-left vertical conduit with the top horizontal tapped bus conduit, and the other of these valves connecting the second-to-right vertical conduit with the same top horizontal tapped bus conduit. The many passive “T”-topology junctions throughout the simple example microfluidic bus system are noted.

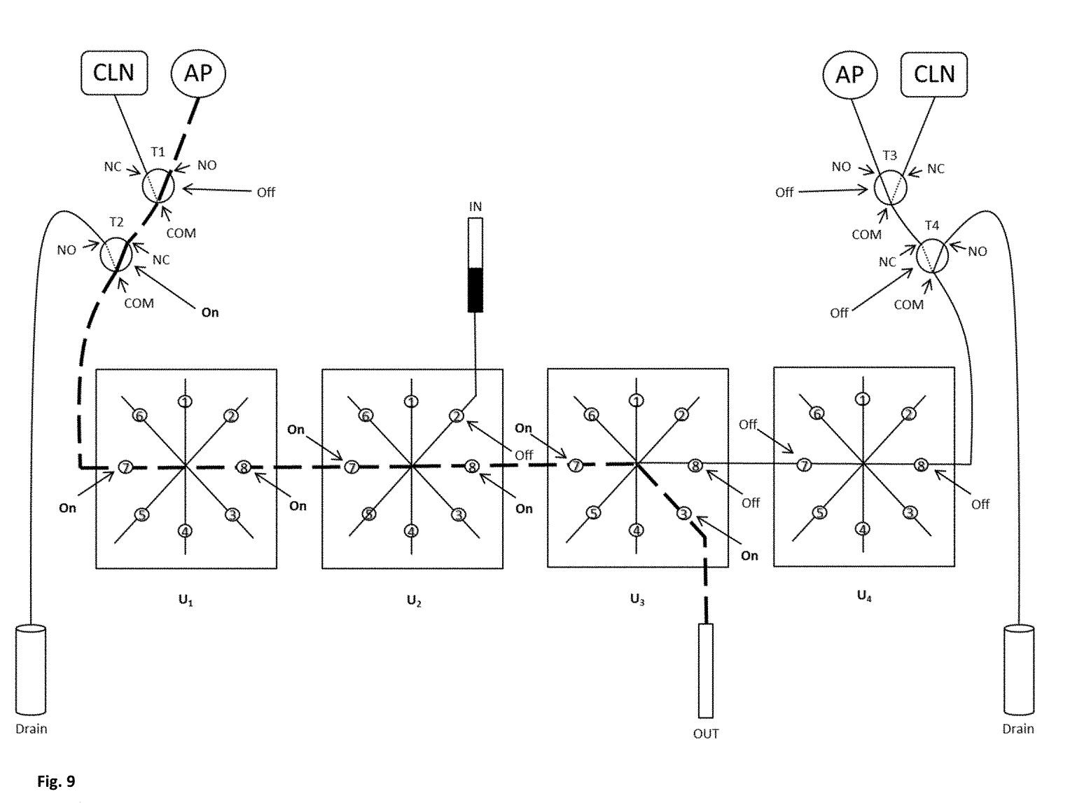

FIG. 4b, adapted from FIG. 9d of U.S. Pat. Nos. 8,032,258 and 8,606,414, depicts example contamination processes (signified with superimposed dashed heavy lines) resultant from the fluid flow (signified with superimposed heavy line) depicted in FIG. 4a.

FIG. 4c, adapted from FIG. 9a of U.S. Pat. Nos. 8,032,258 and 8,606,414, depicts an example enhanced variation of the chemical transport bus of FIG. 4a wherein additional local valves are added so as to closely surround each “T”-topology junction with three valves, one for each conduit meeting at the 3-way junction point.

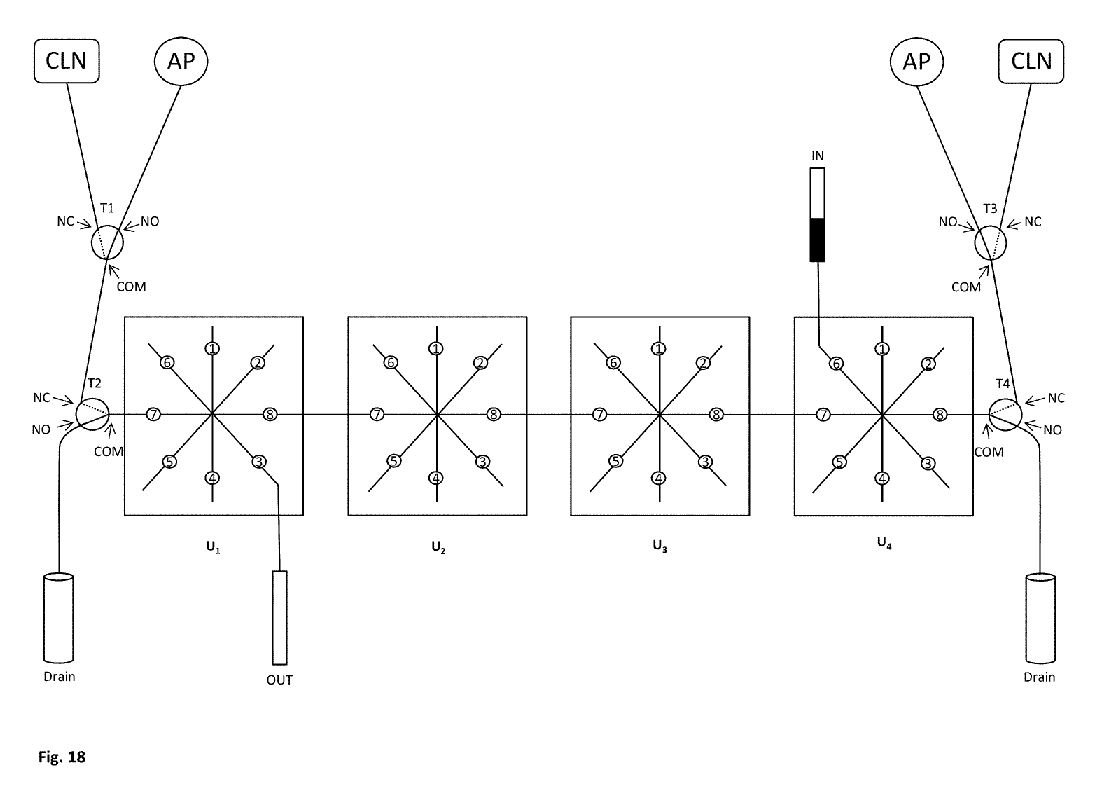

FIG. 4d, adapted from FIG. 18b of U.S. Pat. Nos. 8,032,258 and 8,606,414, depicts the example enhanced chemical transport bus depicted in FIG. 4c in the process of transporting two bursts of fluidic material which can transported through the chemical transport bus conduits, for example, by applied controlled propelling gas pressure and/or electrokinetic forces.

Many other chemical transport bus arrangements are taught in U.S. Pat. No. 8,032,258 and related patents and patent applications, and the arrangements are taught in U.S. Pat. No. 8,032,258 and related patents and patent applications can employ other valve arrangements than the examples explicitly taught therein. FIG. 4 represents a snapshot of the transport of two bursts of fluidic material which can be propelled through bus conduits, for example, by applied controlled pressure and/or electrokinetic forces. U.S. Pat. No. 8,032,258 and related patents and patent applications also teach dedicated-material, continuous gated flow, clearing, cleaning, reuse, one-time use, back-up, fault-tolerance, and other features. Most of the approaches taught in U.S. Pat. No. 8,032,258 and related patents and patent applications involve choreographed and/or feedback-control of groups of valves and other entities (for example pumps), and these controlled operations can be implemented through the execution of computational algorithms.

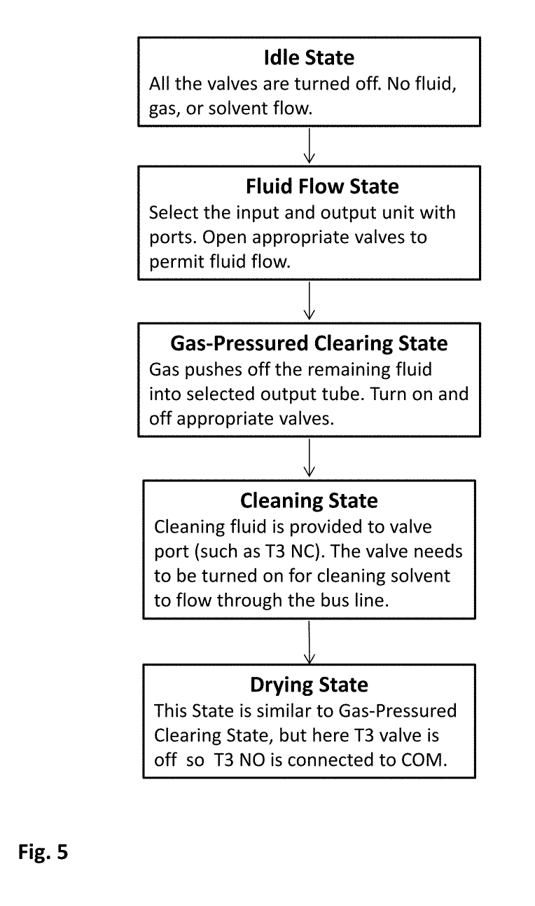

As an example, FIG. 5 depicts an example transaction-myopic system-level operation of a software controlled chemical transport bus system comprising sequences among five classes of example states:

Idle

Fluid Flow

Gas-Pressure Clearing

Solvent-Based Cleaning

Gas-Based Drying.

Such classes of states are realized by combinations of valve states (on/off, route-selection, etc.) and in some cases material locations/motions. Controlled sequences of operations among such states can be implemented through the execution of computational algorithms, the computational algorithms which in turn control the operation of valves and perhaps other entities (pumps, electrokinetic drivers, etc.).

Similarly, the example software-controlled/software-reconfigurable conduit and reaction chamber microfluidic arrangements for lab-on-a-chip and miniature chemical processing technologies depicted in FIG. 2 can, as described earlier, can comprise one or more other types of software controllable elements including gating valves, chemical/biochemical reaction chambers, pumps or other (e.g. electrokinetic) flow-drivers, mixers, thermoelectric devices, light-emitting devices (for photochemical excitation, photosensitization stimulation (for example for localized nitric-oxide donor molecules), fluorescent marker stimulation, absorption/transmission spectroscopy, colorimetric analysis, etc.), electrochemical synthesis electrodes, electrochemical (amperometry/voltammetry/coulometry) analysis electrodes, instrumentation and imaging systems, etc. Operation of such a device would similarly comprise sequences among states and/or classes of states.

### 2. Contributions of the Present Invention

Referring to FIGS. 1 and 2, in various embodiments the sequences of events and information needed to render them can be contained in files, scripts, or through the use of other techniques. Further, as explicitly shown in FIG. 1, files, scripts, or other techniques for both configuration specification and subsequent operation of the configuration can be created using authoring tools.

The present patent application further addresses many aspects described above, in particular including:

sequences among classes of operational states

configuration specification files

operational scripts

libraries of files and scripts

authoring/editing tools

multithreaded operation

simulation

emulation systems

alterative valve configurations for chemical transport busses.

To begin, first fluidic bus transport arrangements with gas-pressure clearing, solvent-based cleaning, and gas-based drying states are considered, discussed, and illustrated with several detailed simple “contiguous-flow” examples. Here “contiguous-flow” can signify a fluid flow from one source to at least one destination that is simply started and stopped with no intervening gas or air introduced to create segmenting open gaps in the fluid flow. It is possible to modify the definition of “contiguous-flow” in various ways to admit and/or differentiate additional minor distinctions; such alternative definitions are anticipated and provided for by the invention. (It is also possible to extend the definition of “contiguous-flow” in various ways to include and/or pertain to gas flows; such extended definitions are also anticipated and provided for by the invention.)

Next, “burst transport” is considered. Here “burst transport” can signify a fluid flow from one source to at least one destination wherein intervening gas or air introduced to create segmenting open gaps in the fluid flow. Typically burst transport would be used to sequentially transport multiple types of fluids through the same conduit, valve, pump, etc. It is possible to modify the definition of “contiguous-flow” in various ways to admit and/or differentiate additional minor distinctions; such alternative definitions are anticipated and provided for by the invention. (It is also possible to extend the definition of “burst transport” in various ways to include and/or pertain to gas flows; such extended definitions are also anticipated provided for by the invention.)

Then, conduit taps and conduit junction points are discussed; in particular traditional “T”-topology taps/junction and New Renaissance Institute's innovative “triangular-topology” valve-cluster implementations and operations are introduced, explained, and illustrated with operational examples. These are also described in companion patent filing U.S. patent application Ser. No. 16/179,825.

Next, example process step and configuration representations, data, and specification files are introduced, explained, and illustrated with examples. “Macros” of various types are then discussed.

Next, process event-scripting is introduced, explained, and illustrated with examples. Then the execution of scripts to control various types of hardware and software systems are discussed.

Finally, authoring, editing, modeling, and simulation tools are introduced, explained, and illustrated with examples.

3. Fluidic Bus Transport Arrangements with Gas-Pressure Clearing, Solvent-Based Cleaning, and Gas-Based Drying States

Fluidic bus transport arrangements with gas-pressure clearing, solvent-based cleaning, and gas-based drying states have been presented for example in New Renaissance Institute U.S. Pat. Nos. 8,032,258; 8,594,848; 8,606,414; 8,812,163; and 9,636,655. Both continuous flow and burst flow are considered in these.

The following remarks apply to the simple related examples 1-3 that are provided in this section and subsequent portions of the present patent application:
In these examples, there are four star-topology “valve units” connected in tandem to form a bus by interconnecting designated side-ports that are used to connect with immediately-neighboring “units.” These four units are indexed and labeled as U₁-U₄. Each unit has 8 ports, each gated by an associated valve and joined at a star junction point. Six of the ports are gated with simple on/off valves. The flow between the star junction and each of two side-ports is controlled by the associated SPDT valves, one valve associated with each side port. To form the fluidic bus, each unit is interconnected to neighboring units via port 7 and port 8 as suggested in FIG. 6. The significance of the example star-topology in this example is multifold:
   Although unusual it is a topology seen in some microfluidic designs;
   It can be regarded as an “equivalent” in some senses for a multiple-port reaction chamber or mixer;
   It can be regarded as an “equivalent” in some senses for a multiple-port reaction chamber or mixer;
   The resulting arrangement depicted in the examples can be readily organized as some number (here six) ports in a planar layer with a first additional gating interface port on one side of the planar layer and a second additional gating interface port on one side of the planar layer; such an approach is applicable to functional layer implementations of microfluidic systems as discussed in U.S. Patent Application 62/693,632 “Modular Arrangements for Micro-Conduit Fluidics and Gas Exchange;”
   It adds example diversity to the considerations and aids in demonstrating the broader scope of the invention.
Also in these examples, two Single Pole Double Throw (SPDT) valves, each with common (COM) port, Normally Closed (NC) port and Normally Open (NO) port are denoted by T1-T4.
The widely adopted conventions of Normally Closed (NC) and Normally Open (NO) for Single Pole Double Throw (SPDT) valves is unfortunately opposite that of SPDT electrical switches and relays. This is likely because for fluids and gases a “closed” valve blocks flow from occurring while an “open” valve permits flow to occur; in contrast for electricity, a “closed” electrical switch permits current flow while an “open” electrical switch blocks (actually interrupts) electrical current flow from occurring
Specifically, for SPDT valves:
   When no electricity is applied to a SPDT valve (“off” or “non-energized”), the valve is said to be “off” and in this mode provide a flow path connecting the COM and NO ports of the valve.
   When electricity is applied to a SPDT valve (“on” or “energized”), the valve is said to be on connecting the COM and NC valves.

That being said, uniformity with an electrical switch analogy is tempting to employ for the sake of conformity, and the reader should be aware that some technical literature and some products could choose to adopt an electrical switch analogy instead of the conventions described above.

In the figures for these examples, “CLN” denotes a Cleaning solvent source while “AP” denotes a gas pressure source that in these examples can be used both for reagent clearing and cleaning-solvent drying purposes.

### 3.1. Example 1—Fluid Flows from U₂ to U₃

In the following example, operation of the system is sequenced in five classes of states:

Idle,

Fluid Flow,

Gas-Pressure Clearing,

Solvent-Based Cleaning,

Gas-Based Drying.

An example sequence of these classes of states is depicted in FIG. 5.

Input chosen in this example is as follows:
Unit 2 (U₂) valve-2 is used as a fluid input fed by a reagent or fluidic source,
Unit 3 (U₁) valve-3 is used as a fluid output to feed a reagent or fluidic destination.

The fluidic system for this example is depicted in FIG. 6. The example is depicted in FIGS. 7-11.

### Idle State

In the idle state, all the valves are turned off, no fluid or solvent is flowing, and no gas pressure is applied. The valves that are involved in this example are valves T1 and T2, U₁ valve-7, U₁ valve-8, U₂ valve-7, U₂ valve-2, U₂ valve-8, U₃ valve-7, U₃ valve-3, U₃ valve-8, U₄ valve-7, U₄ valve-8, and valve T4. The idle state with all the valves turned off involved for this example is represented in FIG. 7.

### Fluid Flow State

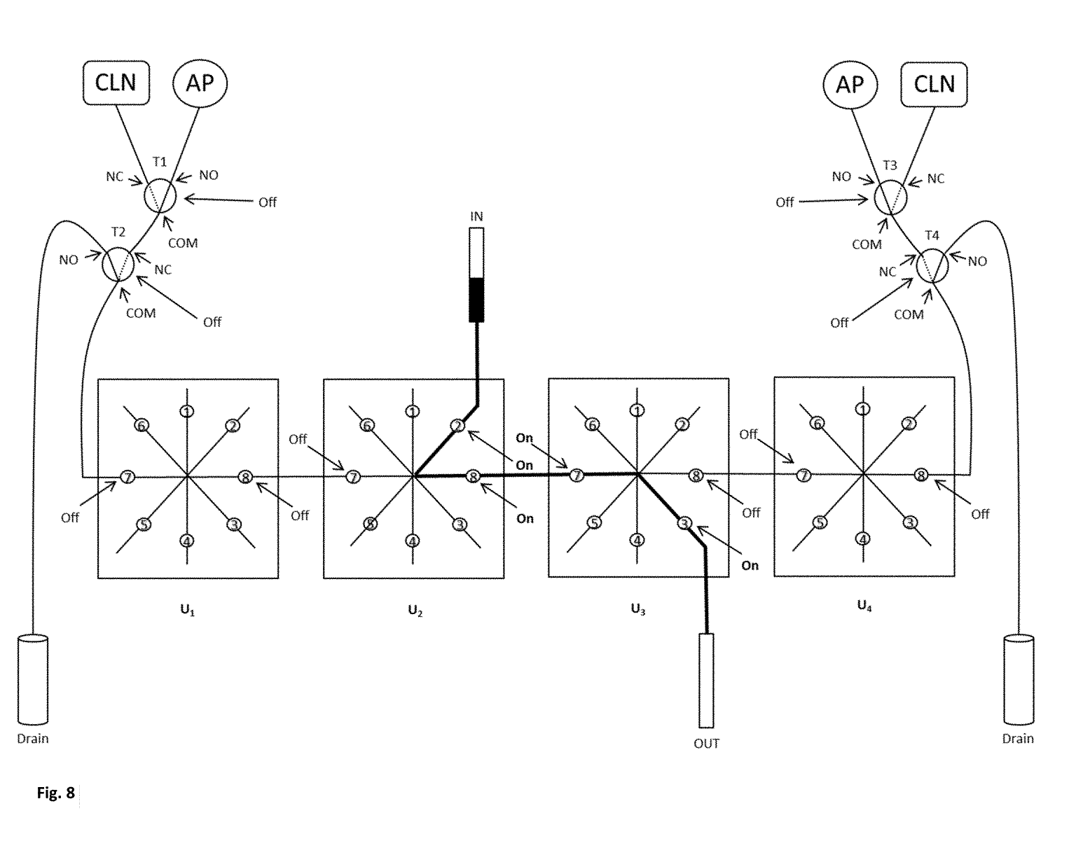

In the fluid flow state, the fluid flows from one input to an output. In this example, the fluid flows from U₂ valve-2 to U₃ valve-3. Thus, the valves U₂ valve-2, U₂ valve-8, U₃ valve-7, and U₃ valve-3 are turned on to allow the fluid to flow from U₂ valve-2 to U₃ valve-3 during a desired period of time or until a desired quantity of fluid is delivered. After the fluid has been delivered from U₂ valve-2 to U₃ valve-3, the U₂ valve-2 valve is turned off. The fluid flow state is represented in FIG. 8 with valves U₂ valve-2, U₂ valve-8, U₃ valve-7, and U₃ valve-3 turned on and valves T1 and T2, U₁ valve-7, U₁ valve-8, U₂ valve-7, U₃ valve-8, U₄ valve-7, U₄ valve-8, and valveT4 remaining turned off.

### Gas-Pressure Clearing State

In the Gas-Pressure Clearing state, the gas pressure pushes further the remaining fluid present in the fluidic pathways into the output. In this particular example, the remaining fluid in the fluidic pathways is pushed into the output U₃ valve-3. T1 valve needs to remain turned off so that the NO and COM are connected, whereas T2 valve needs to be turned on so that the NC and COM are connected together. U₁ valve-7, U₁ valve-8, U₂ valve-7, U₂ valve-8, U₃ valve-7, and U₃ valve-3 are turned on while U₂ valve-2, U₃ valve-8, U₄ valve-7, U₄ valve-8, and T4 remains turned off. An example Gas-Pressure Clearing_state is depicted in FIG. 9.

### Solvent-Based Cleaning State

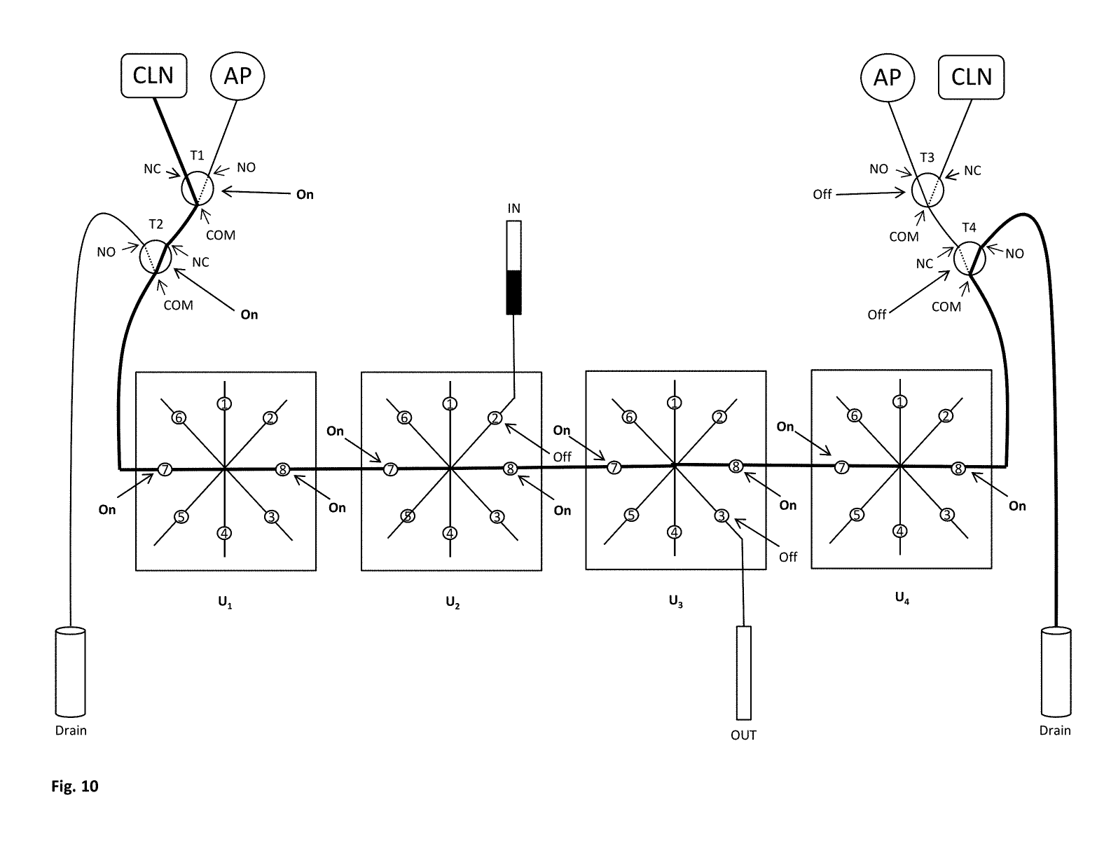

In the solvent-based cleaning state, the fluidic pathways are cleaned by allowing a cleaning solvent to flow into the fluidic pathways which are then deposited into the drain. This way, the next fluid flowing from a new input to a new output will flow into clean fluidic pathways without contaminations from the previous fluid flow. In the example, after the gas pressure transports the remaining fluid into U₃ valve-3 output, the valve U₃ valve-3 is turned off so that the solvent-based cleaning state can begin. In order for the CLN to flow the T1 valve needs to be turned on to connect the NC and COM together and T2 remains turned on. The valves U₁ valve-7, U₁ valve-8, U₂ valve-7, U₂ valve-8, U₃ valve-7, U₃ valve-8, U₄ valve-7, U₄ valve-8 are turned on, while U₂ valve-2, U₃ valve-3 are turned off and T4 remains turned off in order to connect the COM and NO to allow the CLN to go into the drain. The solvent-based cleaning state is represented in FIG. 10.

### Gas-Based Drying State

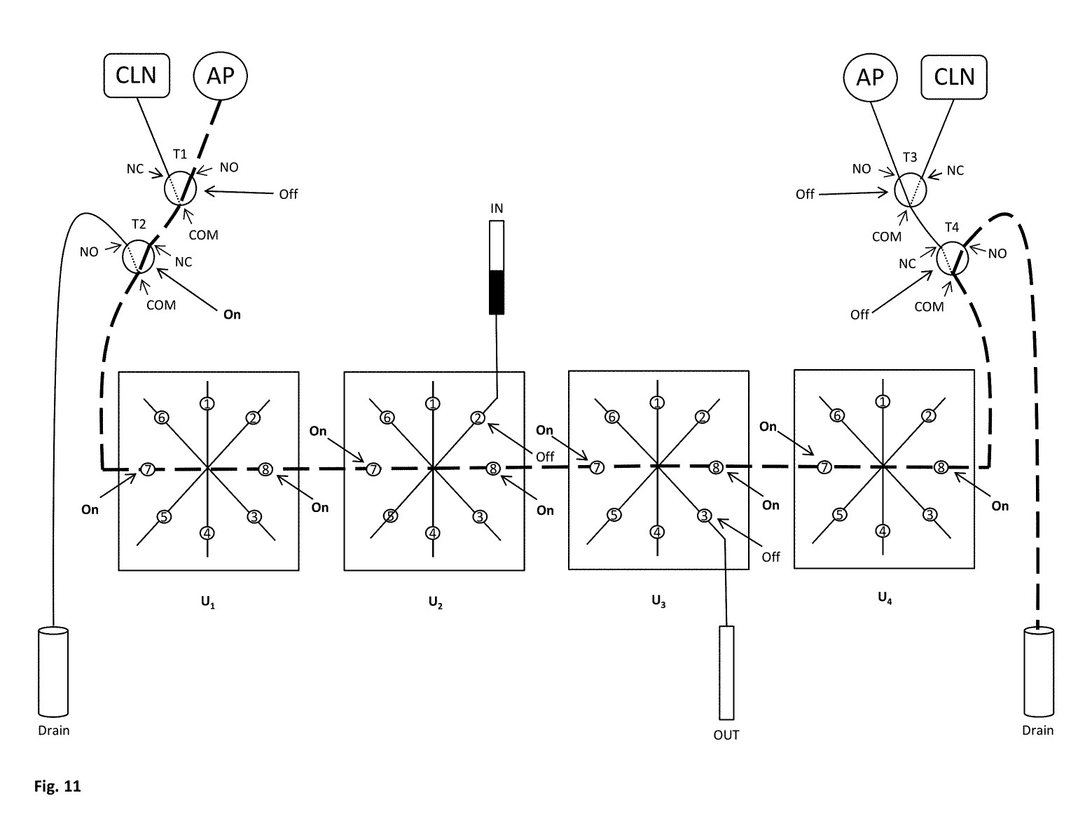

In the gas-based drying state, applied gas pressure is used to push and dry the remaining cleaning solvent into the drain as well as drying any volatile components. In order to let the AP flow, T1 valve needs to be turned off so that the NO and COM are connected again. The valves T2, U₁ valve-7, U₁ valve-8, U₂ valve-7, U₂ valve-8, U₃ valve-7, U₃ valve-8, U₄ valve-7, and U₄ valve-8 remain turned on, while the valve U₂ valve-2, U₃ valve-3, and T4 remain turned off. The gas-based drying state is represented in FIG. 11.

### 3.2. Example 2—Fluid Flows from U₁ to U₃

In the following example, operation of the system is sequenced through the same five classes of states as the previous example. An example sequence of these classes of states is depicted in FIG. 5.

Inputs and outputs are chosen in this example is as follows:

Unit 1 (U₁) valve-2 is used as a fluid input fed by a reagent or fluidic source,

Unit 3 (U₃) valve-3 is used as a fluid output to feed a reagent or fluidic destination.

The valves that are involved in this example are T1, T2, U₁ valve-7, U₁ valve-2, U₁ valve-8, U₂ valve-7, U₂ valve-8, U₃ valve-7, U₃ valve-3, U₃ valve-8, U₄ valve-7, U₄ valve-8, and

T4.

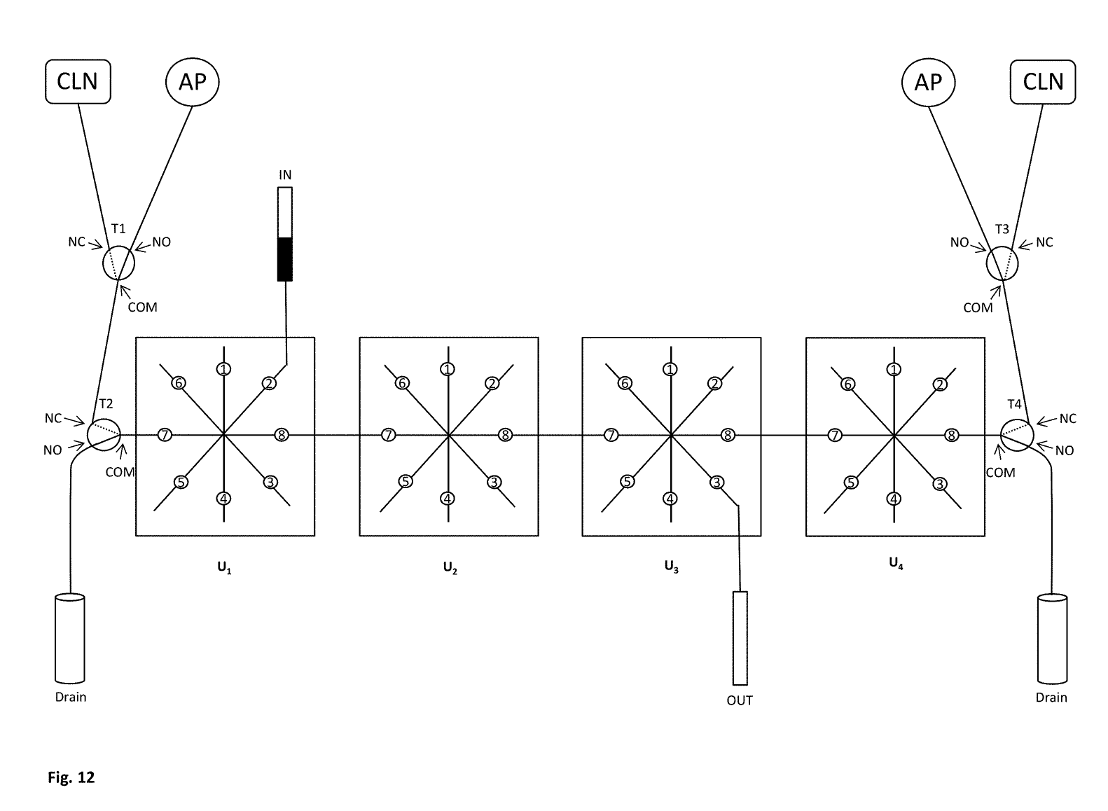

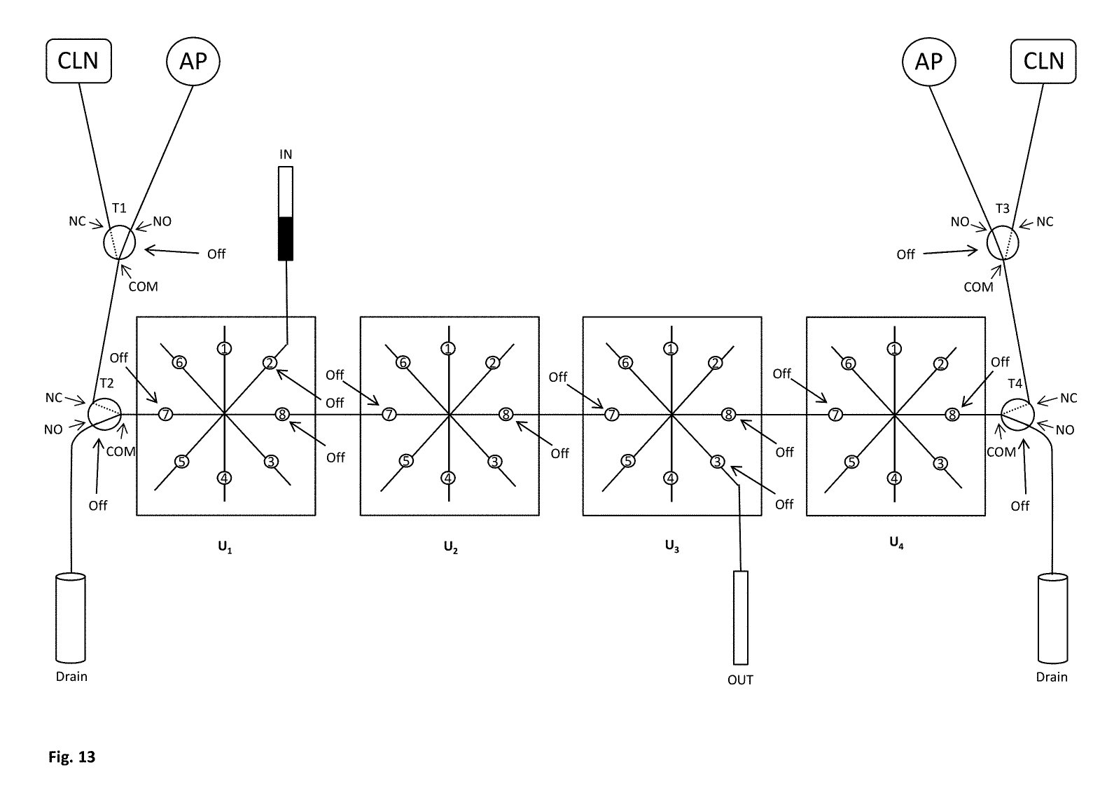

The fluidic systems used in this example are depicted in FIG. 12. The example is depicted in FIGS. 13-17.

### Idle State

In the idle state, all the valves are turned off, no fluid or solvent is flowing, and no air pressure is applied. Thus, valves T1, T2, U₁ valve-7, U₁ valve-2, U₁ valve-8, U₂ valve-7, U₂ valve-8, U₃ valve-7, U₃ valve-3, U₃ valve-8, U₄ valve-7, U₄ valve-8, and T4 are all turned off. The idle state with all the valves turned off involved for this example is represented in FIG. 13.

### Fluid Flow State

In the fluid flow state, the fluid flows from one input to an output. In this example, the fluid flows from U₁ valve-2 to U₃ valve-3. Thus, the valves U₁ valve-2, U₁ valve-8, U₂ valve-7, U₂ valve-8, U₃ valve-7, and U₃ valve-3 are turned on to allow the fluid to flow from U₁ valve-2 to U₃ valve-3 during a desired period of time or until a desired quantity of fluid is delivered. After the fluid has been delivered from U₁ valve-2 to U₃ valve-3, the U₁ valve-2 valve is turned off. The fluid flow state is represented in FIG. 14 with valves U₁ valve-2, U₁ valve-8, U₂ valve-7, U₂ valve-8, U₃ valve-7, and U₃ valve-3 turned on and T1, T2, U₁ valve-7, U₃ valve-8, U₄ valve-7, U₄ valve-8, and T4 remaining turned off.

### Gas-Pressure Clearing State

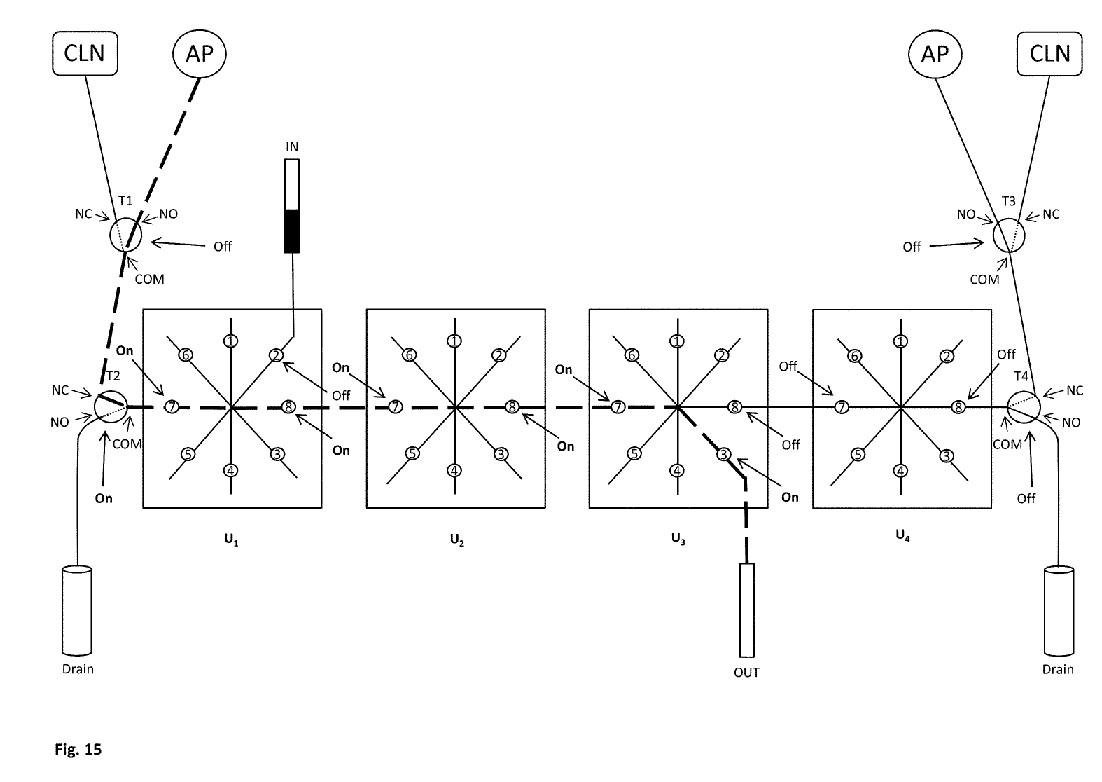

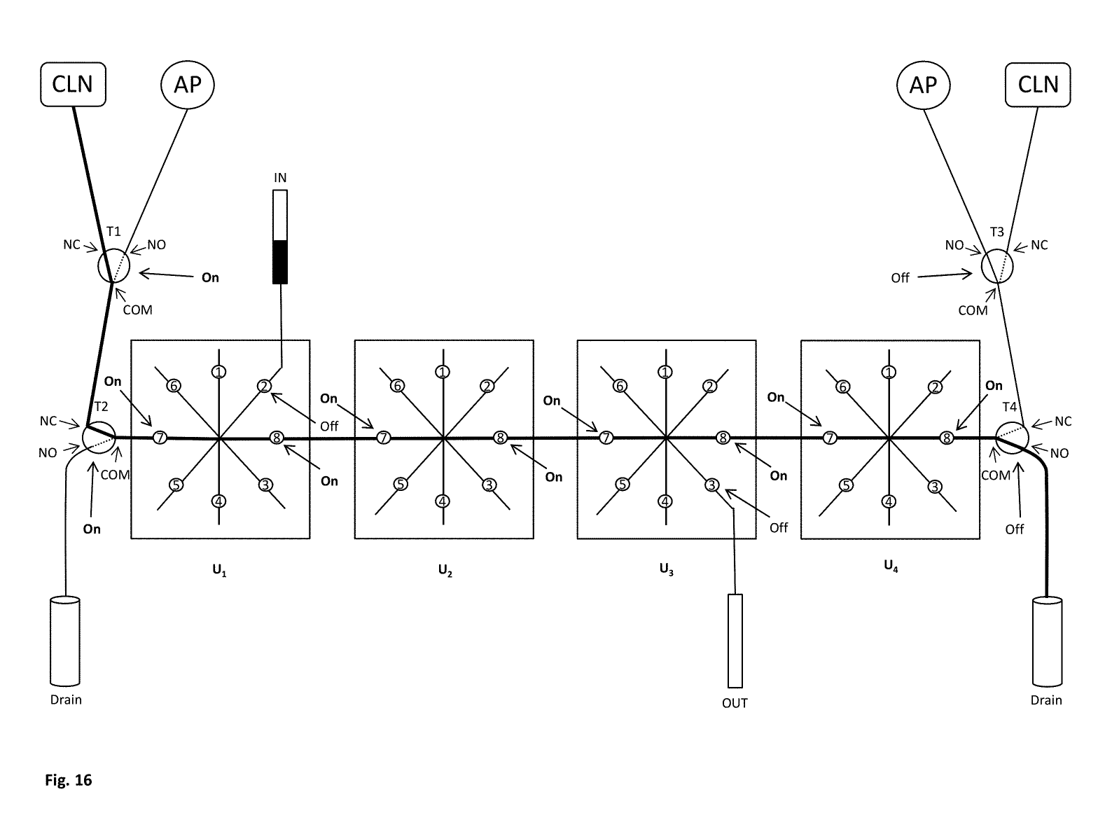

In the Gas-Pressure Clearing state, the gas pressure pushes further the remaining fluid present in the fluidic pathways into the output. In this particular example, the remaining fluid in the fluidic pathways is pushed into the output U₃ valve-3. T1 valve needs to remain turned off so that the NO and COM are connected. On the contrary, T2 valve needs to be turned on so that the NC and COM are connected together. U₁ valve-7, U₁ valve-8, U₂ valve-7, U₂ valve-8, U₃ valve-7, and U₃ valve-3 are turned on while U₁ valve-2, U₃ valve-8, U₄ valve-7, U₄ valve-8, and T4 still remain turned off. The Gas-Pressure Clearing state is represented in FIG. 15.

### Solvent-Based Cleaning State

In the solvent-based cleaning state, the fluidic pathways are cleaned by allowing a cleaning solvent to flow into the fluidic pathways which are then dumped into the drain. This way, the next fluid flowing from a new input to a new output will flow into clean fluidic pathways without contaminations from the previous fluid flow. In this example, after the gas pressure transports the remaining fluid into U₃ valve-3 output, the valve U₃ valve-3 is turned off so that the solvent-based cleaning state can begin.

In order for the CLN to flow the T1 valve needs to be turned on to connect the NC and COM together and T2 remains turned on. The valves U₁ valve-7, U₁ valve-8, U₂ valve-7, U₂ valve-8, U₃ valve-7, U₃ valve-8, U₄ valve-7, U₄ valve-8 are turned on while U₁ valve-2, U₃ valve-3 are turned off and T4 remains turned off in order to connect the COM and NO to allow the CLN to go into the drain. The solvent-based cleaning state is represented in FIG. 16.

### Gas-Based Drying State

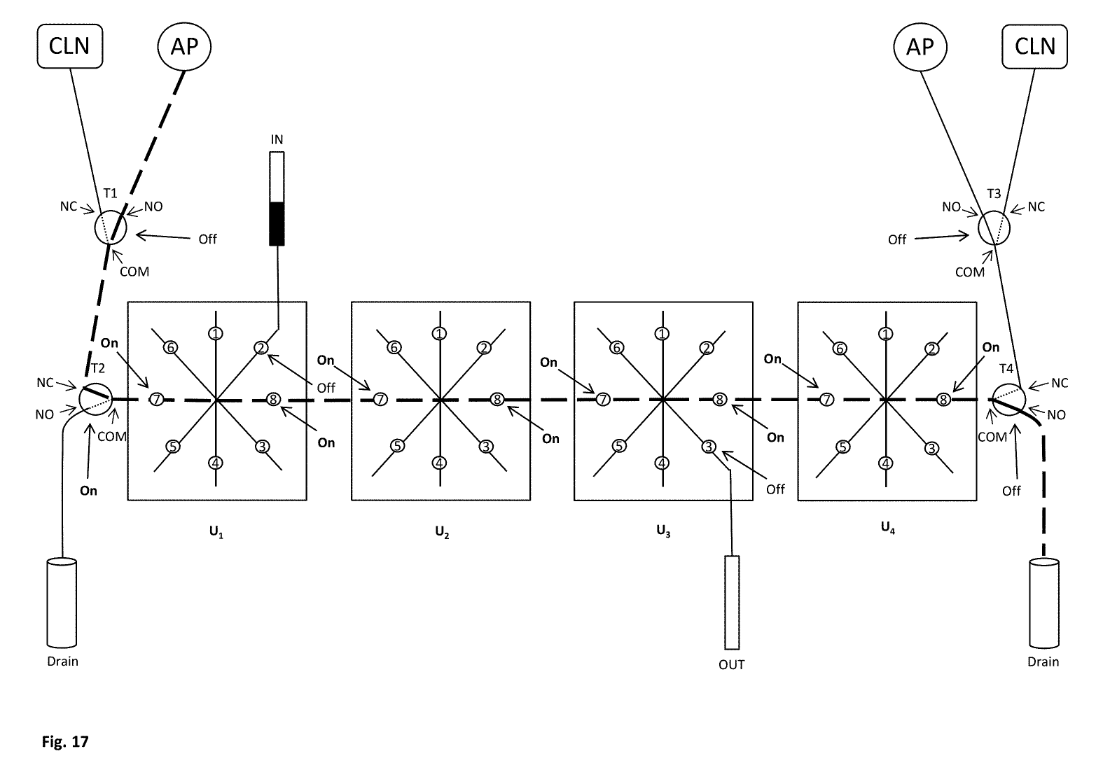

In the gas-based drying state, applied gas pressure is used to push and dry the remaining cleaning solvent into the drain as well as drying any volatile components. In order to let the AP flow, T1 valve needs to be turned off so that the NO and COM are connected again. The valves T2, U₁ valve-7, U₁ valve-8, U₂ valve-7, U₂ valve-8, U₃ valve-7, U₃ valve-8, U₄ valve-7, and U₄ valve-8 remain turned on while the valve U₁ valve-2, U₃ valve-3, and T4 remain turned off. The gas-based drying state is represented in FIG. 17.

### 3.3. Example 3—Fluid Flows from U₄ to U₁

The fluidic system used in this example is represented in FIG. 18

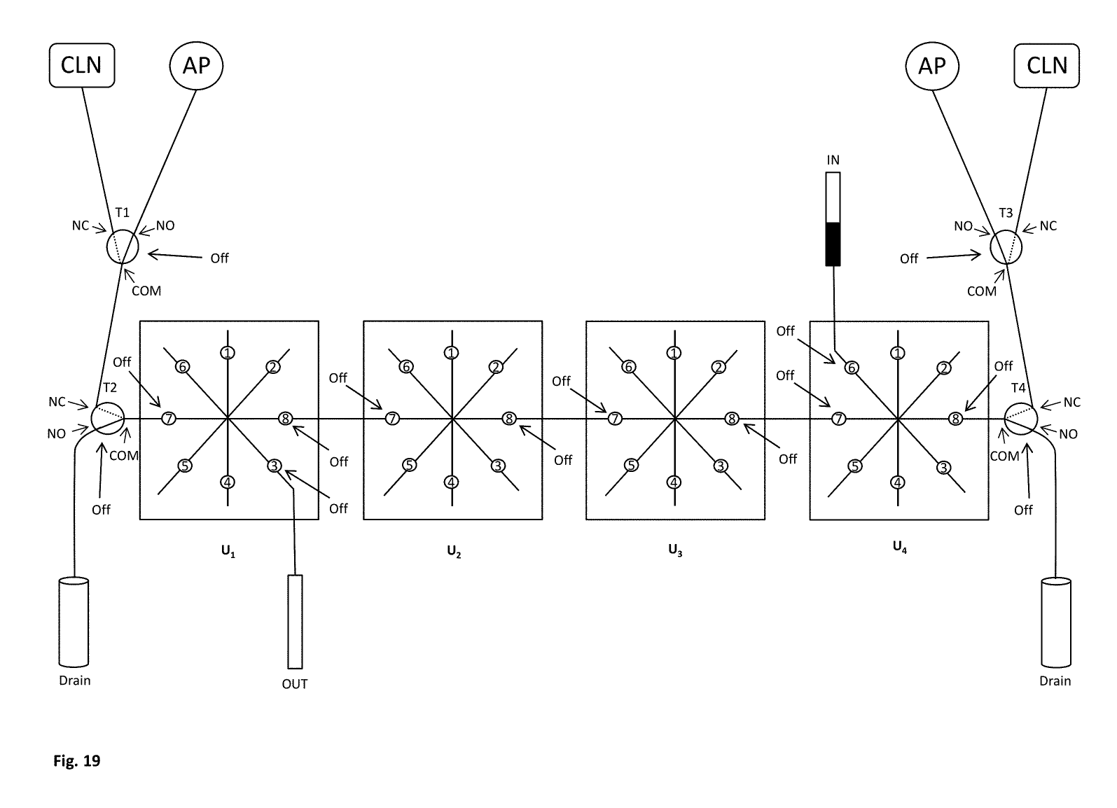

In the following example, operation of the system is sequenced in the same five classes of states as the previous two examples. These are depicted in FIGS. 19-23.

Inputs and outputs chosen in this example is as follows:

Unit 4 (U₄) valve-6 is used as a fluid input fed by a reagent or fluidic source,

Unit 1 (U₁) valve-3 is used as a fluid output to feed a reagent or fluidic destination.

The valves that are involved in this example are T3, T4, U₄ valve-8, U₄ valve-6, U₄ valve-7, U₃ valve-8, U₃ valve-7, U₂ valve-8, U₂ valve-7, U₁ valve-8, U₁ valve-3, U₁ valve-7, and T2.

### Idle State

In the Idle state, all the valves are turned off, thus blocking fluid, solvent and gas flow, no fluid is flowing, and no gas pressure is applied. FIG. 19 represents the idle state with all the valves turned off, thus blocking fluid, solvent and gas flow, e.g. valves T3, T4, U₄ valve-8, U₄ valve-6, U₄ valve-7, U₃ valve-8, U₃ valve-7, U₂ valve-8, U₂ valve-7, U₁ valve-8, U₁ valve-3, U₁ valve-7, and T2 are all turned off.

### Fluid Flow State

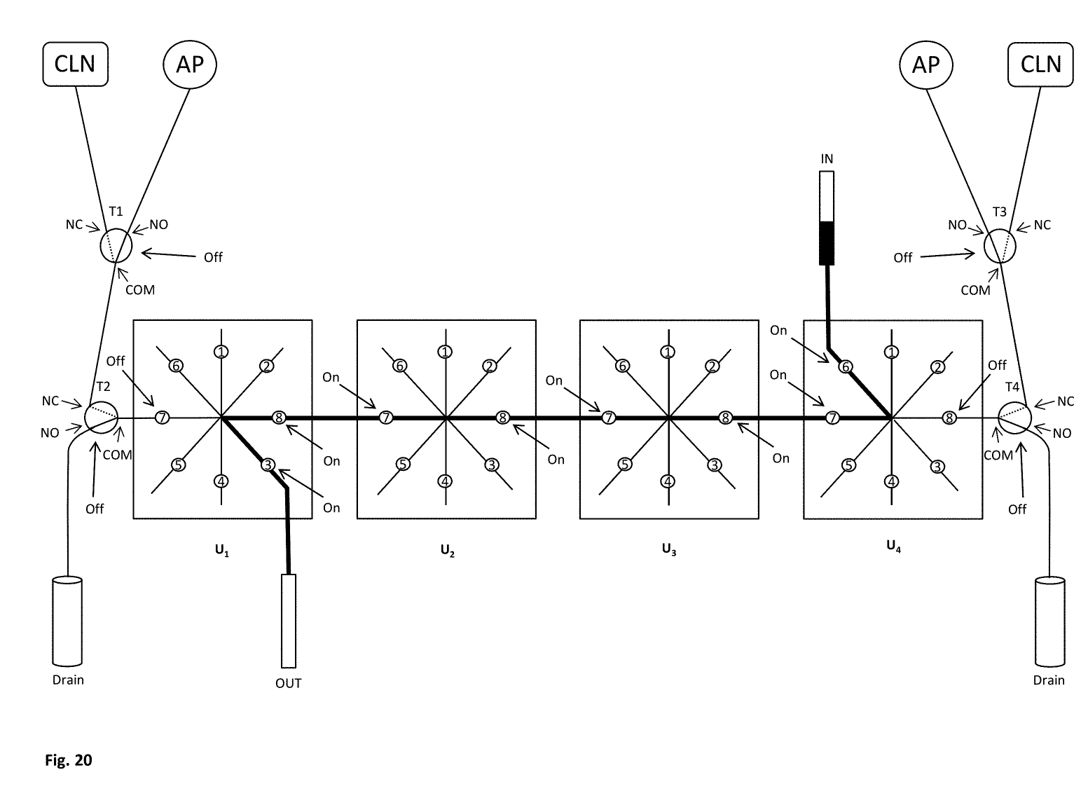

In the fluid flow state, the fluid flows from U₄ input to U₁ output. In the following example the fluid flows from U₄ valve-6 to U₁ valve-3. Thus, the valves U₄ valve-6, U₄ valve-7, U₃ valve-8, U₃ valve-7, U₂ valve-8, U₂ valve-7, U₁ valve-8, and U₁ valve-3 are turned on to allow the fluid to flow from U₄ valve-6 to U₁ valve-3 during a desired period of time or until a desired quantity of fluid is delivered. After the fluid has been delivered from U₄ valve-6 to U₁ valve-3, the U₄ valve-6 valve is turned off. The fluid flow state is represented in FIG. 20 with valves U₄ valve-6, U₄ valve-7, U₃ valve-8, U₃ valve-7, U₂ valve-8, U₂ valve-7, U₁ valve-8, and U₁ valve-3 turned on and T3, T4, U₄ valve-8, U₁ valve-7, and T2 remaining turned off.

### Gas-Pressure Clearing State

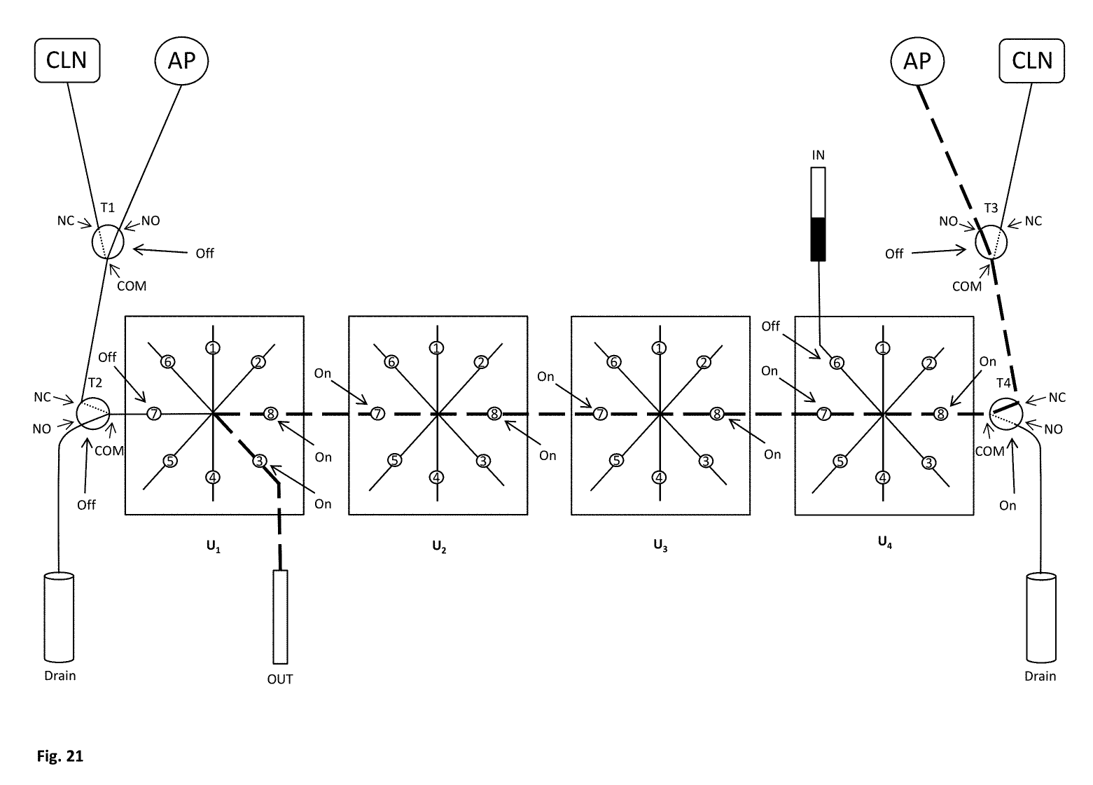

In the Gas-Pressure Clearing state, applied gas pressure pushes the remaining fluid present in the fluidic pathways into the output. In the example, the remaining fluid in the fluidic pathways is pushed into the output U₁ valve-3. T3 valve needs to be turned off so that the NO and COM are connected. T4 valve needs to be turned on so that the NC and COM are connected together and U₄ valve-8, U₄ valve-7, U₃ valve-8, U₃ valve-7, U₂ valve-8, U₂ valve-7, U₁ valve-8, and U₁ valve-3 are turned on while U₄ valve-6, U₁ valve-7 and T2 are turned off. The Gas-Pressure Clearing state is represented in FIG. 21.

### Solvent-Based Cleaning State

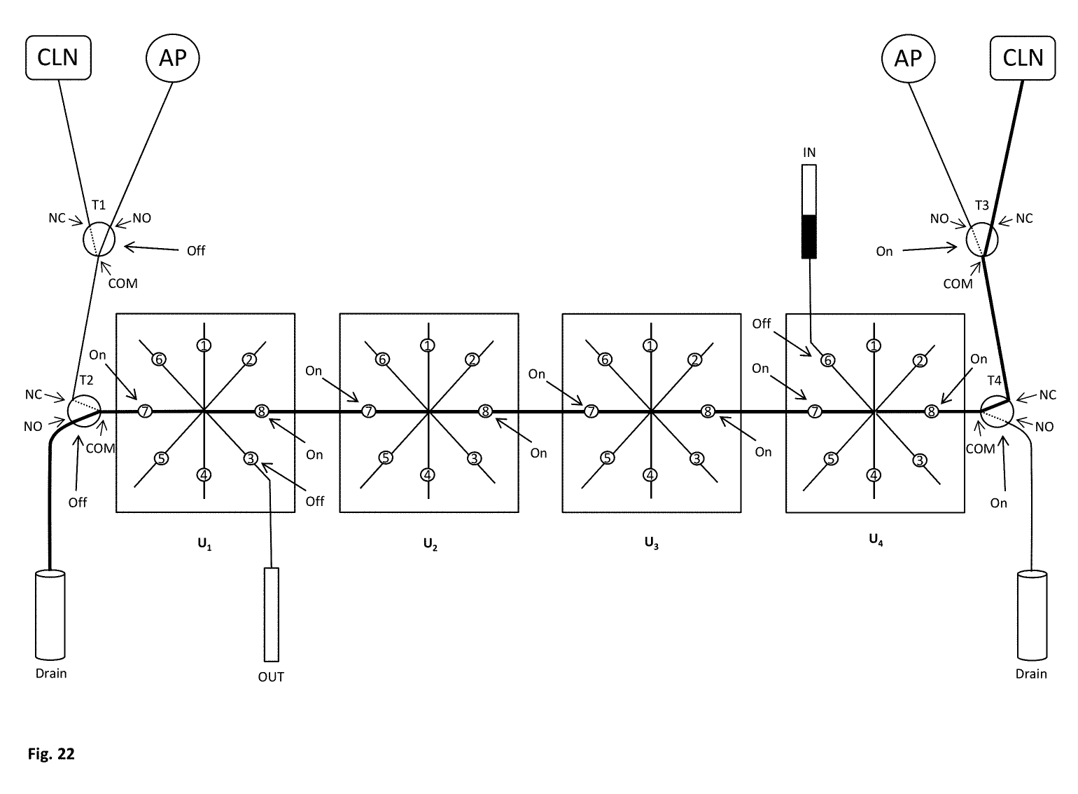

In the solvent-based cleaning state, the fluidic pathways are cleaned by allowing a cleaning solvent to flow into the fluidic pathways which is then dumped into the drain. The next fluid burst or segment flowing from a new input to a new output will flow into clean fluidic pathways without contaminations from the previous fluid flow. In this example, after the gas transports the remaining fluid into U₁ valve-3 output, the valve U₁ valve-3 is turned off so that the solvent-based cleaning state can begin. In order for the CLN to flow the T3 valve needs to be turned on to connect the NC and COM together while T4 remains turned on. The valves U₄ valve-8, U₄ valve-7, U₃ valve-8, U₃ valve-7, U₂ valve-8, U₂ valve-7, U₁ valve-8, and U₁ valve-7 are turned on while U₄ valve-6, U₁ valve-3 are turned off and T2 remains turned off in order to connect the COM and NO to allow the CLN to go into the drain. The solvent-based cleaning state is represented in FIG. 22.

### Gas-Based Drying State

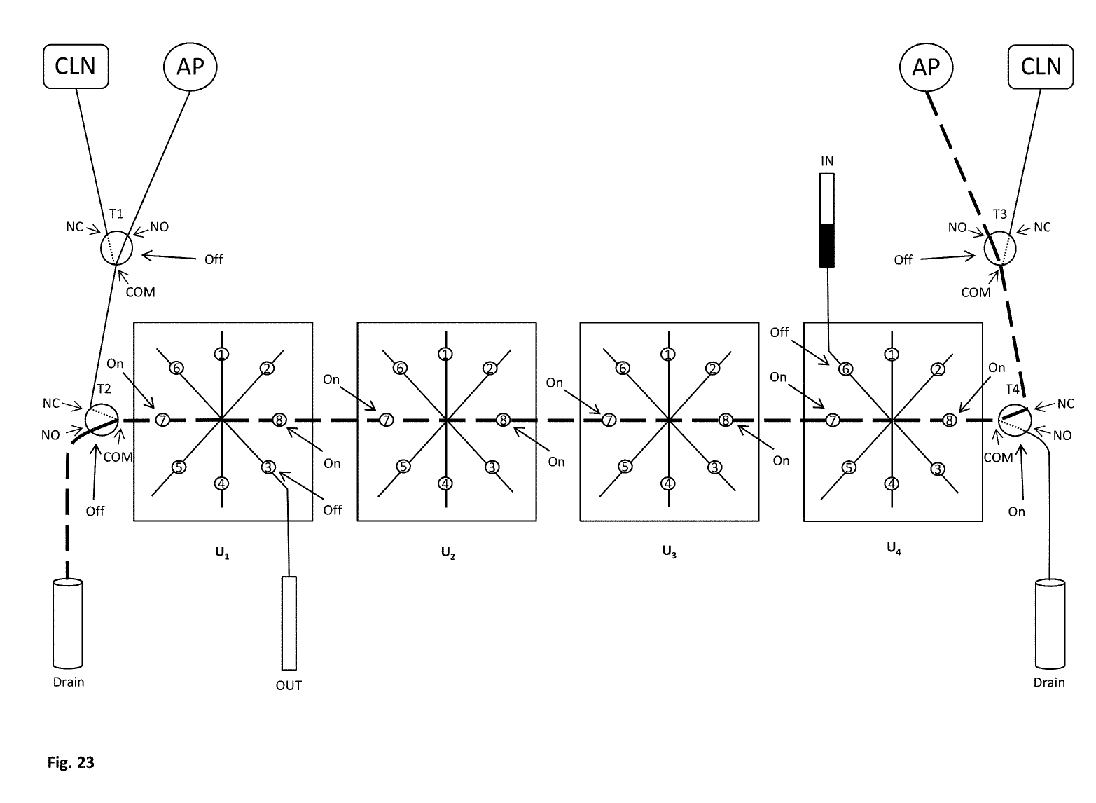

In the gas-based drying state, applied gas pressure is used to push and dry the remaining cleaning solvent into the drain as well as drying any volatile solvent components. In order to let the AP flow, T3 valve needs to be turned off so that the NO and COM are connected again. The valves T4, U₄ valve-8, U₄ valve-7, U₃ valve-8, U₃ valve-7, U₂ valve-8, U₂ valve-7, U₁ valve-8, and U₁ valve-7 remain turned on while the valve U₄ valve-6, U₁ valve-3, and T2 remain turned off. The gas-based drying state is represented in FIG. 23.

### 4. Burst Transport

As a reminder, all of the above examples have been made in the context of contiguous flow transport.

Again:
“Contiguous-flow” can signify a fluid flow from one source to at least one destination that is simply started and stopped with no intervening gas or air introduced to create segmenting open gaps in the fluid flow. It is possible to modify the definition of “contiguous-flow” in various ways to admit and/or differentiate additional minor distinctions; such alternative definitions are anticipated and provided for by the invention. (It is also possible to extend the definition of “contiguous-flow” in various ways to include and/or pertain to gas flows; such extended definitions are also anticipated and provided for by the invention.)
“Burst transport” can signify a fluid flow from one source to at least one destination wherein intervening gas or air introduced to create segmenting open gaps in the fluid flow. Typically burst transport would be used to sequentially transport multiple types of fluids through the same conduit, valve, pump, etc. It is possible to modify the definition of “contiguous-flow” in various ways to admit and/or differentiate additional minor distinctions; such alternative definitions are anticipated and provided for by the invention. (It is also possible to extend the definition of “burst transport” in various ways to include and/or pertain to gas flows; such extended definitions are also anticipated provided for by the invention.)

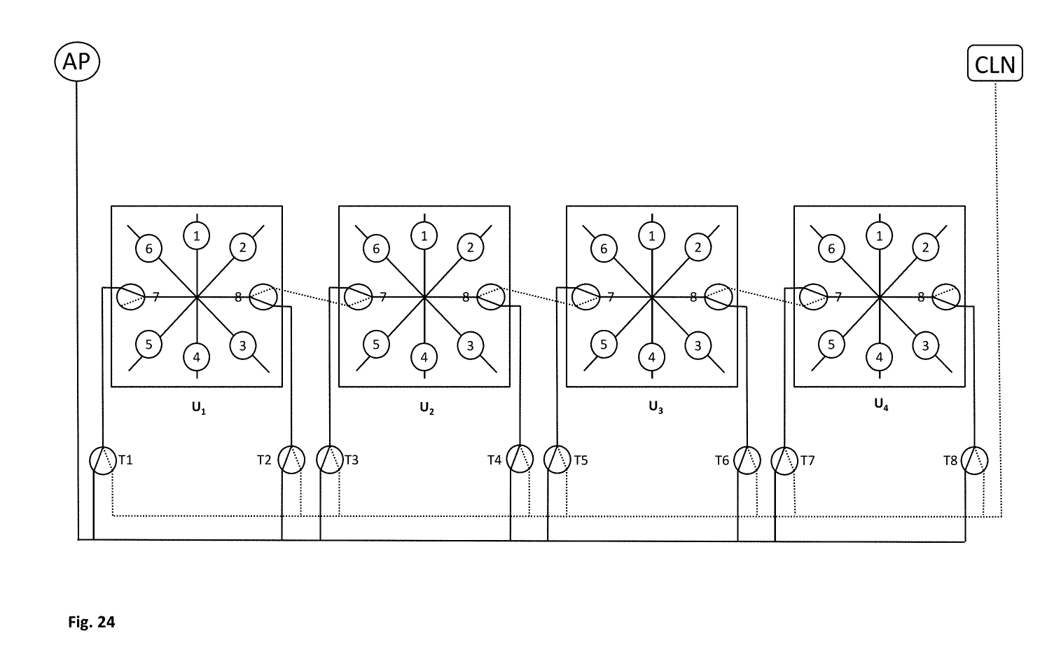

FIG. 24 depicts a first example arrangement for supporting transport of short fluid burst whose transport is driven by applied gas pressure.

In this example, SPDT valves are connected to every port 7 and port 8 of each of four 8-branch valve cluster units and are denoted T1-T8 as indicated in FIG. 24. To form a fluidic bus, each 8-branch valve cluster unit is interconnected to neighboring units to form a series via the NC port of the SPDT valve of port 7 and port 8 of each valve cluster unit.

As an example, the SPDT valve can be implemented as a solenoid-operated valve. When such a SPDT valve is not energized (“off”) its NO port and COM port are connected and the NC port is blocked. In the figures, this “unenergized” (“off”) condition is represented by a solid line linking the valve's NO port and COM port, and the non-connected NC port is represented with a dotted line linking the valve's NC port and COM port.

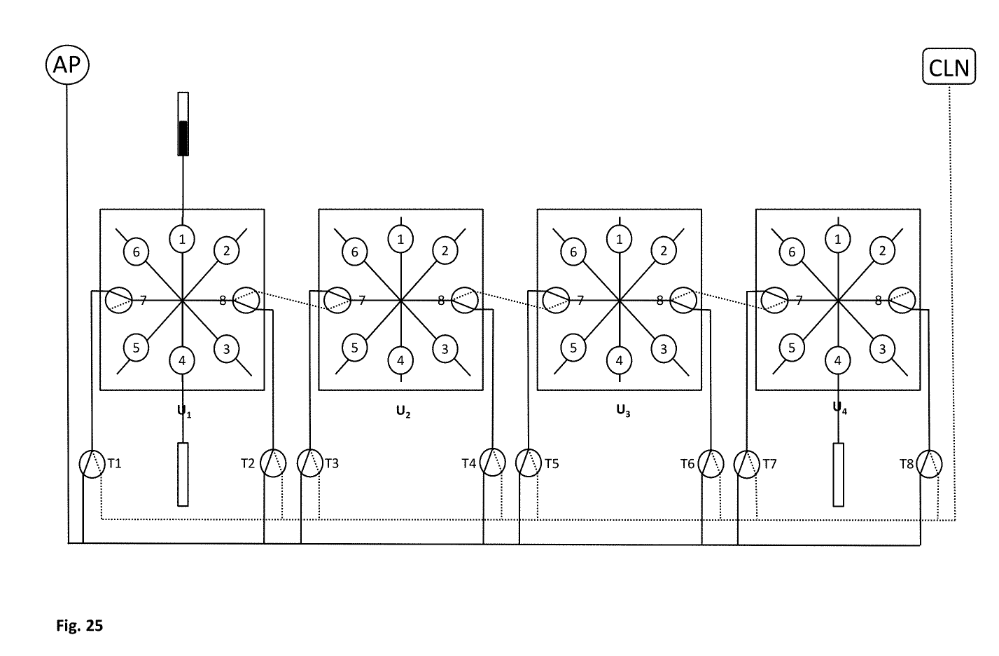

When electricity is applied the SPDT valve, the NC port and COM port become connected and the NO port becomes blocked. In the figures, this “energized” (“on”) condition is represented by a solid line linking the valve's NC port and COM port, and the non-connected NC port is represented with a dotted line linking the valve's NO port and COM port, for example as suggested by selected valves depicted in FIGS. 25-27 to be described.

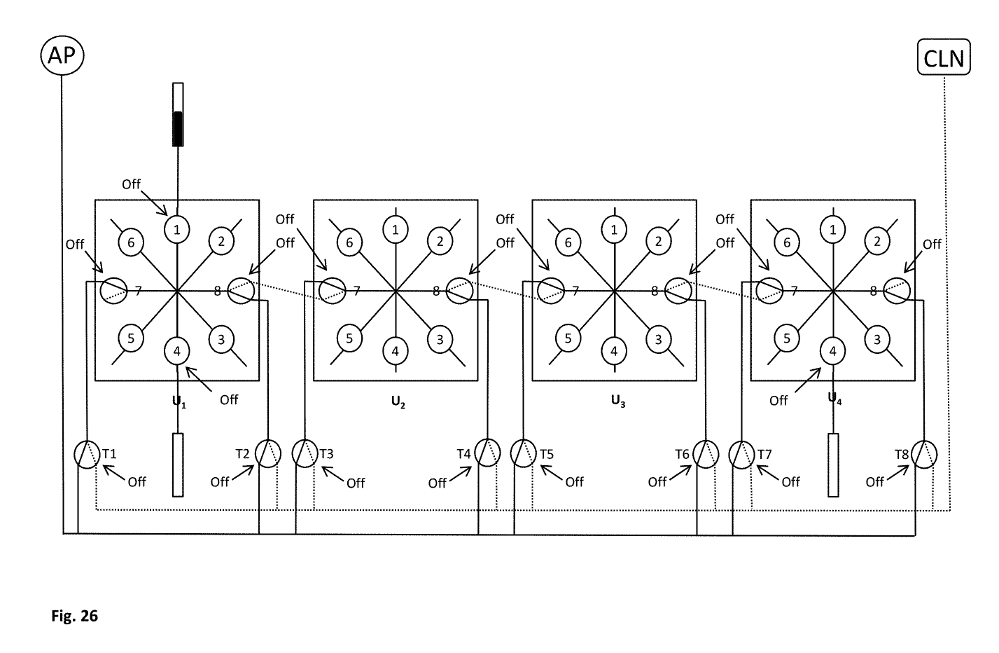

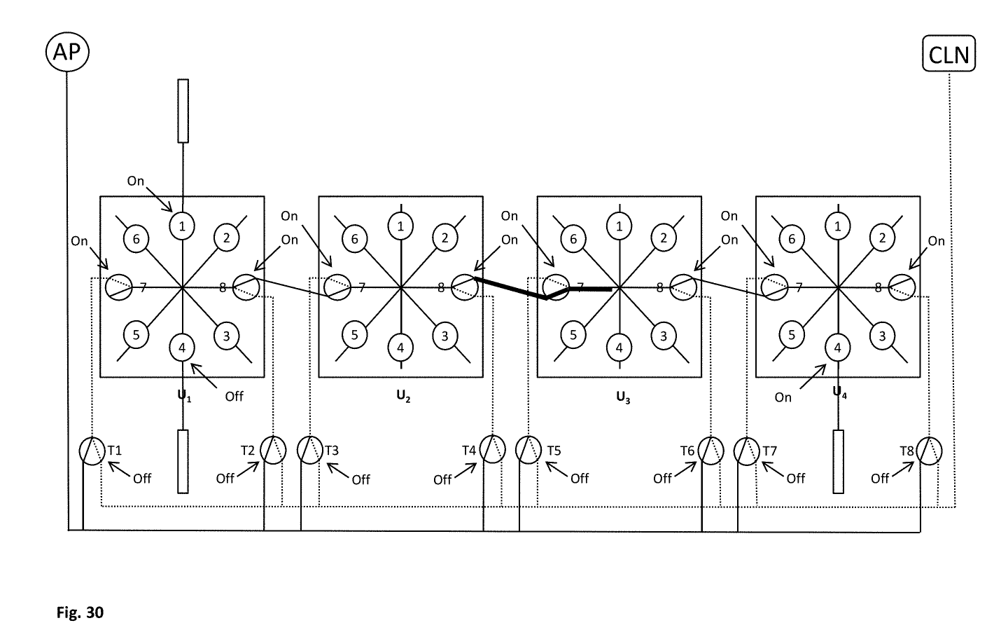

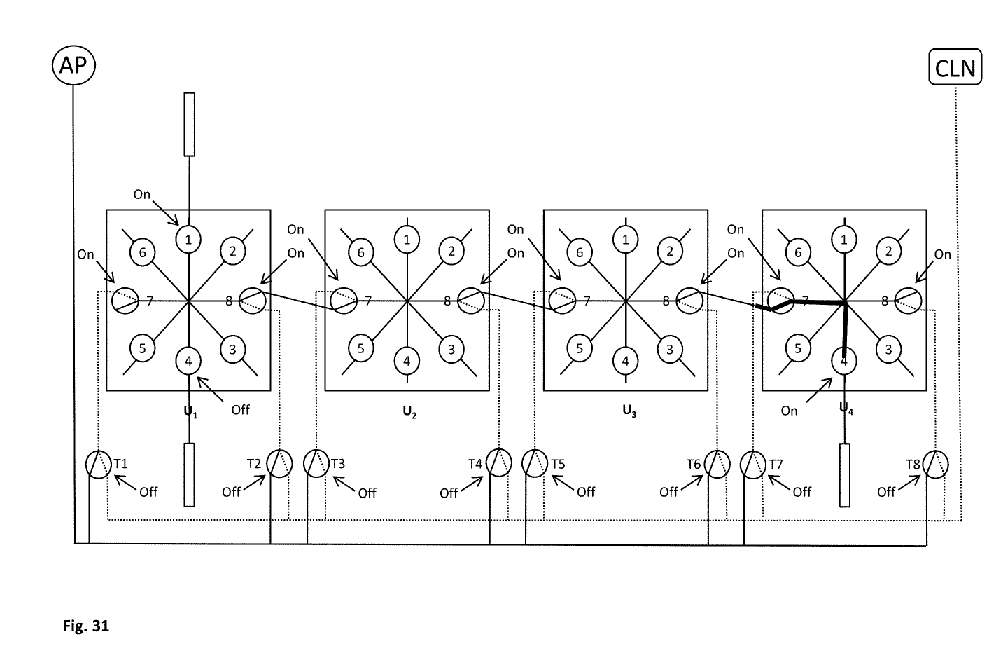

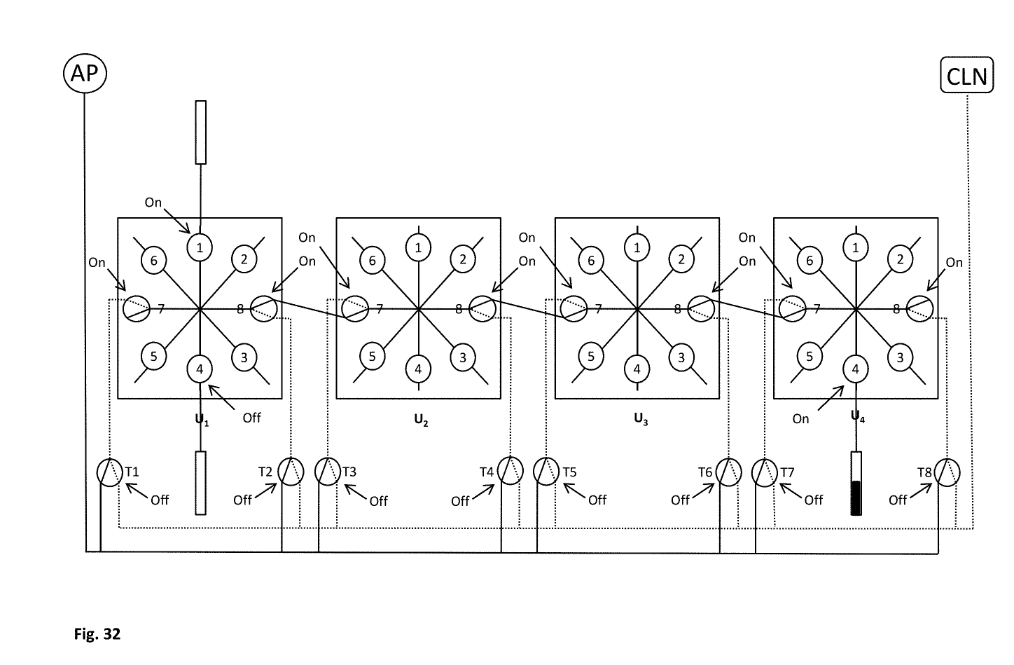

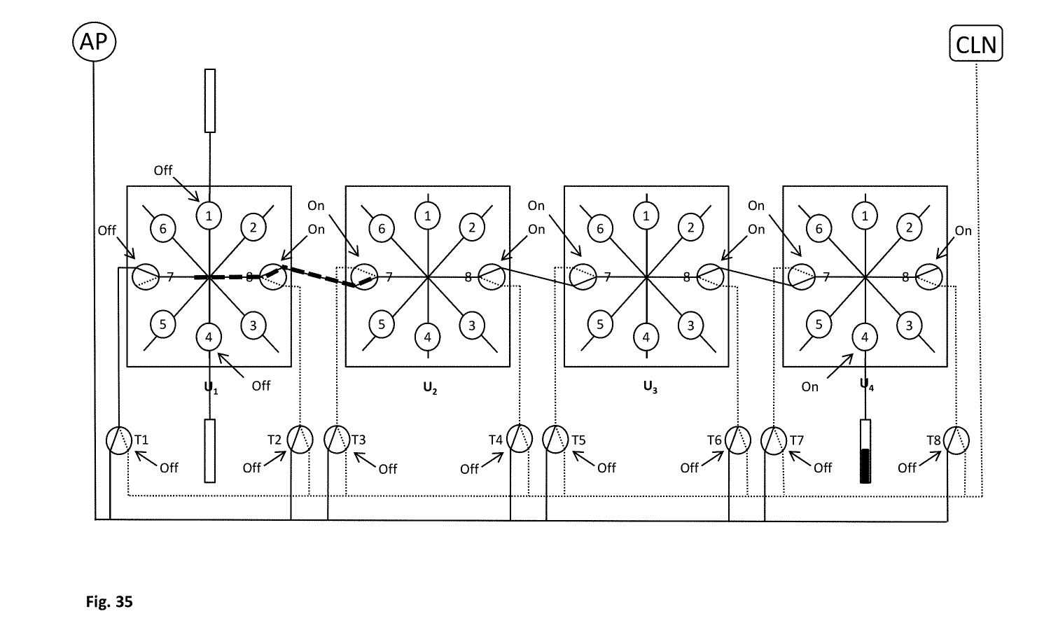

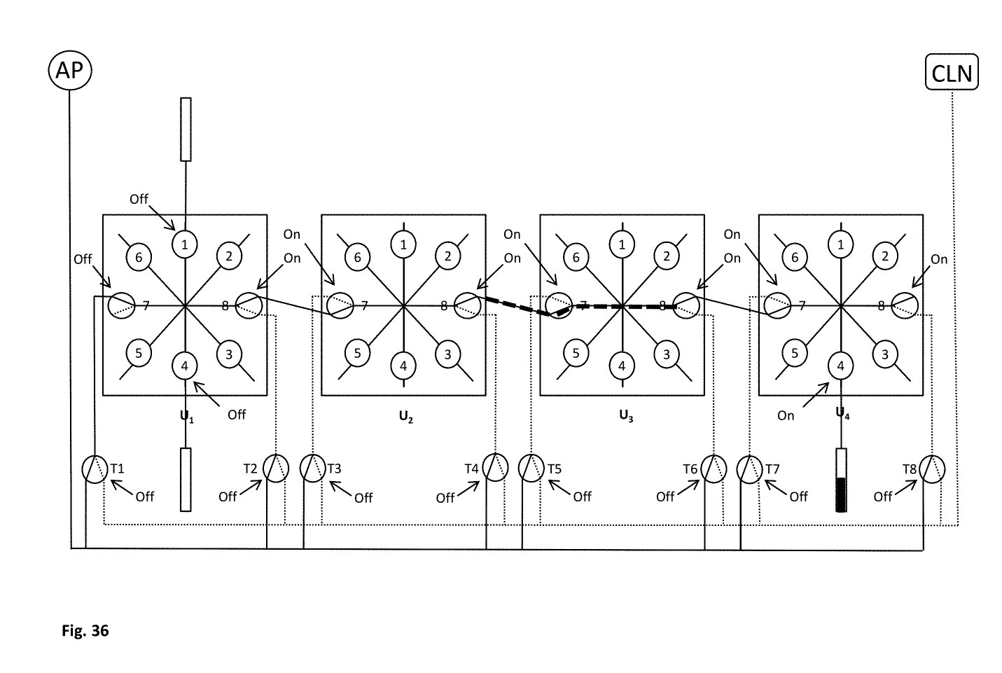

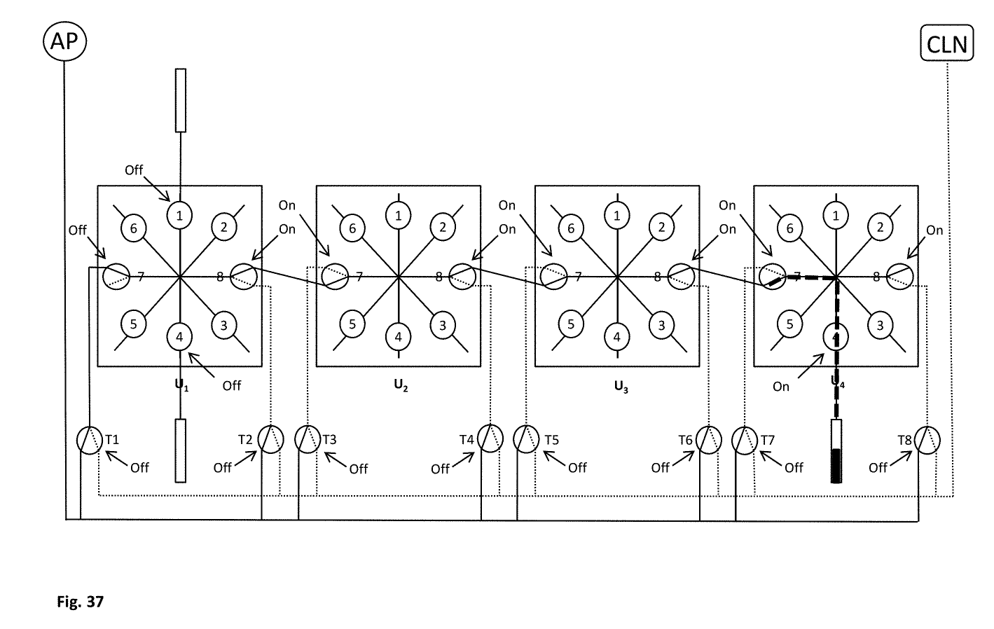

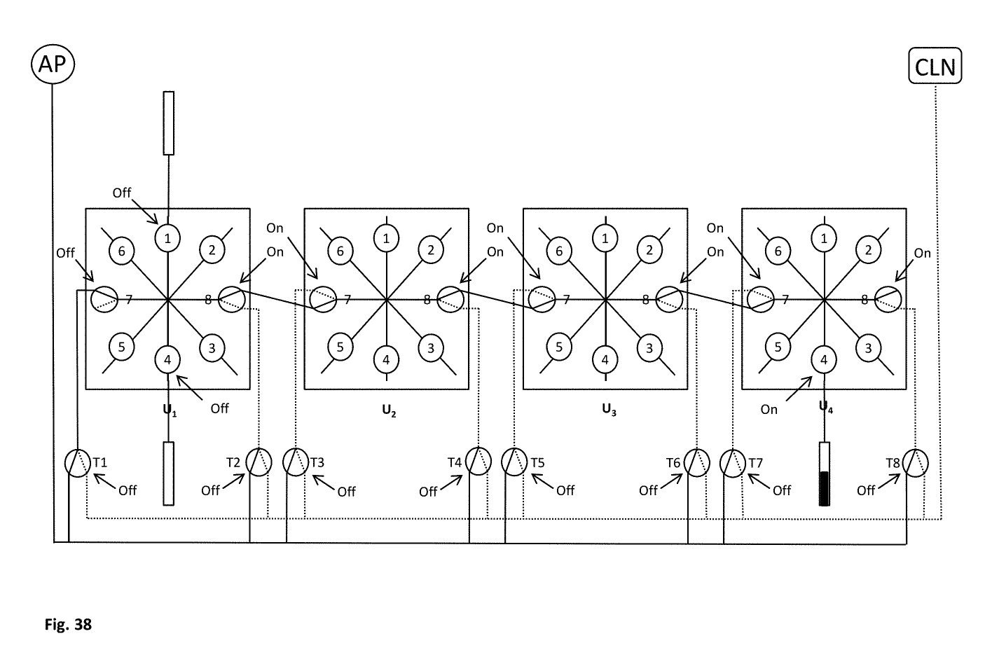

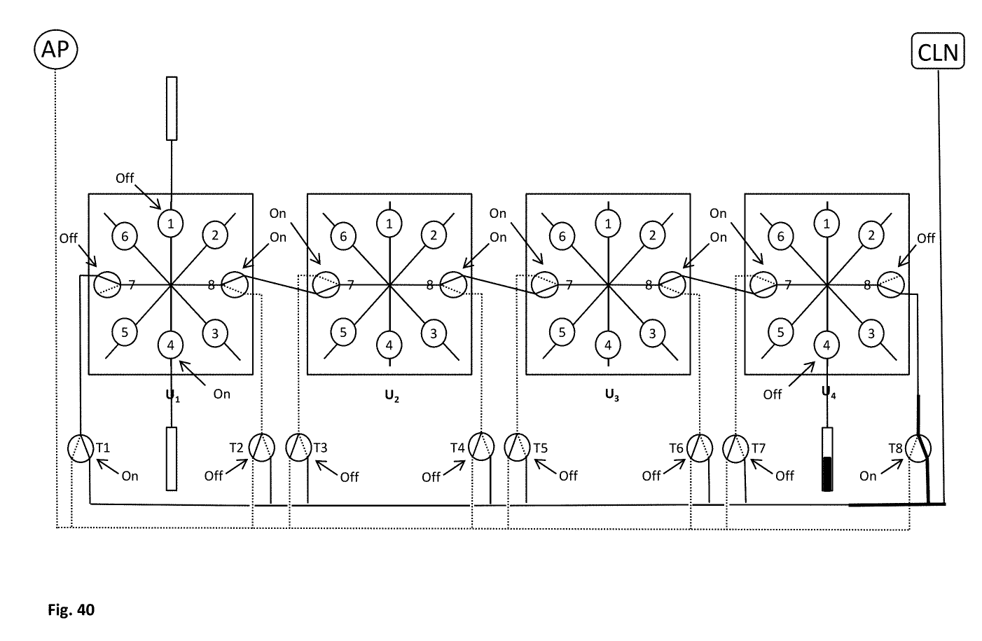

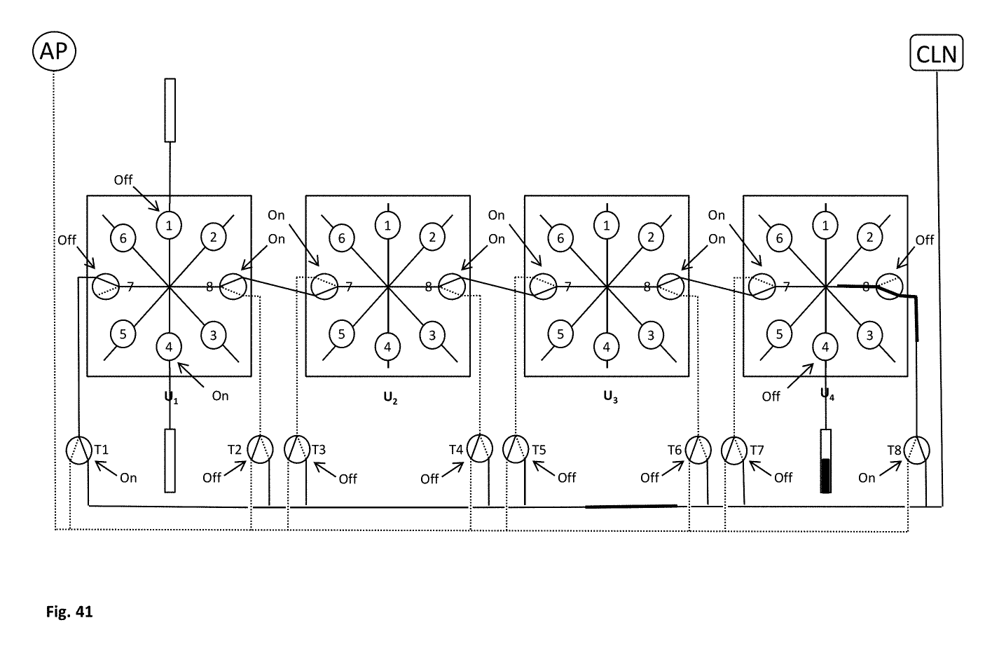

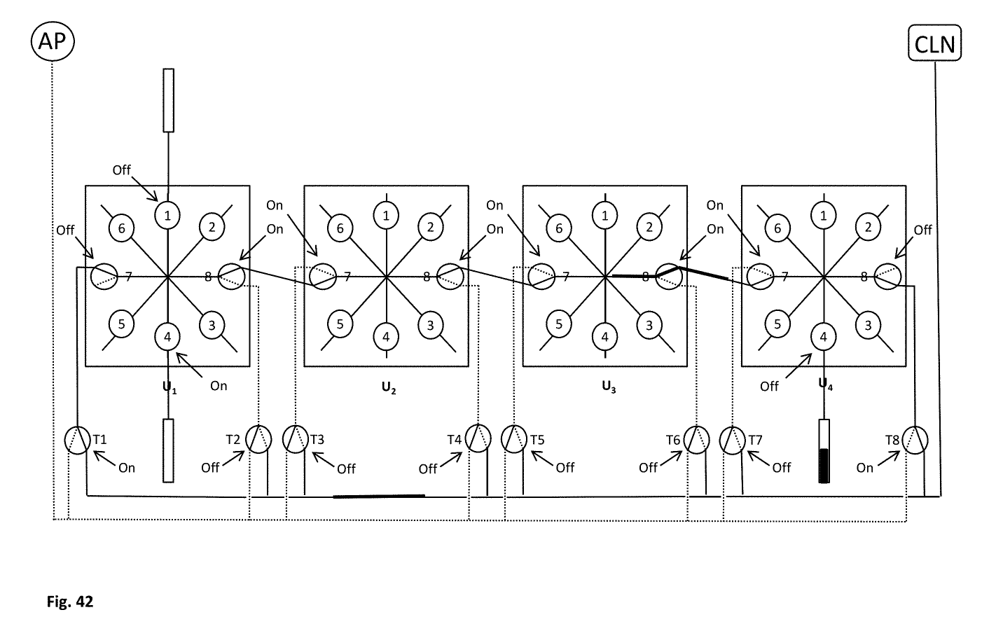

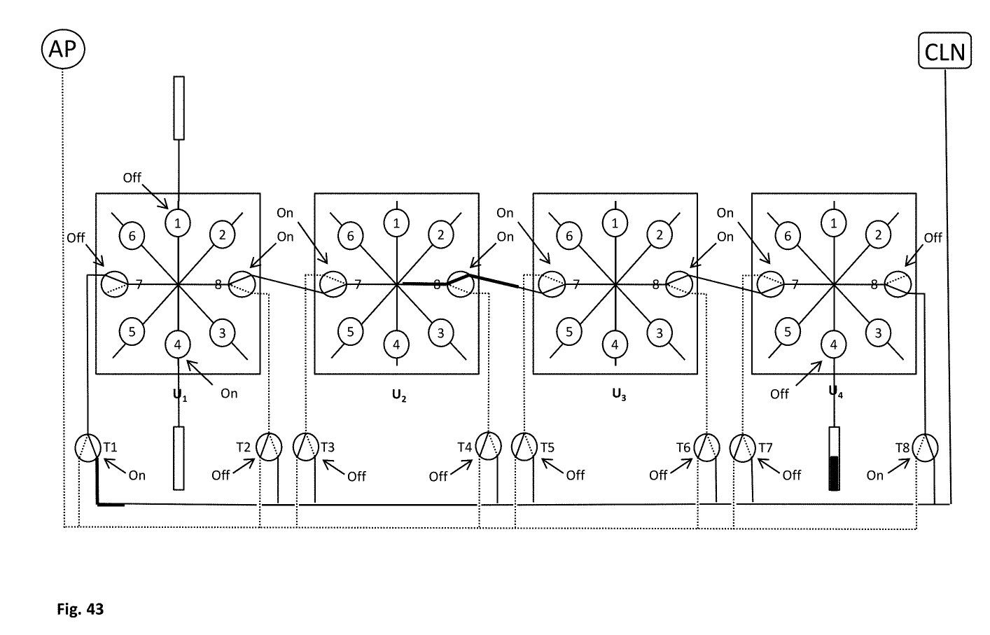

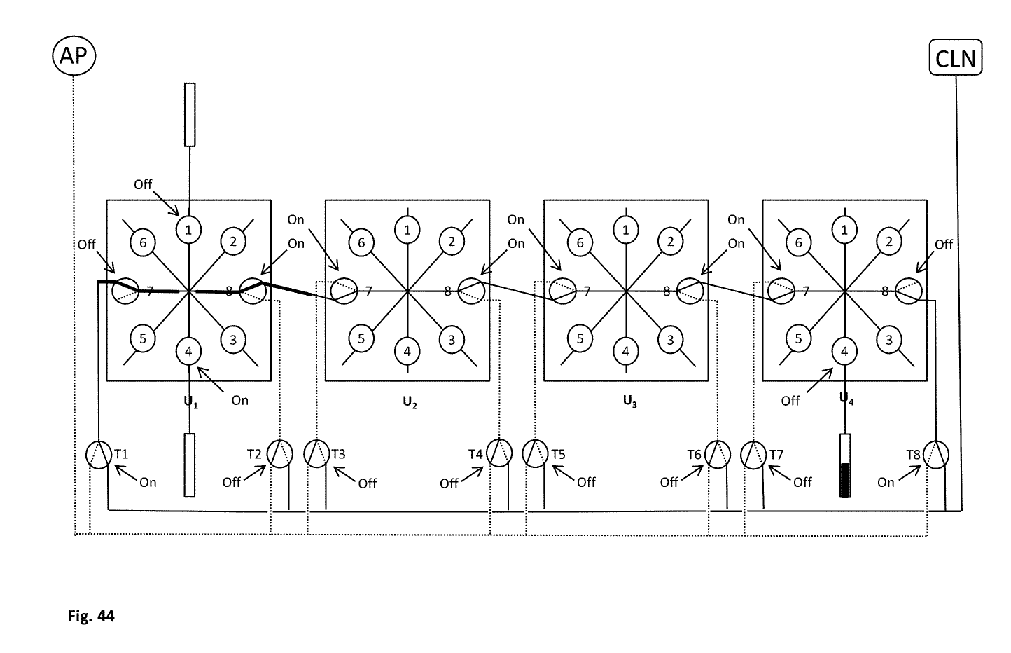

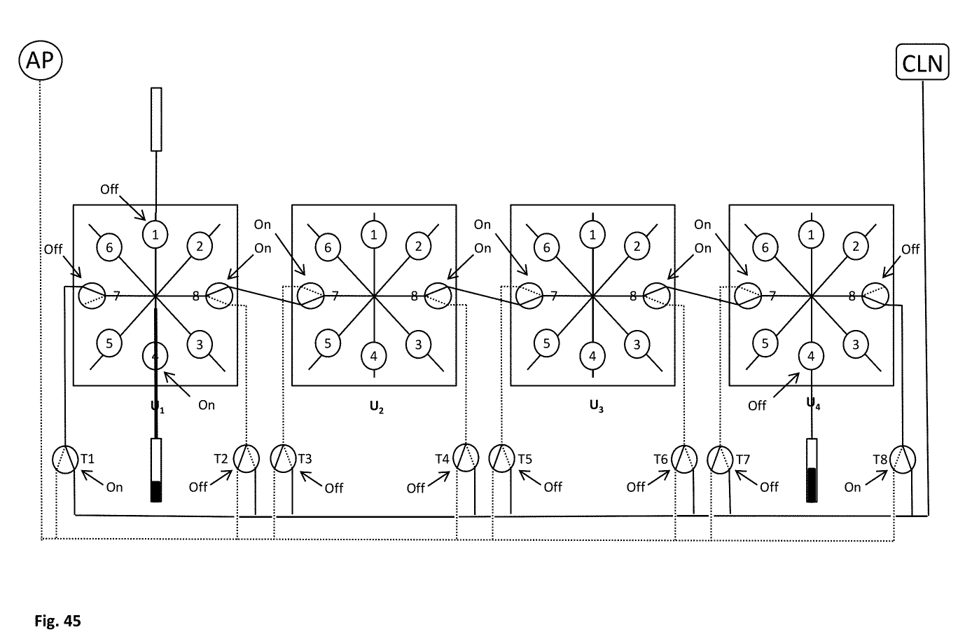

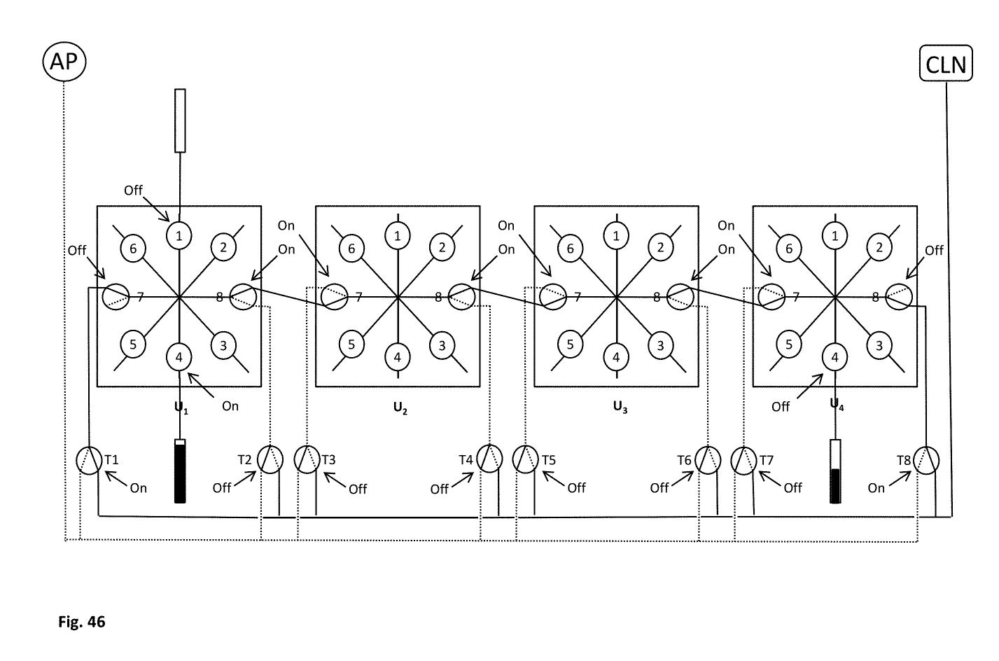

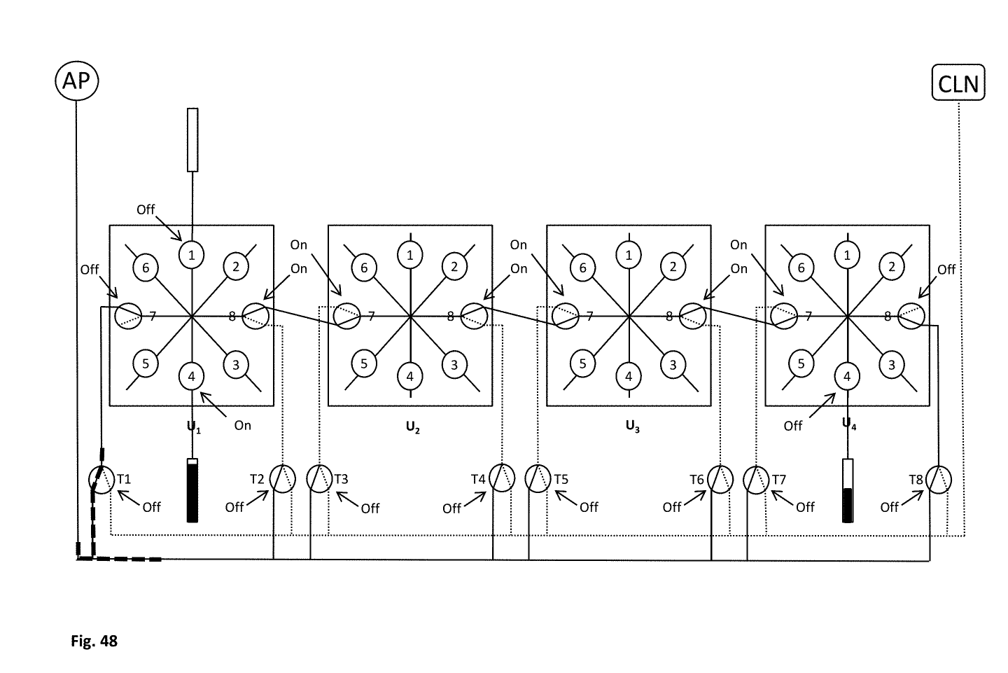

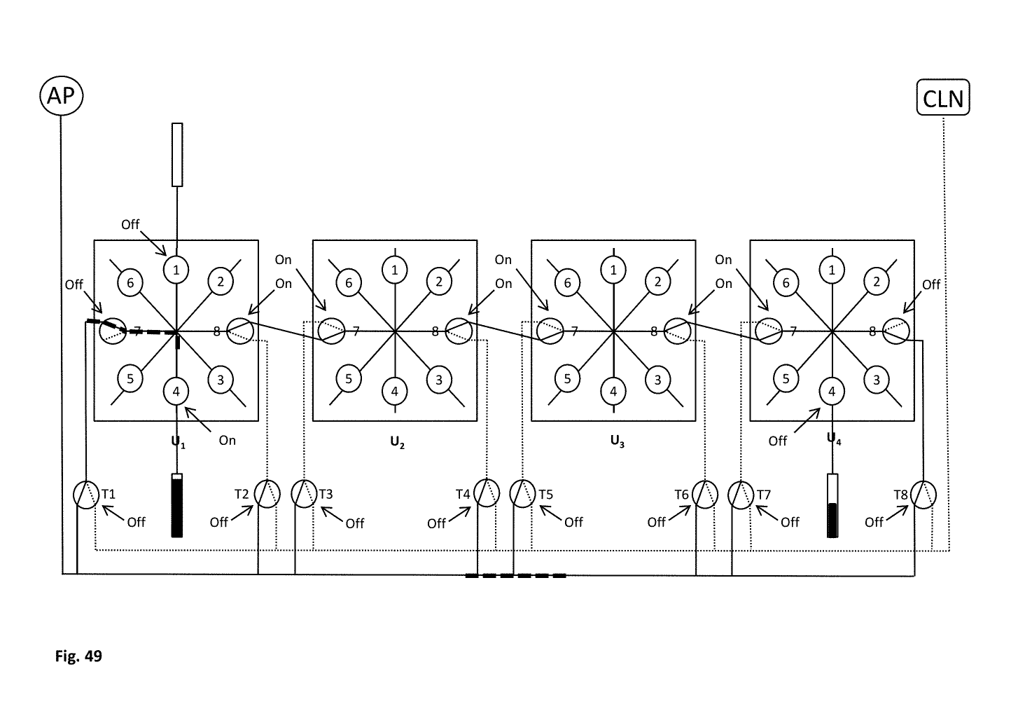

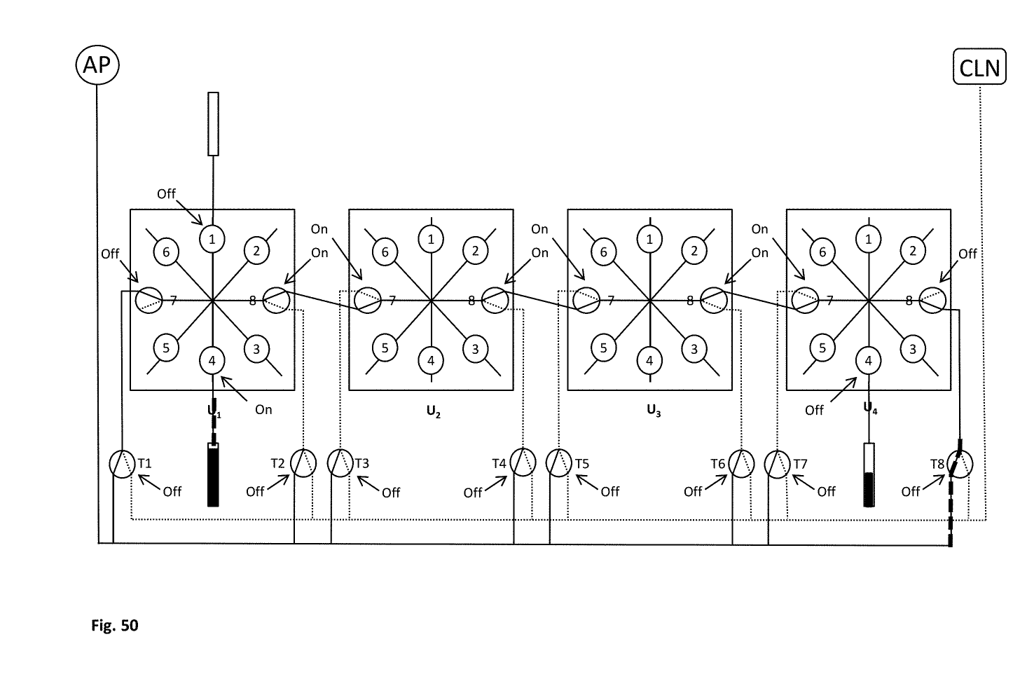

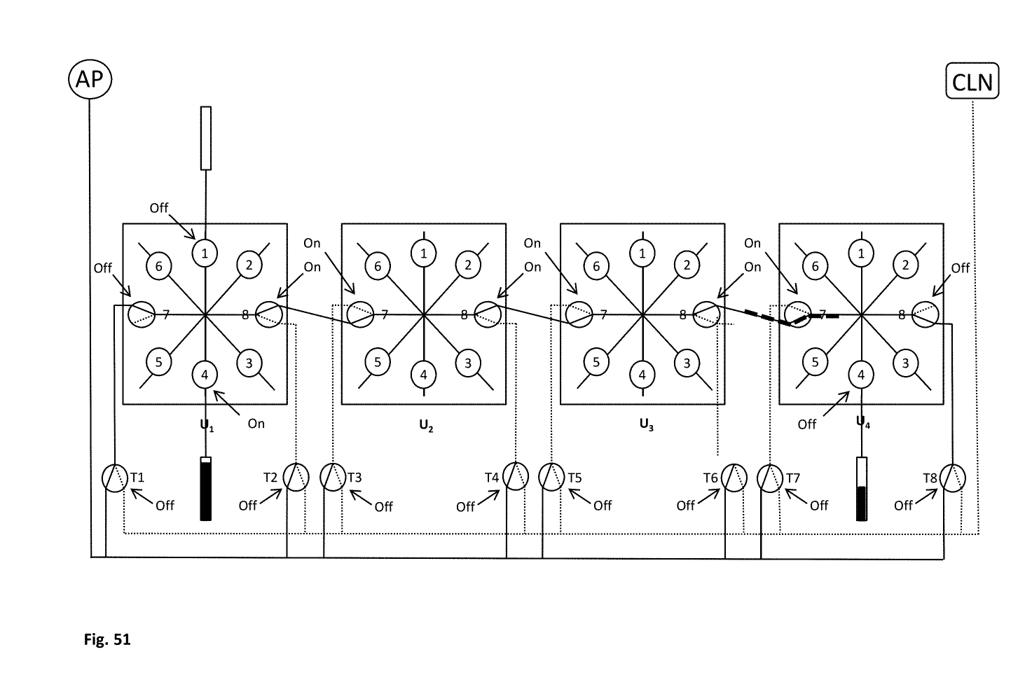

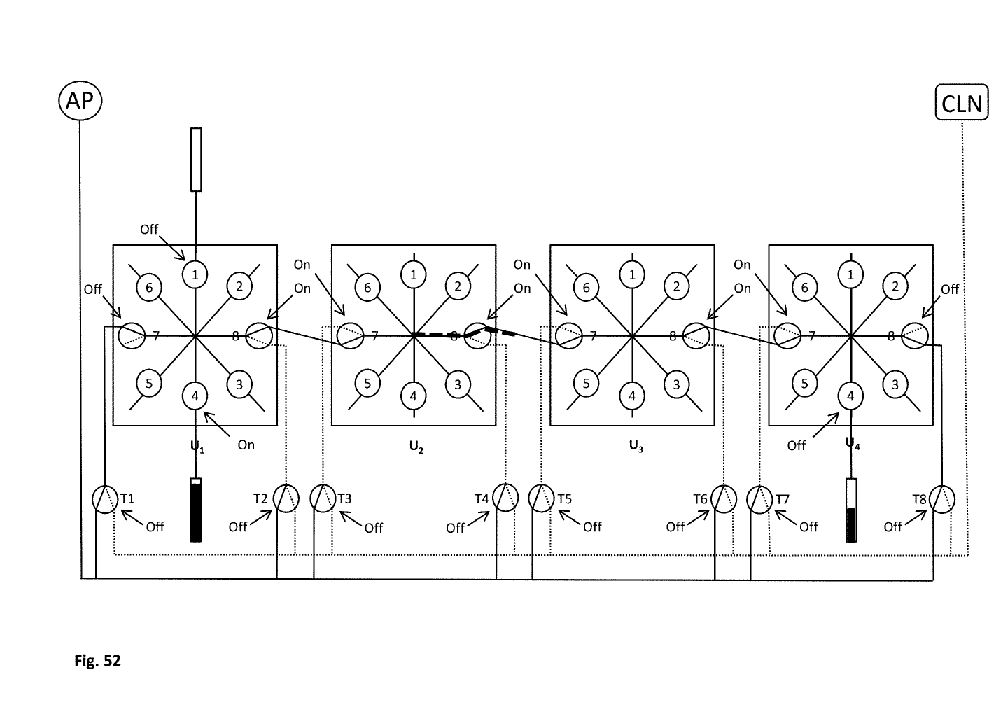

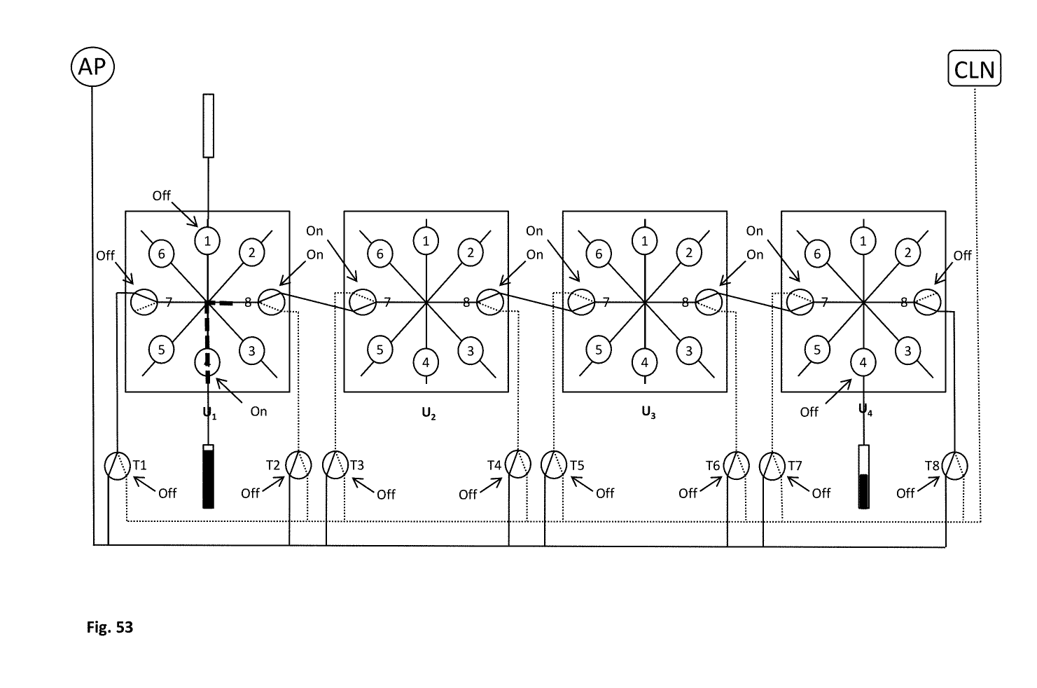

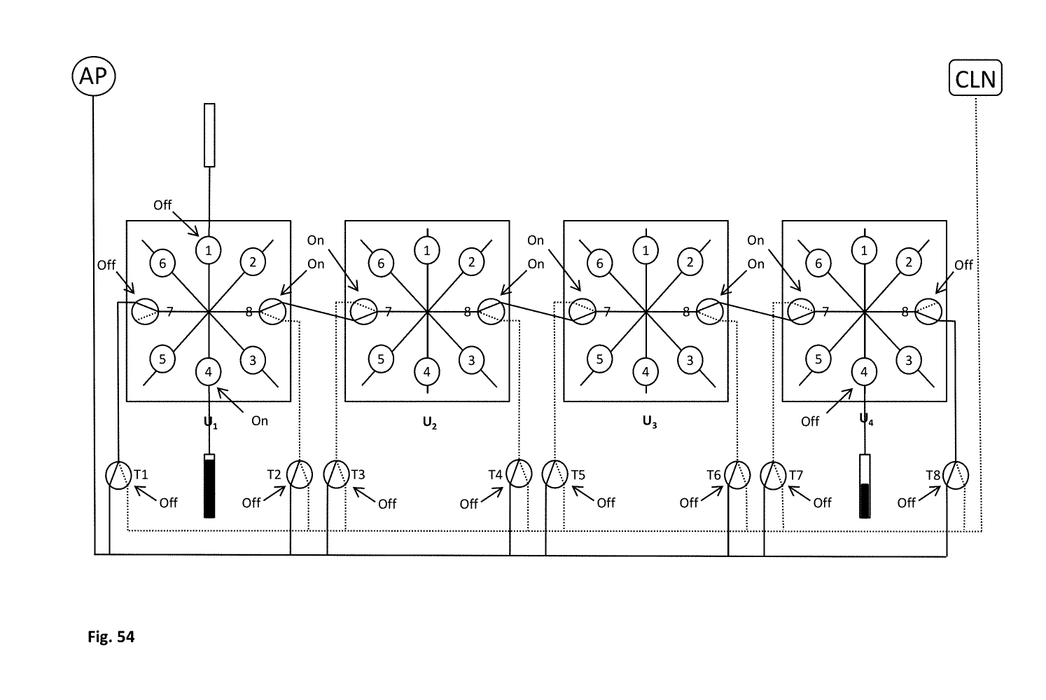

In the following example, the new operation of the system is sequenced in the same five classes of states as the previous two examples. These are depicted in FIGS. 26-54.

The fluidic system used in this example is represented in FIG. 25. Inputs and outputs utilized in this example include:

Unit 1 (U₁) valve-1 is used as a fluid input fed by a reagent or fluidic source,

Unit 4 (U₄) valve-4 is used as a fluid output to feed a reagent or fluidic destination.

Valves that are involved in an example where fluid flows from port 1 on Unit 1 to port 4 on Unit 4 are T1, U₁ valve-7, U₁ valve-1, U₁ valve-4, U₁ valve-8, U₂ valve-7, U₂ valve-8, U₃ valve-7, U₃ valve-8, U₄ valve-7, U₄ valve-4, U₄ valve-8, and T8.

The following operational example illustrates a sequence of events that facilitates a fluid flow from U₁ to U₄.

### Idle State

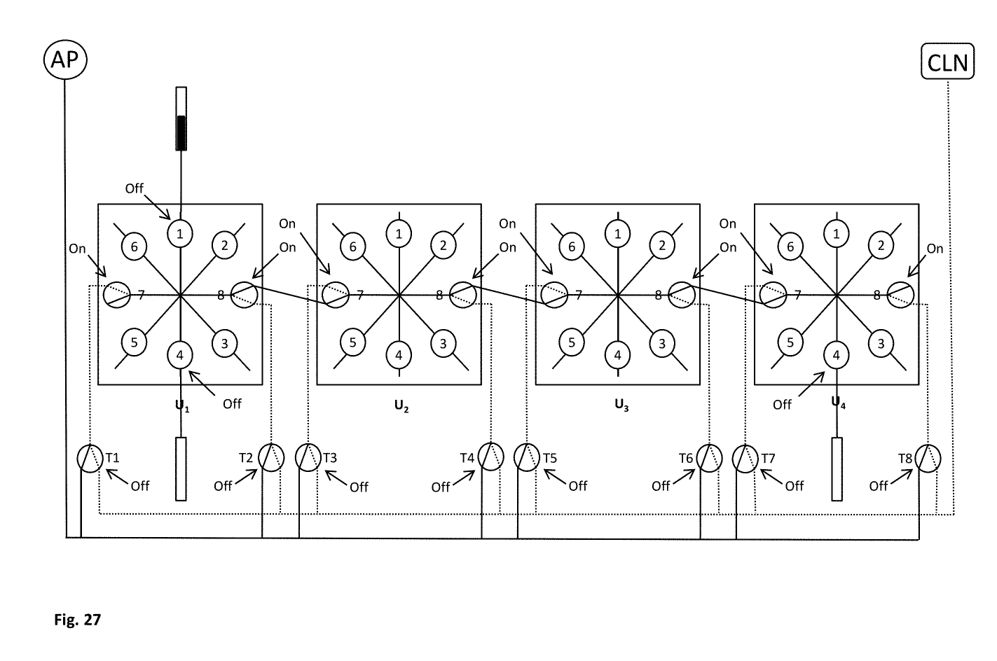

In the idle state, all the valves are turned off, no fluid or solvent is flowing, and no air pressure is applied. Thus, valves T1, U₁ valve-7, U₁ valve-1, U₁ valve-4, U₁ valve-8, U₂ valve-7, U₂ valve-8, U₃ valve-7, U₃ valve-8, U₄ valve-7, U₄ valve-4, U₄ valve-8, and T8 are all turned off. The idle state with all the valves turned off involved for this example is represented in FIGS. 26-27.

### Fluid Flow State

In the fluid flow state, the fluid flows from one input to an output. In this example, the fluid flows from U₁ valve-1 to U₄ valve-4. Thus, the valves U₁ valve-1 and U₄ valve-4 are turned on while U₁ valve-7, U₁ valve-8, U₂ valve-7, U₂ valve-8, U₃ valve-7, U₃ valve-8, U₄ valve-7, and U₄ valve-8 are already on. This allows the fluid to flow from U₁ valve-1 to U₄ valve-4 during a desired period of time or until a desired quantity of fluid is delivered. After the fluid has been delivered from U₁ valve-1 to U₄ valve-4, the U₁ valve-1 valve is turned off.

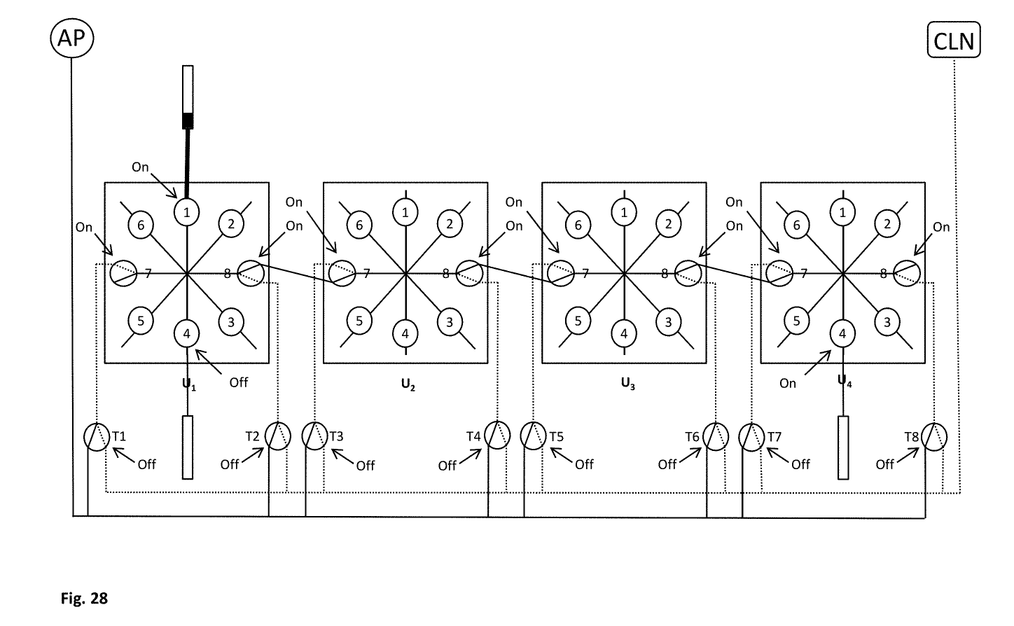

The fluid flow state is represented in detail with the fluid visibly flowing from U₁ valve-1 to U₄ valve-4 in FIGS. 28-32 with the valves U₁ valve-1, U₁ valve-7, U₁ valve-8, U₂ valve-7, U₂ valve-8, U₃ valve-7, U₃ valve-8, U₄ valve-7, U₄ valve-4, and U₄ valve-8 turned on.

### Gas-Pressure Clearing State

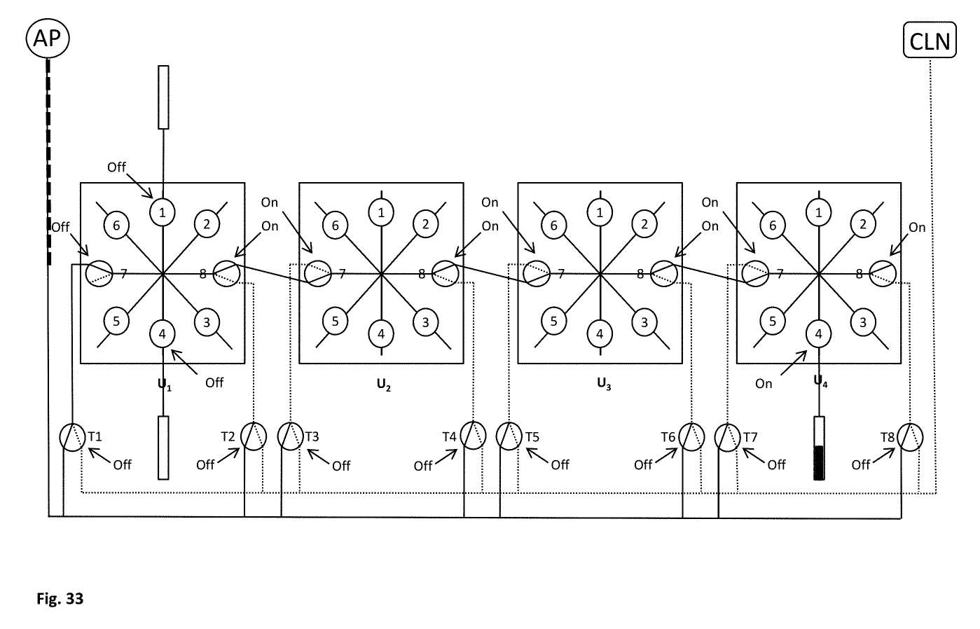

In the gas-pressure clearing state, the gas pressure pushes further the remaining fluid present in the fluidic pathways into the output. In this particular example, the remaining fluid in the fluidic pathways is pushed into the output U₄ valve-4. The T1 valve needs to remain turned off so that the NO and COM are connected. U₁ valve-7 needs to be turned off so that the NO is connected to the COM of T1. U₁ valve-8, U₂ valve-7, U₂ valve-8, U₃ valve-7, U₃ valve-8, U₄ valve-7, and U₄ valve-4 remain turned on. The gas-pressure clearing state is represented in detail with the gas moving represented with a dashed line in FIGS. 33-38.

### Solvent-Based Cleaning State

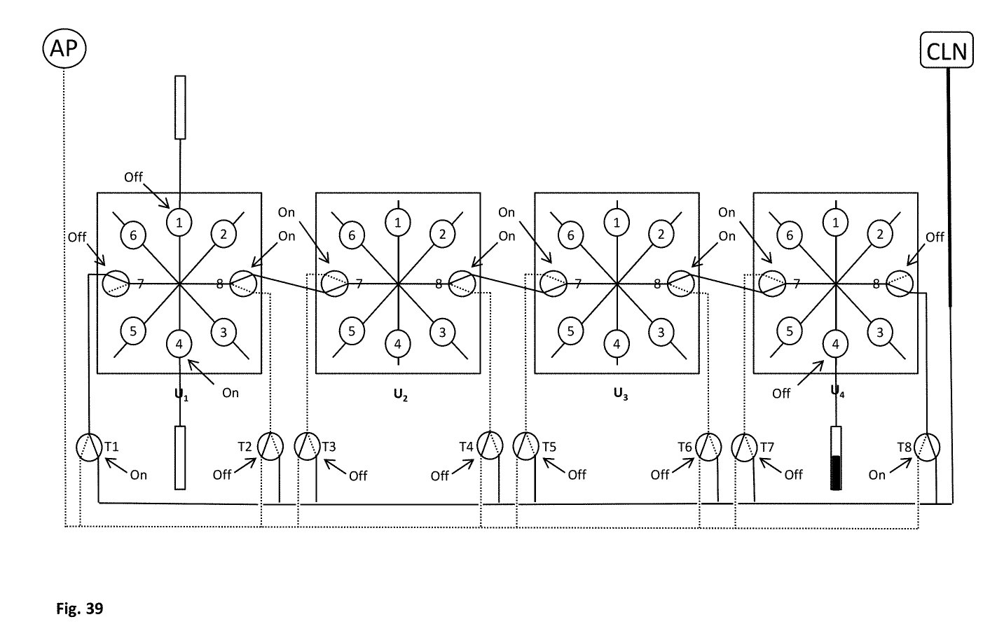

In the solvent-based cleaning state, the fluidic pathways are cleaned by allowing a cleaning solvent to flow into the fluidic pathways which is then dumped into the output U₁ valve-4, here used as a drain. The next fluid burst or segment flowing from a new input to a new output will flow into clean fluidic pathways without contaminations from the previous fluid flow. In this example, after the gas pressure transports the remaining fluid into U₄ valve-4 output, the valve U₄ valve-4 is turned off so that the solvent-based cleaning stage can begin. In order for the CLN to flow the U₄ valve-8 valve needs to be turned off to connect the NO and COM together and U₁ valve-7 remains turned off. T1 and T8 are turned on so that NC is connected with COM. The valves U₁ valve-8, U₂ valve-7, U₂ valve-8, U₃ valve-7, U₃ valve-8, U₄ valve-7, and U₄ valve-8 are all on. U₁ valve-4 used as a drain in this example is also turned on. The solvent-based cleaning state is represented in detail with the cleaning fluid flowing in both directions in FIGS. 39-46.

### Gas-Based Drying State

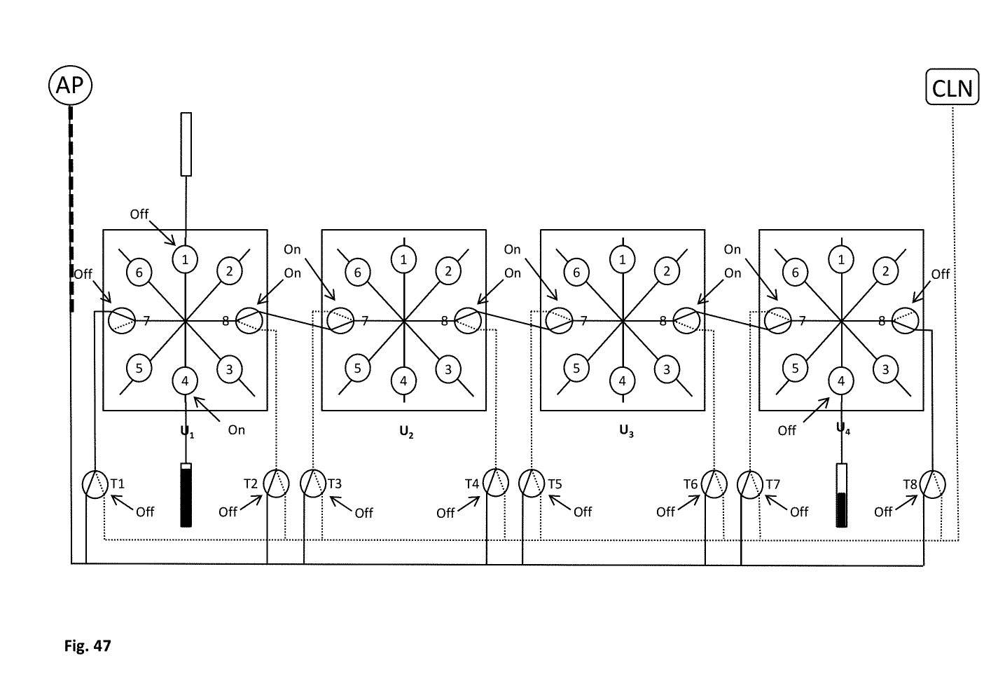

In the gas-based drying state, applied gas pressure is used to push and dry the remaining cleaning solvent into the drain U₁ valve-4 as well as drying any volatile solvent components. In order to let the drying gas (AP) flow, T1 and T8 valve needs to be turned off again so that the NO and COM are connected again. The valves U₁ valve-7, U₁ valve-4, U₁ valve-8, U₂ valve-7, U₂ valve-8, U₃ valve-7, U₃ valve-8, U₄ valve-7, and U₄ valve-8 remain all turned on. The gas-based drying state is represented in detail with the air flowing in both directions in FIGS. 47-54.

### 5. Valve-Chaperoned T-Topology Junction and Triangle-Topology Valve-Cluster Implementations and Operations

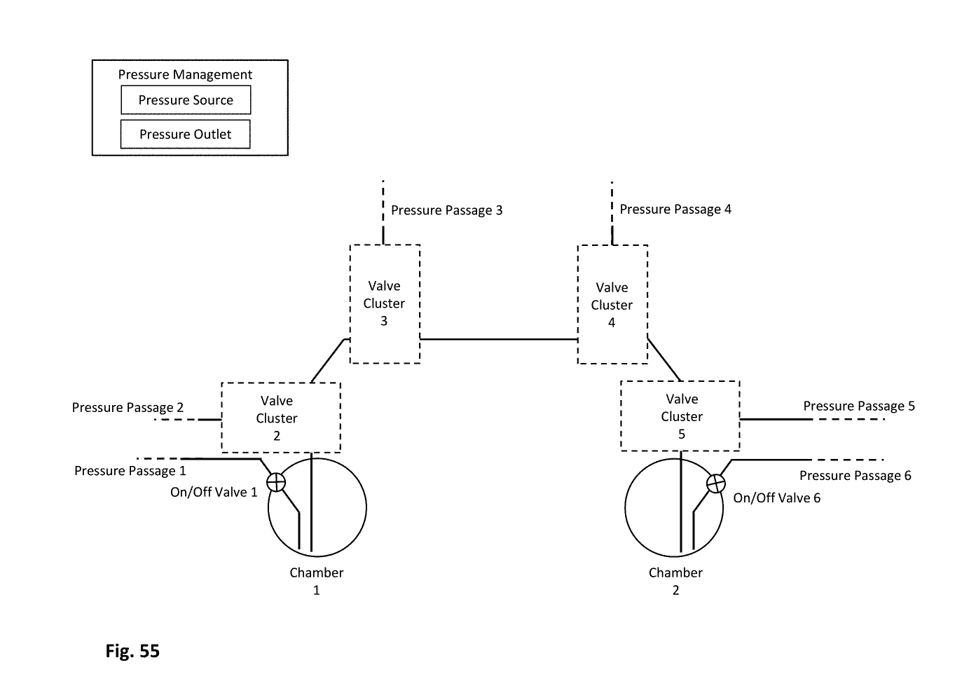

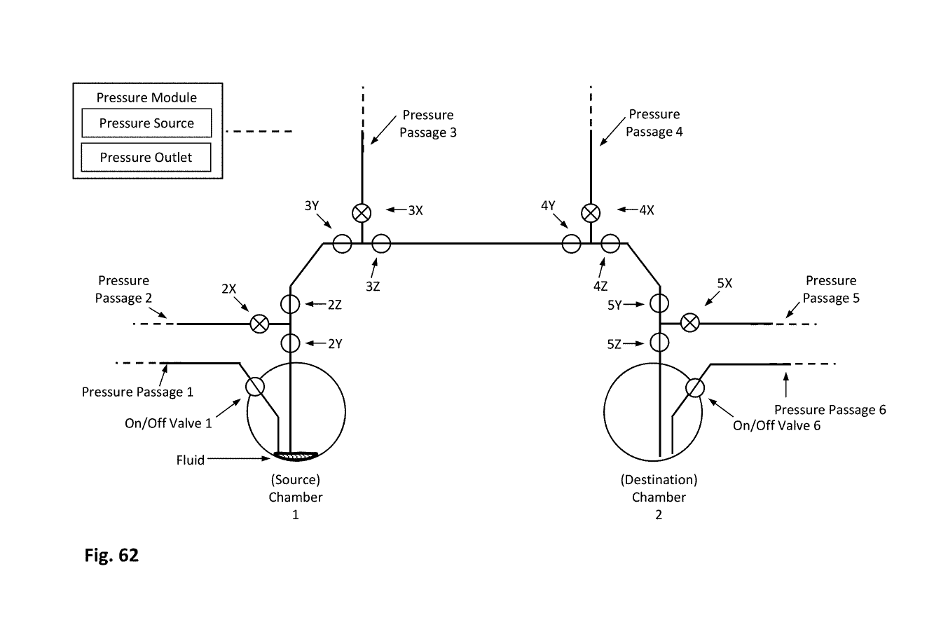

FIG. 55 depicts a simplified example system comprising two chambers, each comprising a dedicated valve-gated pressure passage and a fluid transport port. The fluid transport ports of the two chambers are joined by an interconnecting transport line punctuated with valve cluster arrangements for routing fluids and introducing gas pressure, venting, vacuum, etc. Although the example arrangement depicted in FIG. 62 comprises a total of 6 pressure passages (numbered 1 to 6), a greater or lesser number of pressure passages can be employed. The collection of valve clusters can incorporate one or multiple instances of one or more types of valve cluster(s). Each valve-gated pressure passage has a dedicated on/off gate valve (indexed with a corresponding valve number) that can be opened or closed so as to selectively introducing gas pressure, venting, vacuum, etc. into the system at selected locations and at selected times so as to obtain the type of fluid transport desired.

Depending on the type of valve cluster, the intervening valve-cluster arrangements can perform at least some or all of several types of functions and/or serve to represent functional entities:
The intervening valve-cluster arrangements can be or can represent intervening taps on a microfluidic bus;
The intervening valve-cluster arrangements can serve as transfer points for applying gas pressure for propelling a fluid through valves and conduits. Since gas compresses, long transmission paths require increasing amounts of gas pumping and can slow down the rate of transfer;
The intervening valve-cluster arrangements can also be used to introduce clearing gases, cleaning solvent, and drying gases useful for reusable, reconfigurable, and/or decontamination of recyclable or safe-disposal microfluidic devices;
As will be shown, the intervening valve-cluster arrangements can be used to return unused materials abandoned in conduits and valve passages along a transmission path back to their source;
As will be shown, the intervening valve-cluster arrangements can be used to create small-volume bursts of fluid.

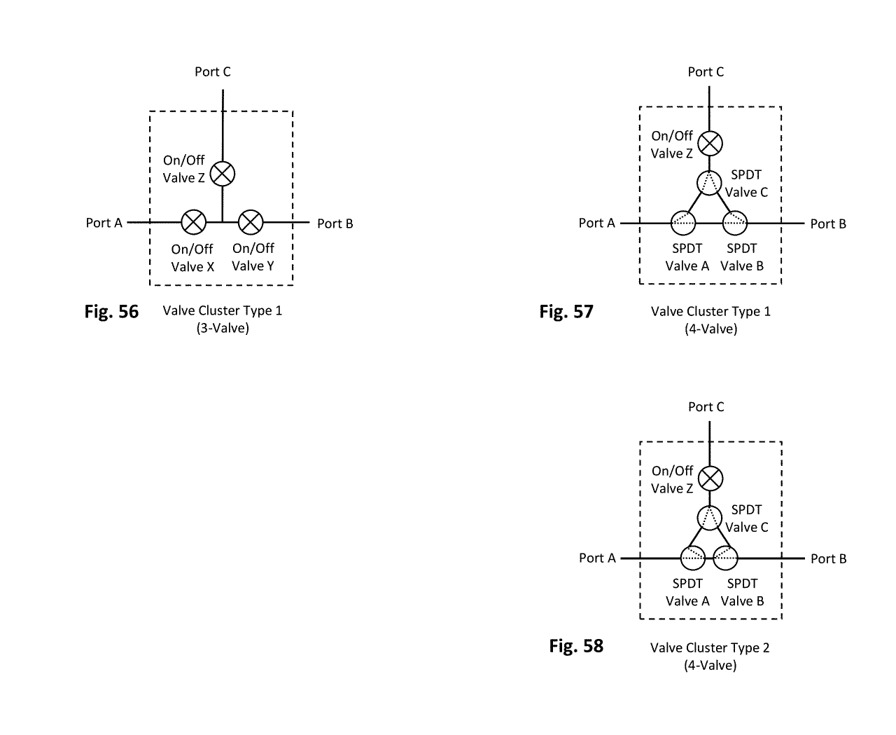

FIGS. 56-58 depict three example 3-valve valve clusters (two including gating valves) for introducing gas pressure, venting, vacuum, etc. into the system at selected locations and at selected times so as to obtain the type of fluid transport desired.

The example arrangements shown in FIGS. 57 and 58 both depict three SPDT valves and a SPST (on/off) gate valve connected on one side to T-junction Port C and on the other side to the COM port of one of the SPDT valves. The remaining two SPDT valves are connected together by one port, and additionally connected to a dedicated port of the first SPDT valve, and to external ports (T-junction Port A for one of the remaining two SPDT valves and T-junction Port B for the other of the remaining two SPDT valves). Specifically, the COM port of one of the remaining two SPDT valves connects to T-junction Port A and the COM port of the other of the remaining two SPDT valves connects to T-junction Port B. In one example mode of operation, T-junction Port A connects directly to T-junction Port B—this can be used for example to support a standard flow path through a fluidic system. In a second example mode of operation, T-junction Port C can be used to introduce or receive a flow of clearing gas, cleaning solvent, drying gas, and/or other materials by permitting flows between T-junction Port C and T-junction Port A. In a third example mode of operation, T-junction Port C can be used to introduce or receive a flow of clearing gas, cleaning solvent, drying gas, and/or other materials by permitting flows between T-junction Port C and T-junction Port B. In a fourth example mode of operation, flows among T-junction Ports A, B, and C are blocked.

In overview:
The example valve-chaperoned “T”-topology arrangement shown in FIG. 56 depicts three SPST (on/off) gate valves connected on one side to an associated T-junction port (T-junction Port A, T-junction Port, B, and T-junction Port C respectively) and on the other side to a flow T-junction. This is used as an example junction structure in many of the microfluidic bus implementations described in U.S. Pat. Nos. 8,032,258, 8,606,414, and 8,812,163, for example those reproduced in the present patent application as FIGS. 3c and 3d.
The example “triangle”-topology valve-cluster arrangement shown in FIG. 57 comprises having T-junction Port A connected to the COM port of its associated SPDT valve and having T-junction Port B connected to the COM port of its associated SPDT valve.
The example “triangle”-topology valve-cluster arrangement shown in FIG. 58 depicts a variation on example arrangement shown in FIG. 7 comprising having the COM port of the SPDT valve associated with T-junction Port A connected to the COM port of the SPDT valve associated with T-junction Port B; effectively the orientation of the “common” port of two of the SPDT valves are flipped from that of FIG. 57.

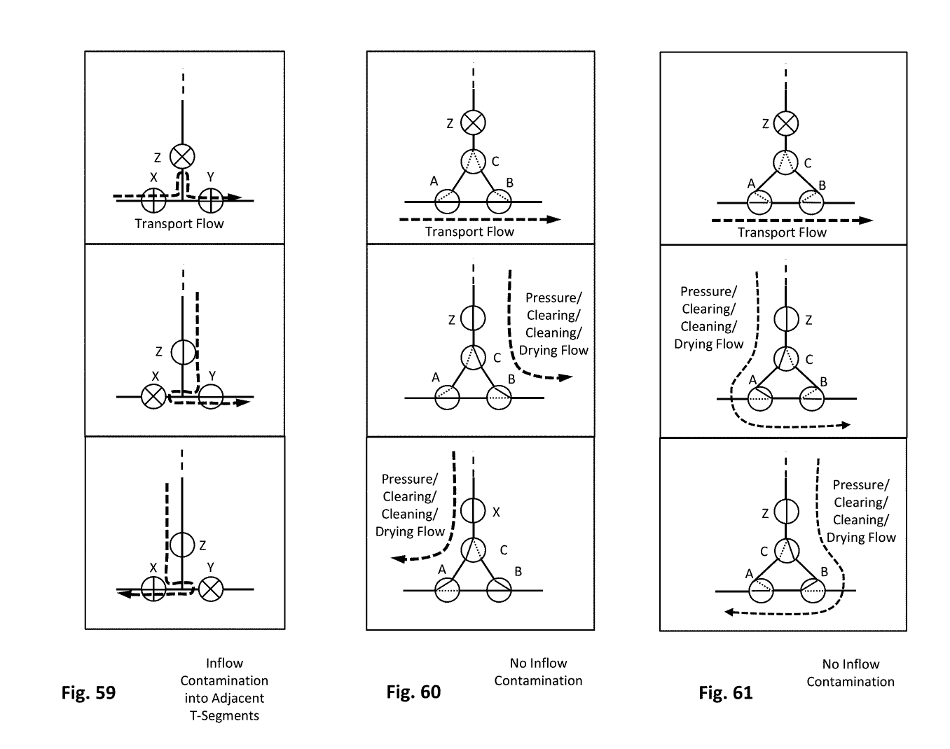

FIGS. 59-61 illustrate example transport flow, clearing/cleaning flow, and residue/contamination scenarios respectively associated with the example arrangements shown in FIGS. 56, 57, and 58.

The example arrangement shown in FIG. 59 illustrates an example transport flow (top drawing), an example clearing/cleaning flow among Port C and Port B (middle drawing), and an example clearing/cleaning flow among Port C and Port A (bottom drawing) for the example arrangement of FIG. 6. Note that the flow T-juncture inherently retains residual flows in each of the transport flow (top drawing), an example clearing/cleaning flow among Port C and Port B (middle drawing), and an example clearing/cleaning/drying flow among Port C and Port A (bottom drawing).

The example arrangement shown in FIG. 60 illustrates an example transport flow (top drawing), an example clearing/cleaning gas or solvent flow between Port C and Port B (middle drawing), and an example clearing/cleaning gas or solvent flow between Port C and Port A (bottom drawing) for the example arrangement of FIG. 57. Note that any material left in the interconnection passage between Port A and Port B from an earlier transport flow cannot be cleared, cleaned, and dried.

The example arrangement shown in FIG. 61 illustrates an example transport flow (top drawing), an example clearing/cleaning gas or solvent flow between Port C and Port B (middle drawing), and an example clearing/cleaning gas or solvent flow between Port C and Port A (bottom drawing) for the example arrangement of FIG. 58. Here that any material left in the interconnection passage between Port A and Port B from an earlier transport flow is inherently cleared, cleaned, and dried.

Accordingly, the example “triangle”-topology valve-cluster arrangement shown in FIG. 58 is advantageous over the example arrangements shown in FIGS. 56 and 57 with respect to both preventing contamination as well as clearing, cleaning, and drying.

### 5.1 Example Valve-Chaperoned “T”-Topology Implementations and Operations

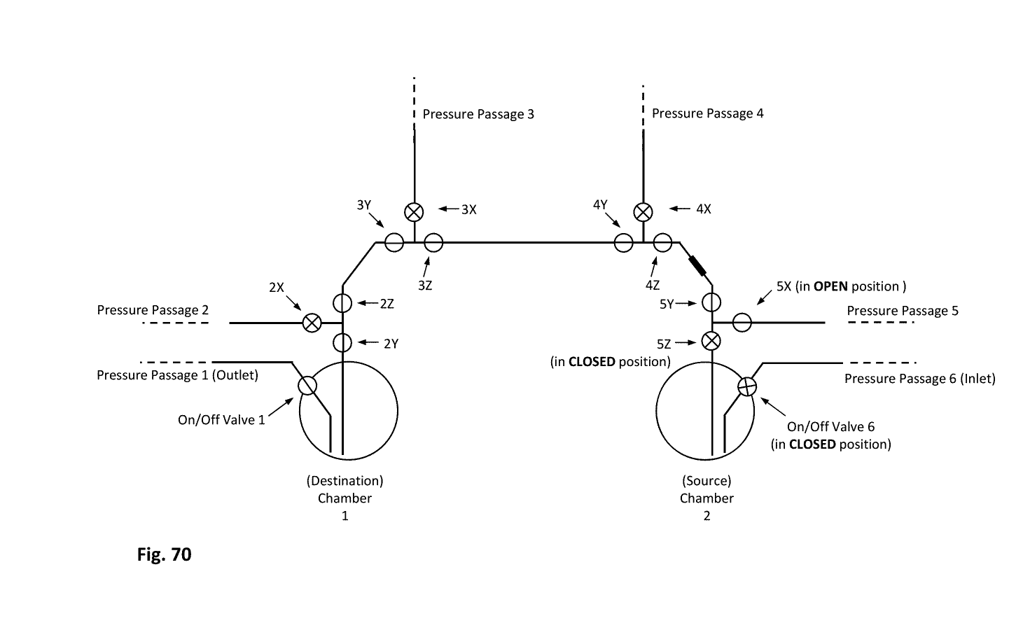

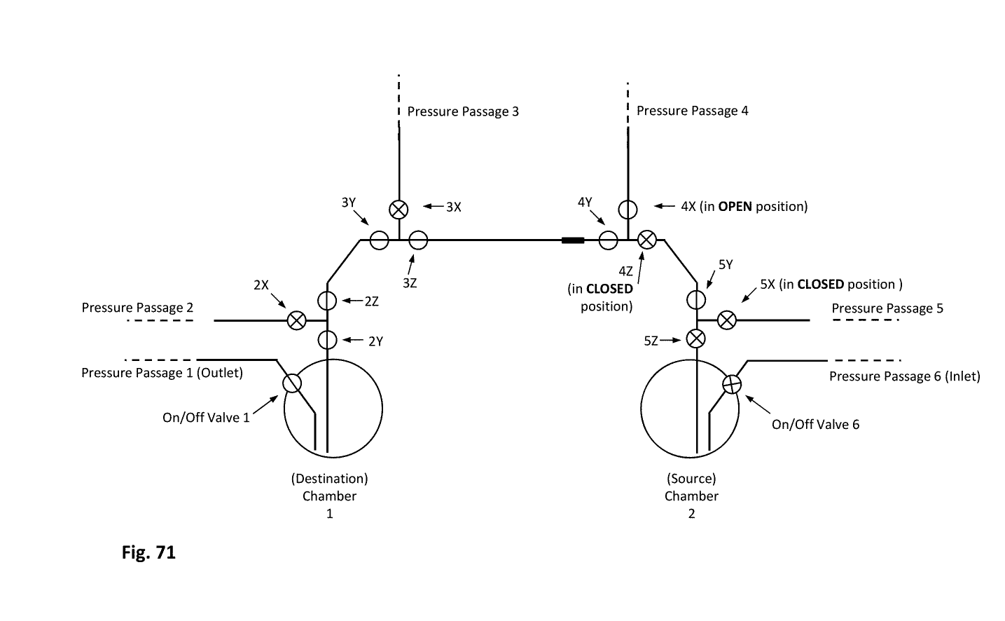

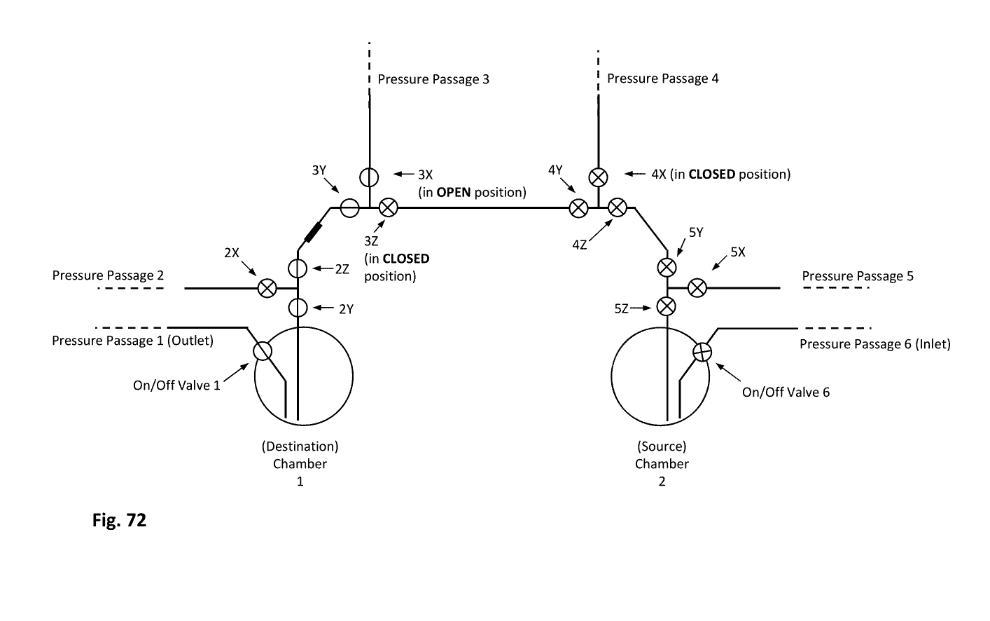

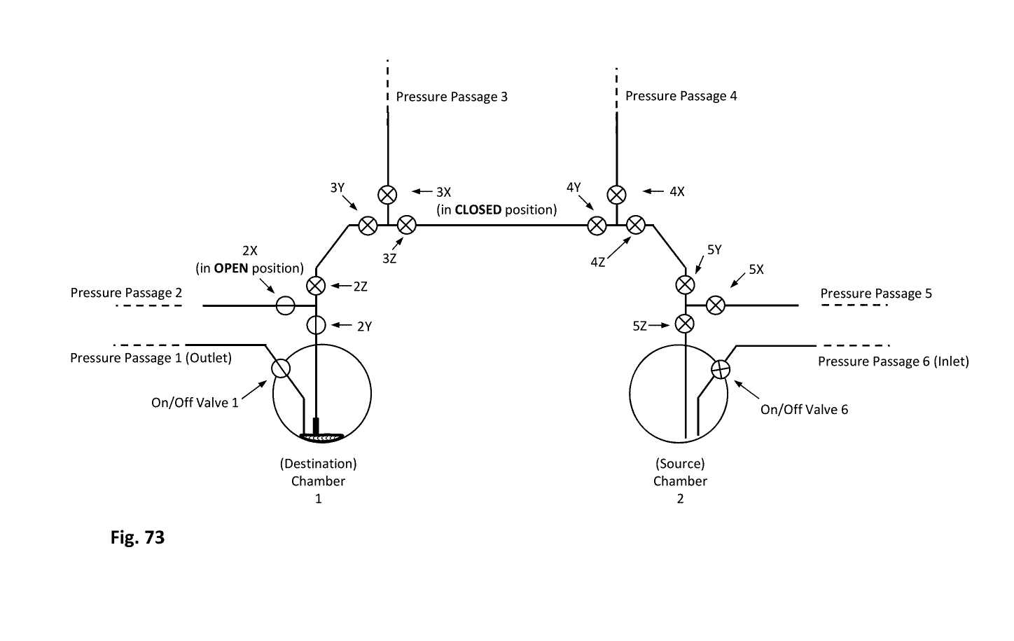

FIGS. 62-73 depict example structures and operations of an example valve-chaperoned “T”-topology implementation, incorporating multiple instances of the valve cluster depicted in FIG. 56 into the configuration depicted in FIG. 55.

FIG. 62 depicts a simplified example system comprising two chambers, each comprising a dedicated valve-gated pressure passage and a fluid transport port, and further incorporating multiple instances of the valve cluster depicted in FIG. 56 into the configuration depicted in FIG. 55. FIG. 62 further depicts an example initial situation where a fluid present in Chamber 1. In this example Chamber 1 can be regarded as the fluid source.

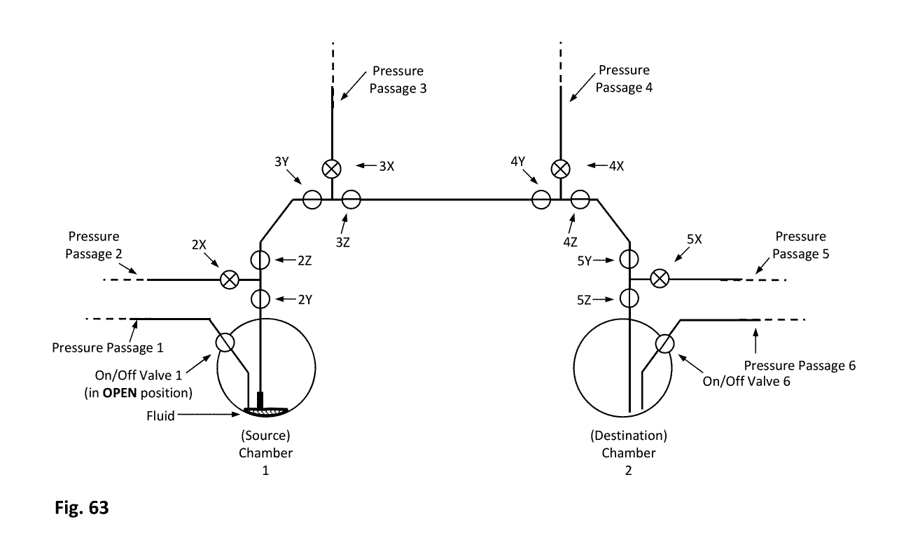

FIG. 63 depicts an example situation where gas pressure provided by pressure passage 1 going through the gas-pressure gating valve 1 powered now into an open position, resulting in pushing a fluid front into the outgoing conduit. Valves 2Y, 2Z, 3Y, 3Z, 4Y, 4Z, 5Z, and pressure passage 6 valves are open to vent the displaced gas ahead of the fluid front out of Chamber 2 through pressure passage 6.

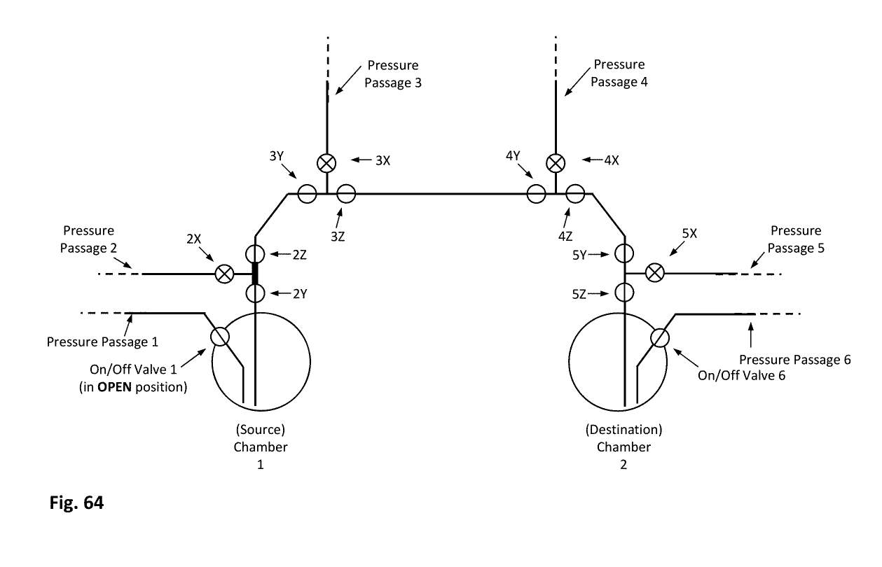

FIG. 64 depicts an example situation where gas pressure provided by pressure passage 1 further pushing a fluid front into valve cluster 2 (comprising valves 2X, 2Y, 2Z), wherein flow valves 2Y and 2Z are open and gas-pressure gating valve 2X remains closed as it was in FIGS. 12 and 13. Valves 3Y, 3Z, 4Y, 4Z, 5Z, and pressure passage 6 valves are open to vent the displaced gas ahead of the fluid front out of Chamber 2 through pressure passage 6.

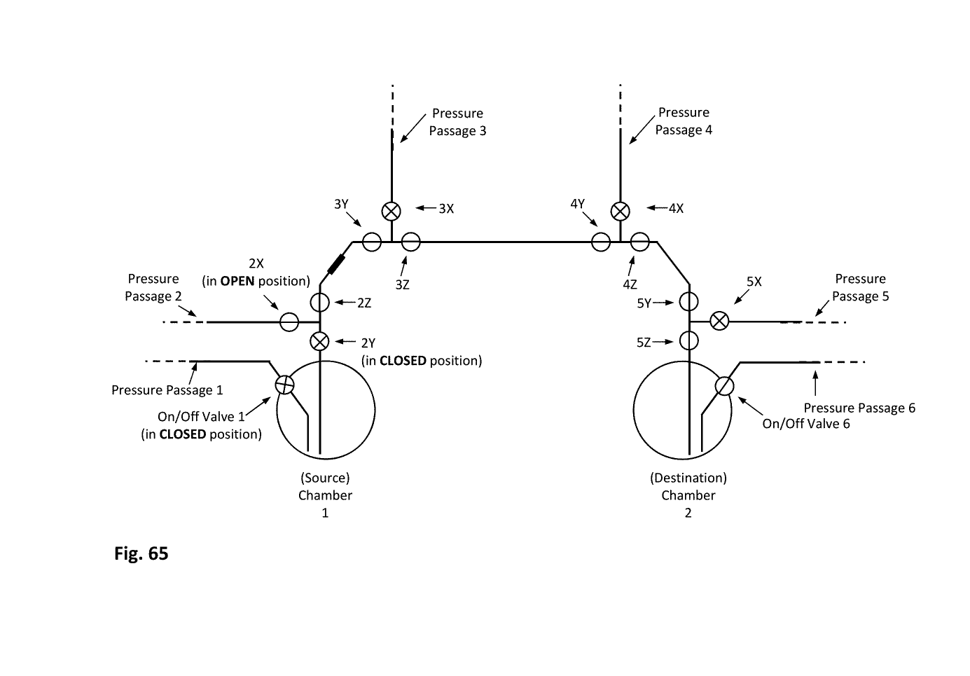

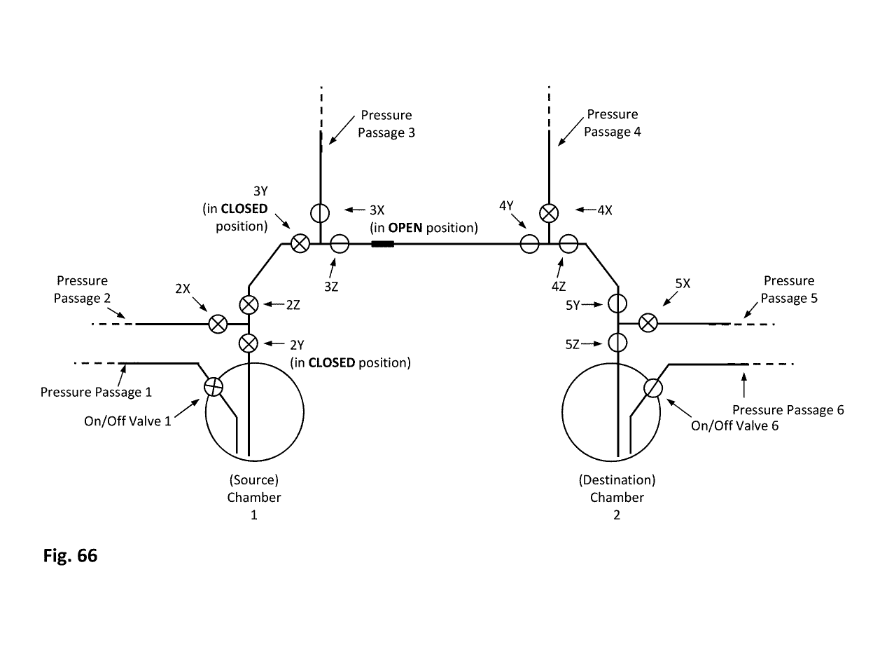

FIG. 65 depicts an example situation where the pressure passage valve 1 closed and pressure passage valve 2X open, letting the pressure passage 2 open, further pushing a fluid front past valve cluster 2 approaching valve 3Y. Valves 3Y, 3Z, 4Y, 4Z, 5Z, and pressure passage 6 valves are open to vent the displaced gas ahead of the fluid front out of Chamber 2 through pressure passage 6.

FIG. 66 depicts an example subsequent situation where gas pressure passage valve 2X and flow valve 3Y are closed and valve 3X is open allowing gas pressure from pressure passage 3 to travel past valve 3Z. Valves 4Y, 4Z, 5Z, and pressure passage 6 valves are open to vent the displaced gas ahead of the fluid front out of Chamber 2 through pressure passage 6.

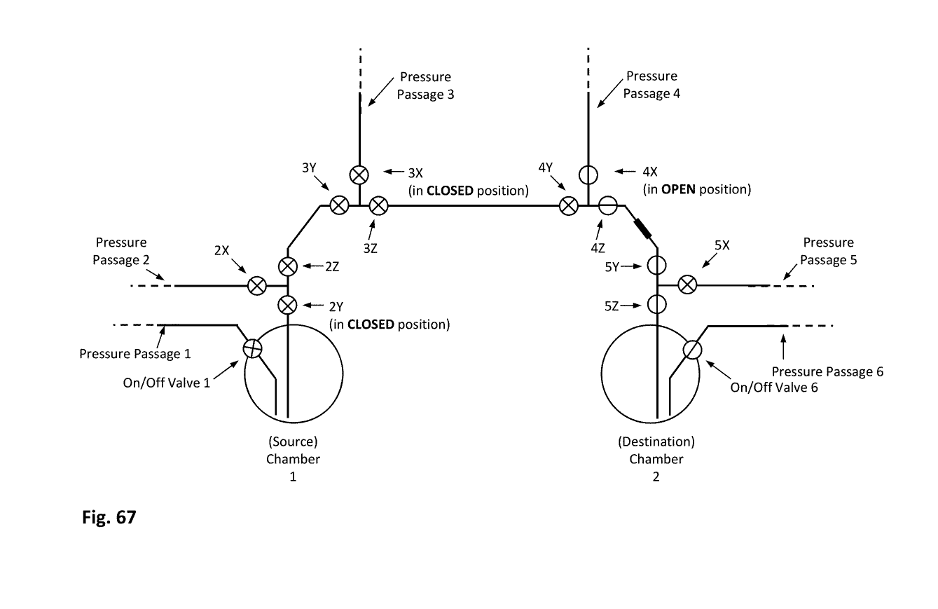

FIG. 67 depicts an example situation where gas pressure passage valve 3X is closed and gas pressure passage valve 4X is open allowing the pressure from gas pressure passage 4 to transport fluid through valve 4Z, pushing the fluid towards valve 5Y. Valves 5Z and pressure passage 6 valves are open to vent the displaced gas ahead of the fluid front out of Chamber 2 through pressure passage 6.

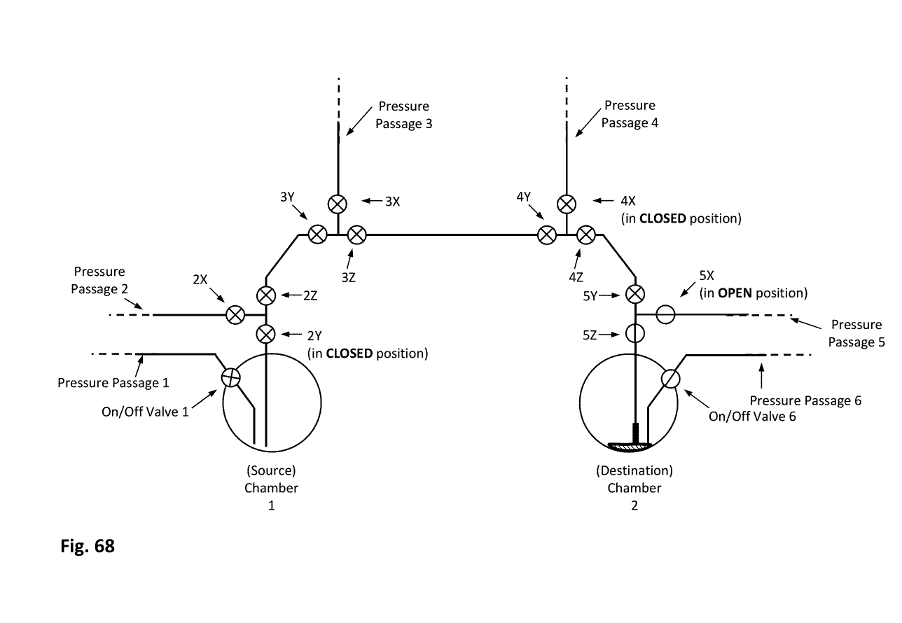

FIG. 68 depicts an example situation where gas pressure passage valve 4X closed and gas pressure passage valve 5X is open allowing the pressure from pressure passage 5 to push the fluid front past valve 5Z into Chamber 2 (the destination).

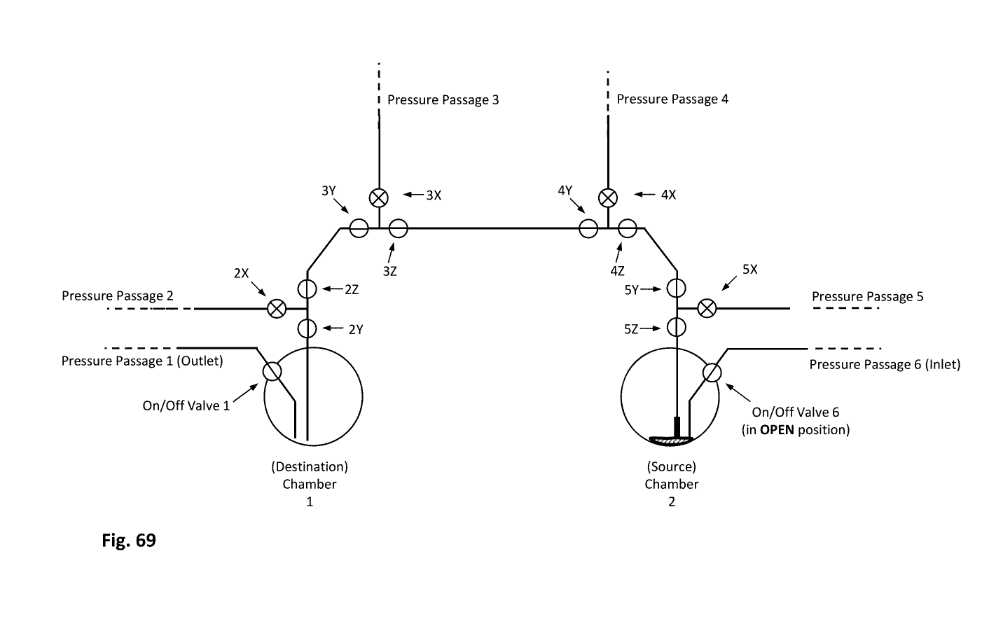

FIGS. 69-73 depict similar example operation steps for the same arrangement that result in a flow travelling in the opposite direction, employing Chamber 2 as the source and Chamber 1 as the destination.

Alternatively, the sequences described above can be modified so that pressure passage 6 provides a vacuum draw at Chamber 2, drawing fluid into Chamber 2 from Chamber 1 through the transport line with pressure passages 1 through 5 sequentially providing incoming-pressure venting.

Alternatively, the sequences described above can be modified so that is applied as presented in the example and additionally pressure passage 6 provides a vacuum draw at Chamber 2, drawing fluid into Chamber 2 from Chamber 1 through the transport line with pressure passages 1 through 5 sequentially providing incoming-pressure.

### 5.2 Example Triangular-Topology Valve-Cluster Implementations and Operations

As mentioned, the triangle-topology valve-cluster provides better contamination performance and better facilitates various types of clearing, cleaning, and drying capabilities that simple passive “T”-topology junctions or valve-chaperoned “T”-topology junctions.

In this section example operation and features are presented for the example valve-chaperoned “T”-topology implementation, incorporating multiple instances of the valve cluster depicted in FIG. 8 into the configuration depicted in FIG. 5.

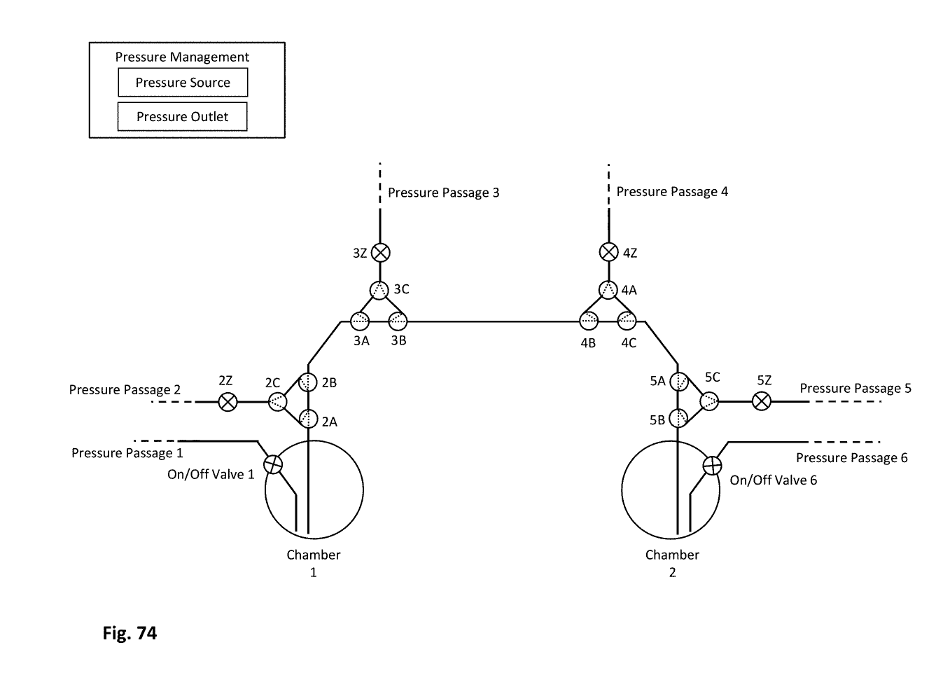

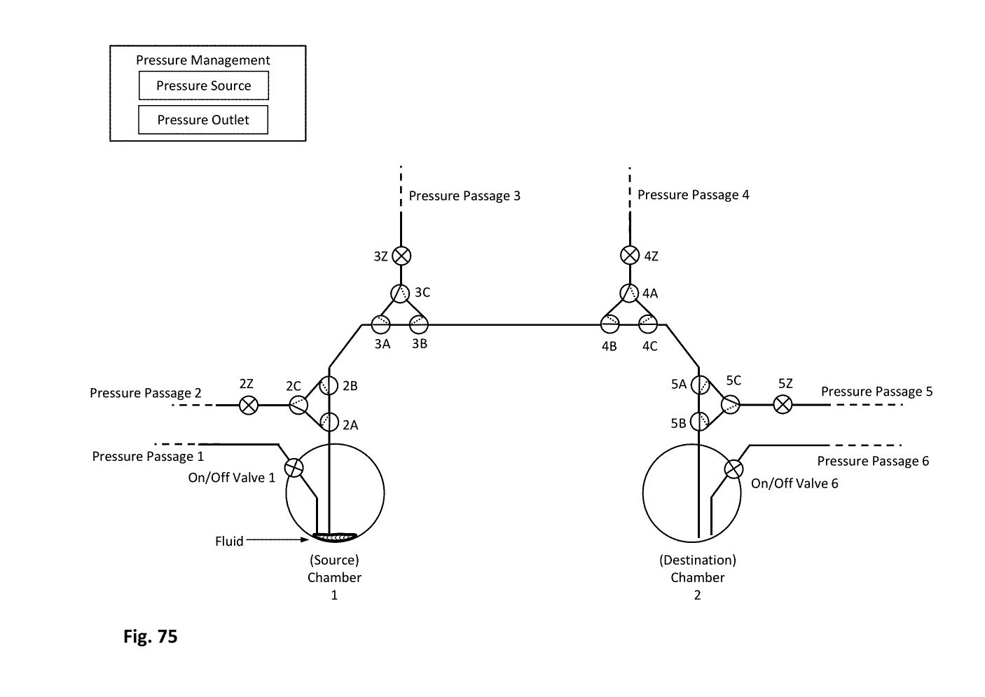

FIG. 74 depicts a simplified example system comprising two chambers, each comprising a dedicated valve-gated pressure passage and a fluid transport port, and further incorporating multiple instances of the valve cluster depicted in FIG. 8 into the configuration depicted in FIG. 55. The fluid transport ports of the two chambers are joined by an interconnecting transport line punctuated with the valve cluster arrangement depicted in FIG. 8 for routing fluids and introducing gas pressure, venting, vacuum, etc. Although the example arrangement depicted in FIG. 74 comprises a total of 6 pressure passages (numbered 1 to 6), a greater or fewer number can be used. Each pressure passage has a dedicated on/off gate valve (indexed with a corresponding valve number) that can be opened or closed so as to selectively introducing gas pressure, venting, vacuum, etc. into the system at selected locations and at selected times so as to obtain the type of fluid transport desired. Pressure passages 2 to 5 attach through gating gas pressure providing valves (2Z, 3Z, 4Z, 5Z) within four different triangle-topology valve-clusters comprising three SPDT valves. One triangle valve cluster comprises the set of SPDT valves {2A,2B,2C}, another triangle valve cluster comprises the set of SPDT valves {3A,3B,3C}, another triangle valve cluster comprises the set of SPDT valves {4A,4B,4C}, and the final depicted triangle valve cluster comprises the set of SPDT valves {5A,5B,5C}. In the figure. the three valves in the valve cluster are drawn in an arrangement which, at the proper time, permit a propelling gas pressure to flow through each depicted triangle-topology in a counterclockwise manner as the fluid front is moved from Chamber 1 to Chamber 2. Although other venting arrangements are possible, in this example pressure passage 6 valve is open so as to vent the displaced gas ahead of the fluid front out of Chamber 2 through pressure passage 6.

FIG. 75 depicts an example initial situation where a volume of fluid present is in Chamber 1. In this example, Chamber 1 can be regarded as the fluid source. In the example initial situation, all the valves connecting the outside pressure exchanges (gas sources, or as later described venting and/or vacuum) to pressure passage 1 through 6 are closed. As an example, additional preparatory step illustrated in this example, the valves (2C, 3C, 4C, 5C) to be involved in anticipated future steps of propelling of the fluid by gas pressure applied by its associated valve cluster are put in the proper valve-state to do so. As an additional example preparatory step illustrated in this example, valves within the triangle valve clusters that are to be involved in the anticipated fluid transport (2A, 2B, 3A, 3B, 4A, 4B, 5A, and 5B) are put into valve-states that provide a direct path between Chamber 1 and Chamber 2. Although other venting arrangements are possible, in this example pressure passage 6 valve is open so as to vent the displaced gas ahead of the fluid front out of Chamber 2 through pressure passage 6.

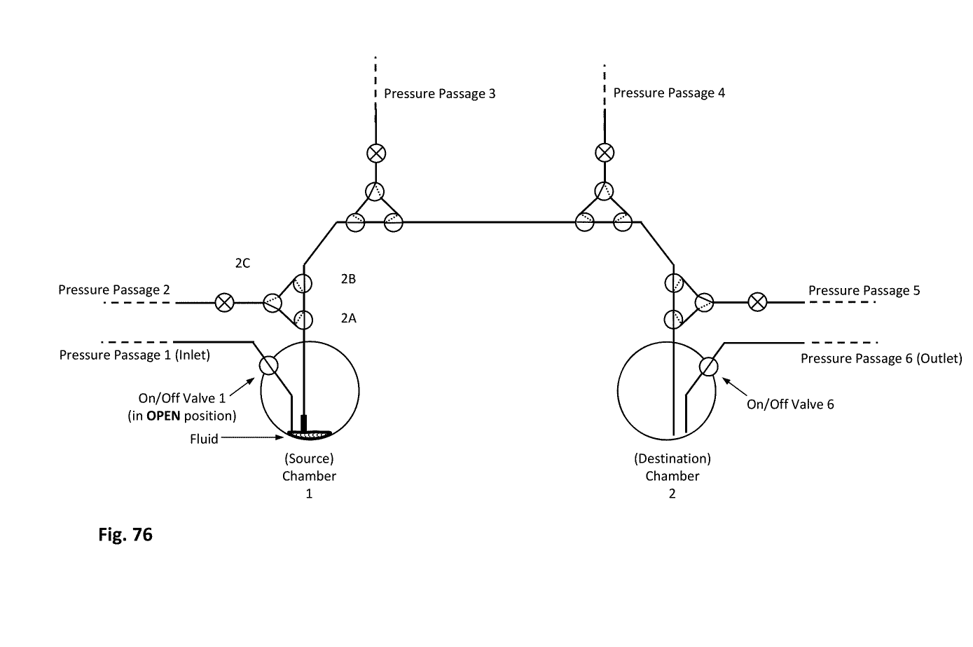

FIG. 76 depicts gas pressure provided by pressure passage 1 going through the gas-pressure gating valve 1 powered now into an open position. The pressure coming from passage 1 pushes the fluid through the depicted conduit on a path to exit from Chamber 1. Although other venting arrangements are possible (for example, using one or more of pressure passages in the triangle valve clusters), in this example (as described above) valves within the triangle valve clusters are pre-staged to create a transport passage from Chamber 1 to Chamber 2, and so leveraging this the gas-pressure gating valve 6 is opened so that pressure passage 6 attaching to Chamber 2 permits outgoing-pressure venting for gas in the system ahead of the fluid front that is pushed into Chamber 2 as the fluid moves through the transport passage.

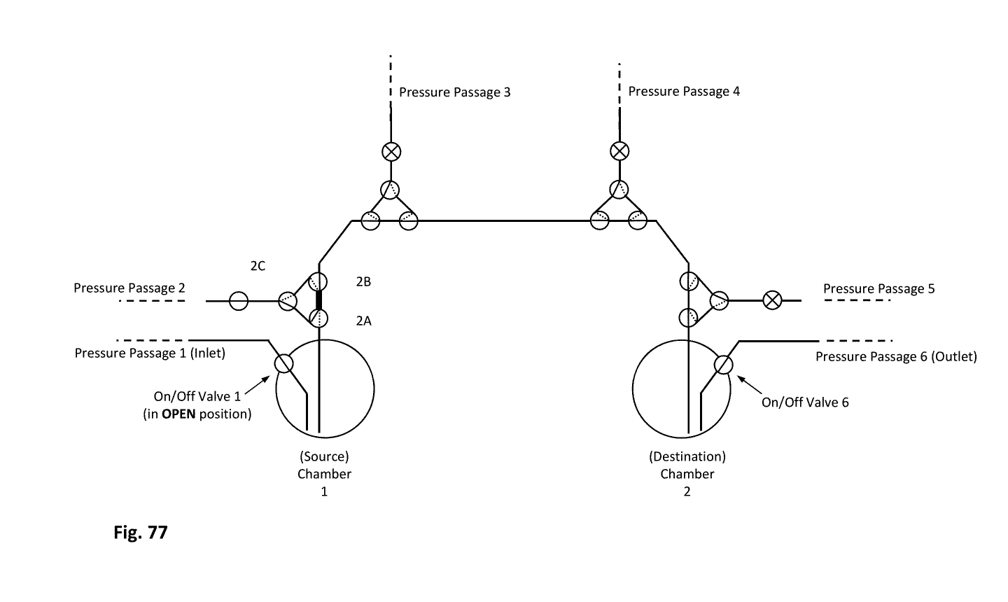

FIG. 77 depicts the pressure passage valve 1 closed and pressure passage valve 2 open so as to introduce gas pressure from gas pressure passage 2 enter the first-encountered triangle valve cluster through valve 2C. As depicted, this requires valve 2A to change valve state from the state it depicted in FIG. 26 so as to provide pressure from pressure passage 2 that is available through valve 2C. The gas pressure from pressure passage 2 is provide through valves 2C and into valve 2C pushes the fluid tail from 2A into and through valve 2B pushing, the fluid further on its way to Chamber 2 through the transport passage through valves 3A, 3B, 4A, 4B, 5A, and 5B. Additionally, in this example, the gating pressure passage valve for pressure passage 1 has been closed. Further, although other venting arrangements are possible, in this example pressure passage 6 valve is open so as to vent the displaced gas ahead of the fluid front out of Chamber 2 through pressure passage 6.

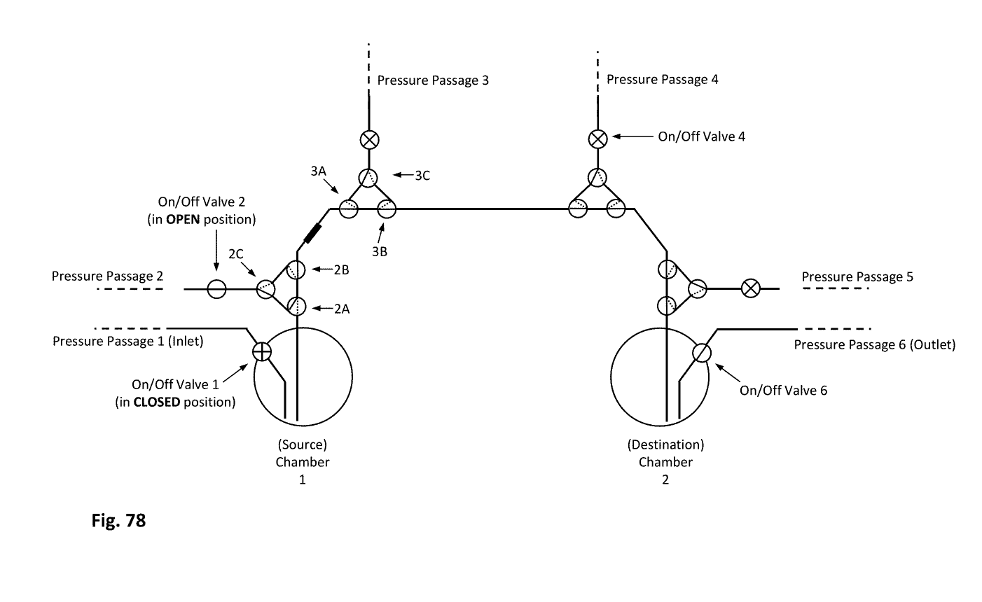

FIG. 78 depicts the fluid front traveling beyond valve 2B and approaching valve 3A, now propelled with gas pressure provided from pressure passage 2 rather than pressure passage 1. Although other venting arrangements are possible, in this example pressure passage 6 valve is open so as to vent the displaced gas ahead of the fluid front out of Chamber 2 through pressure passage 6.

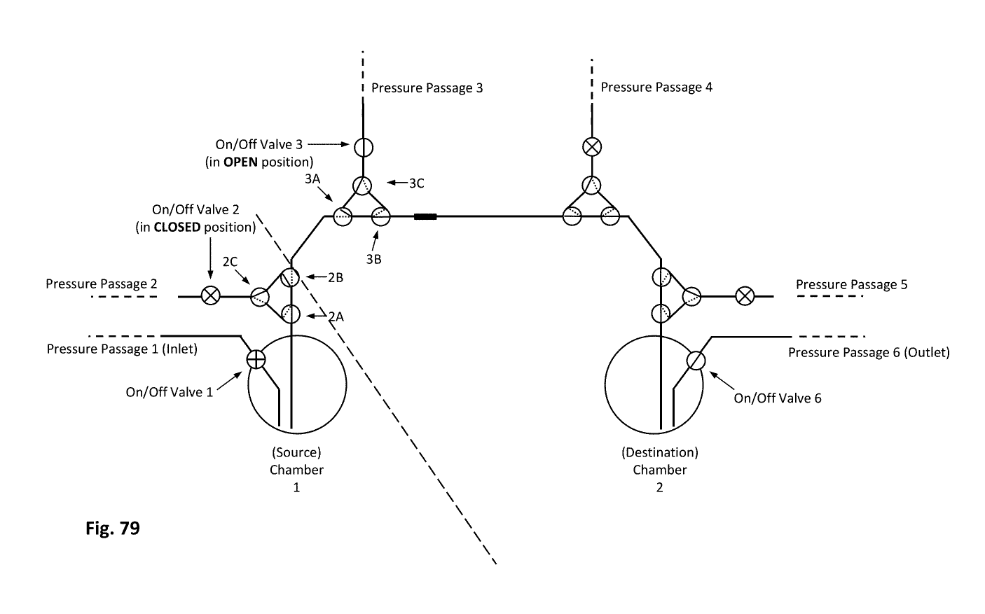

FIG. 79 depicts a subsequent step where the first-encountered triangle valve cluster (comprising valves 2A, 2B, and 2C) no longer provides gas pressure from pressure passage 2 to transport the fluid towards Chamber 2, and instead the next-encountered triangle valve cluster (comprising valves 3A, 3B, and 3C) provides gas pressure from pressure passage 3 to transport the fluid towards Chamber 2. As depicted, this requires valve 3A to change valve state from the state it depicted in FIG. 28 so as to provide pressure from pressure passage 3 that is available through valve 3C. Although other venting arrangements are possible, in this example pressure passage 6 valve is open so as to vent the displaced gas ahead of the fluid front out of Chamber 2 through pressure passage 6.

Further as to FIG. 79, the status of operation of arrangement of FIG. 74 can now be regarded as being functionally portioned as suggested by the long dashed dividing line tangent to valve 2B. At this point in the transport process, affairs to right and above the long dashed dividing line are still involved with the transport of the fluid towards Chamber 2, while affairs to left and below the long dashed dividing line are no longer involved with the transport of the fluid towards Chamber 2. As far as the transport task is concerned, the state of the valves can remain or be assigned any valve state. One example possible choice would be to power off all the valves so as to conserve electrical power. Another example possible choice would be to leave each valve in the state it was last changed to—this will be illustrated as port of the reverse-direction flow to be considered shortly. Yet another possible choice would be to actively start some sort of beneficial process, for example returning any unused fluid back into Chamber 1, or to invoke a clearing/cleaning/drying sequence. For sake of illustration, the state of valves 2A, 2B, and 2C will be set in an example configuration to returning any unused fluid between valve 2B and Chamber 1 back into Chamber 1. (It is noted that a clearing/cleaning/drying sequence where potentially contaminated unused fluid between valve 2B and Chamber 1 is removed from the system, additional valve arrangements can or must be advantageously added.)

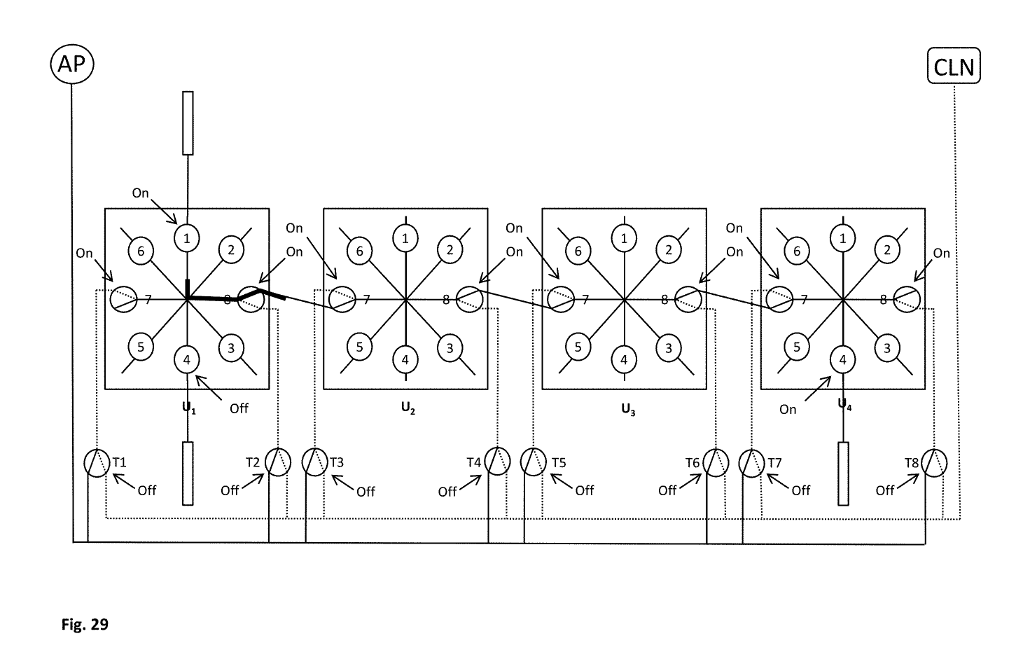

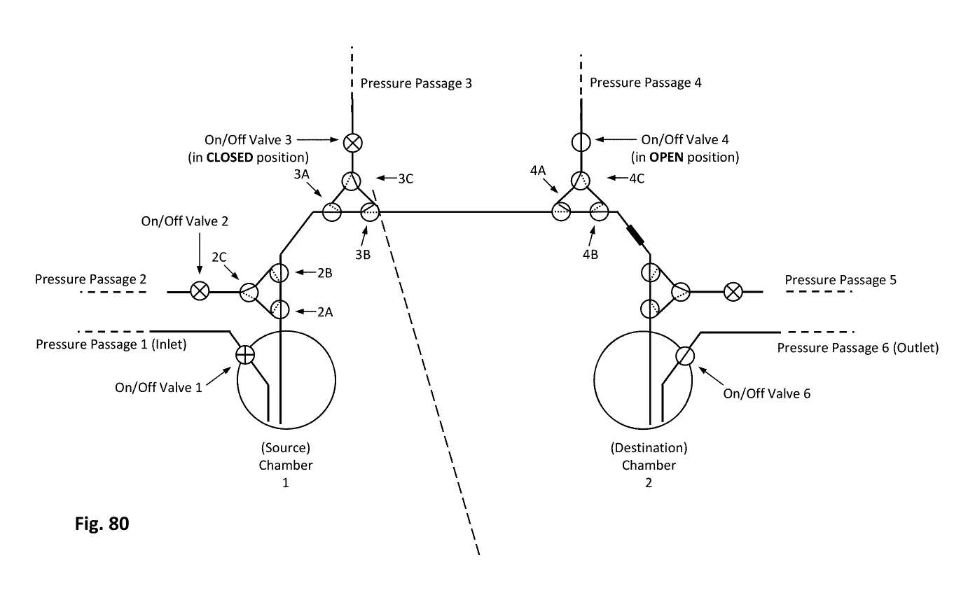

FIG. 80 depicts a subsequent step where the previously-encountered triangle valve cluster (comprising valves 3A, 3B, and 3C) no longer provides gas pressure from pressure passage 3 to transport the fluid towards Chamber 2, and instead the next-encountered triangle valve cluster (comprising valves 4A, 4B, and 4C) provides gas pressure from pressure passage 4 to transport the fluid towards Chamber 2. As depicted, this requires valve 4A to change valve state from the state it depicted in FIG. 29 so as to provide pressure from pressure passage 4 that is available through valve 4C. Although other venting arrangements are possible, in this example pressure passage 6 valve is open so as to vent the displaced gas ahead of the fluid front out of Chamber 2 through pressure passage 6.

Further as to FIG. 80, the status of operation of arrangement of FIG. 74 can now be regarded as being functionally portioned as suggested by the rotated long dashed dividing line tangent to valve 3B. At this point in the transport process, affairs to right and above the long dashed dividing line are still involved with the transport of the fluid towards Chamber 2, while affairs to left and below the long dashed dividing line are no longer involved with the transport of the fluid towards Chamber 2. As before, as far as the transport task is concerned the state of the valves can remain or be assigned any valve state. The choices can again include (1) power off all the valves so as to conserve electrical power, (2) leave each valve in the state it was last changed to (as will be considered shortly), and (3) actively start some sort of beneficial process, for example returning any unused fluid back into Chamber 1, or to invoke a clearing/cleaning/drying sequence. For sake of illustration, the state of valves 2A, 2B, 2C, 3A, 3B, and 3C will be set in an example configuration to returning any unused fluid between valve 3B and Chamber 1 back into Chamber 1. (As before it is noted that a clearing/cleaning/drying sequence where potentially contaminated unused fluid between valve 3B and Chamber 1 is removed from the system, additional valve arrangements can or must be advantageously added.)

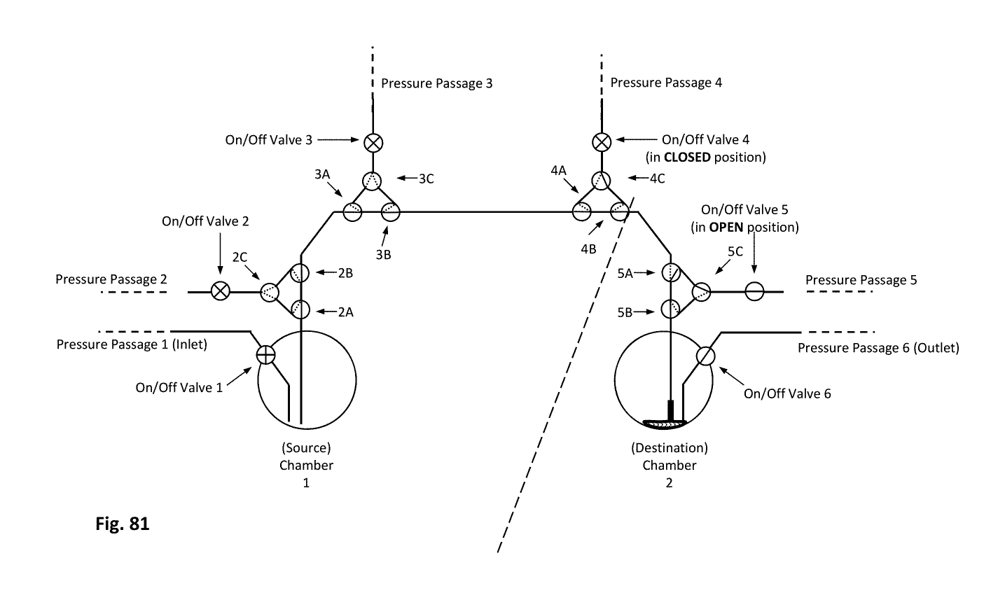

FIG. 81 depicts a subsequent step where the previously-encountered triangle valve cluster (comprising valves 4A, 4B, and 4C) no longer provides gas pressure from pressure passage 4 to transport the fluid towards Chamber 2, and instead the next-encountered triangle valve cluster (comprising valves 5A, 5B, and 5C) provides gas pressure from pressure passage 5 to transport the fluid towards Chamber 2. As depicted, this requires valve 5A to change valve state from the state it depicted in FIG. 79 so as to provide pressure from pressure passage 5 that is available through valve 5C. Although other venting arrangements are possible, in this example pressure passage 6 valve is open so as to vent the displaced gas ahead of the fluid front out of Chamber 2 through pressure passage 6.

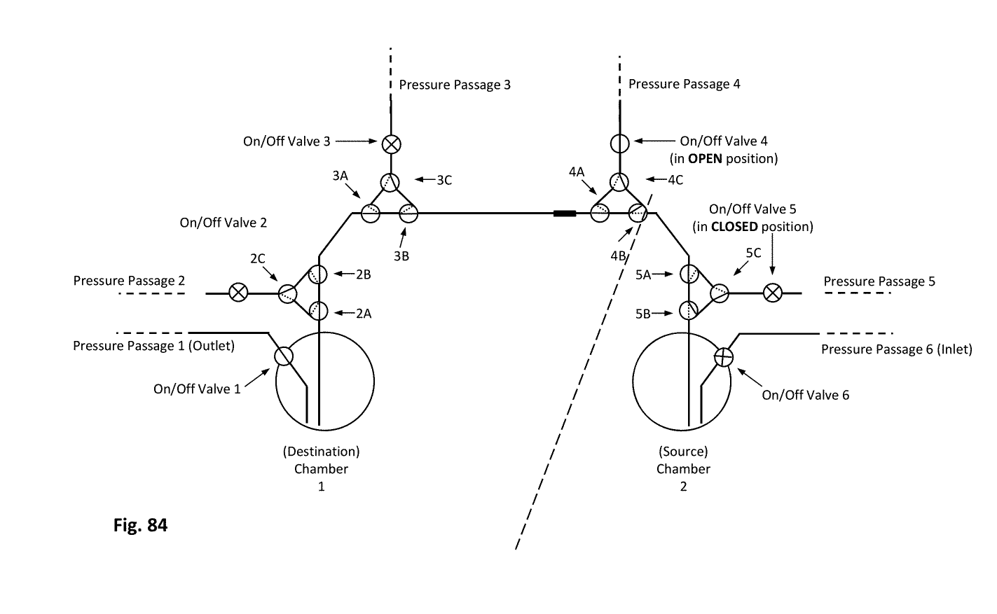

Further as to FIG. 81, the status of operation of arrangement of FIG. 74 can now be regarded as being functionally portioned as suggested by the further-rotated long dashed dividing line tangent to valve 4B. At this point in the transport process, affairs to right and above the long dashed dividing line are still involved with the transport of the fluid towards Chamber 2, while affairs to left and below the long dashed dividing line are no longer involved with the transport of the fluid towards Chamber 2. As before, as far as the transport task is concerned the state of the valves can remain or be assigned any valve state. The choices can again include (1) power off all the valves so as to conserve electrical power, (2) leave each valve in the state it was last changed to (as will be considered shortly), and (3) actively start some sort of beneficial process, for example returning any unused fluid back into Chamber 1, or to invoke a clearing/cleaning/drying sequence. For sake of an alternative illustration, for the examples depicted in FIGS. 84-86 the state of valves 2A, 2B, 2C, 3A, 3B, 3C, 4A, 4B, and 4C will be simply left in the last states that were assigned.

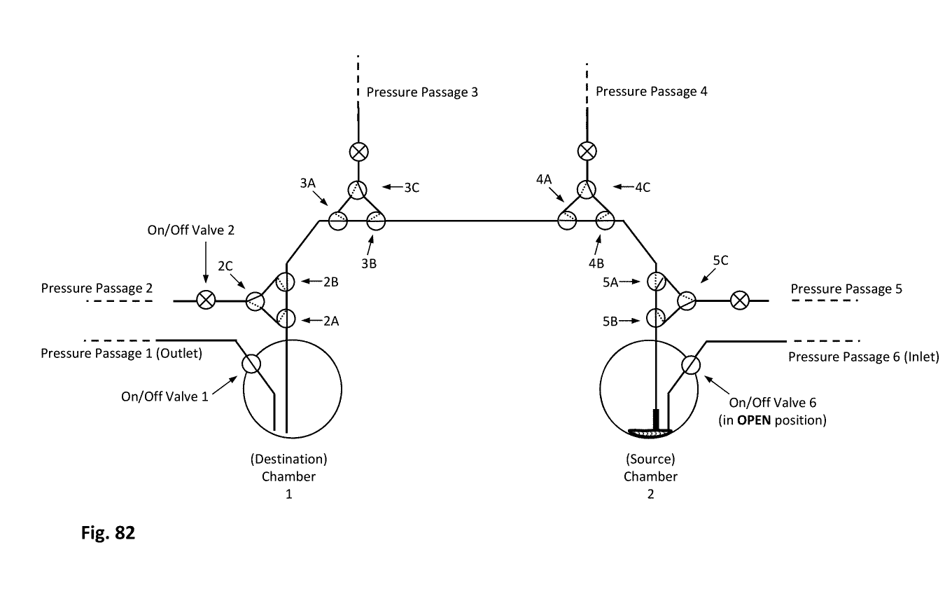

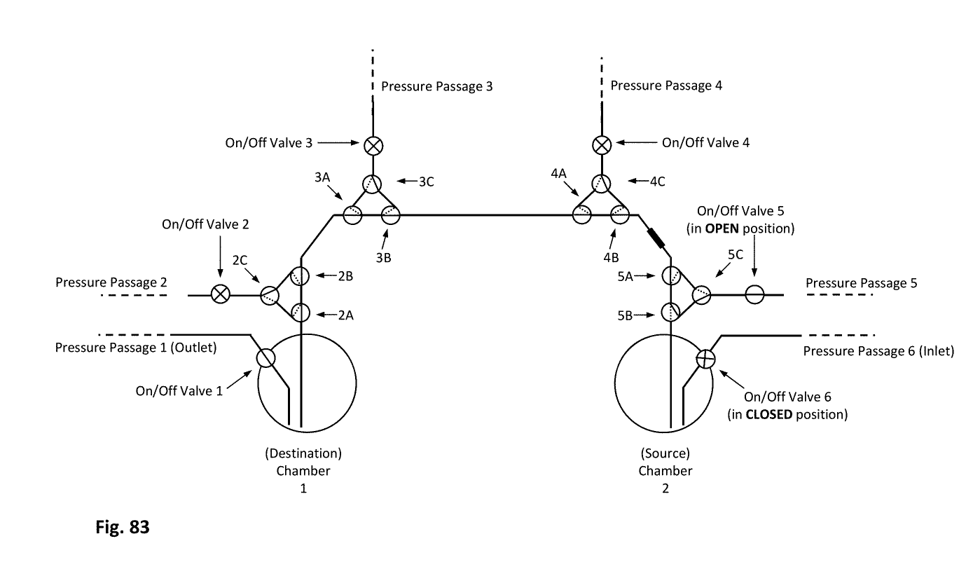

FIGS. 82-86 depict related example operation steps for the same arrangement that result in a flow travelling in the opposite direction, employing Chamber 2 as the source and Chamber 1 as the destination. Although other venting arrangements are possible, in this example pressure passage 1 valve is open so as to vent the displaced gas ahead of the fluid front out of Chamber 1 through pressure passage 1.

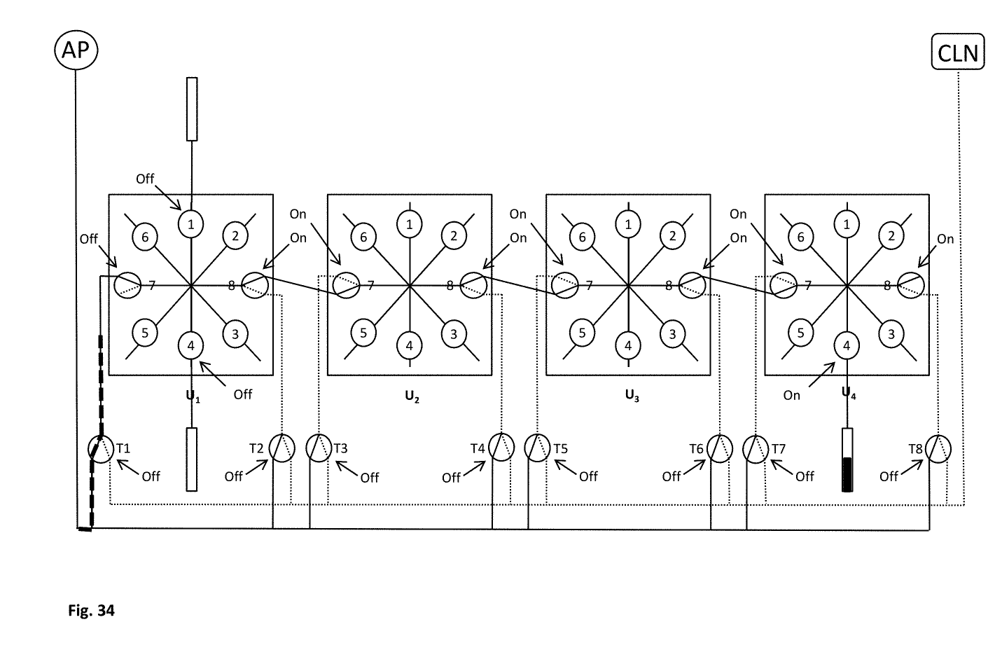

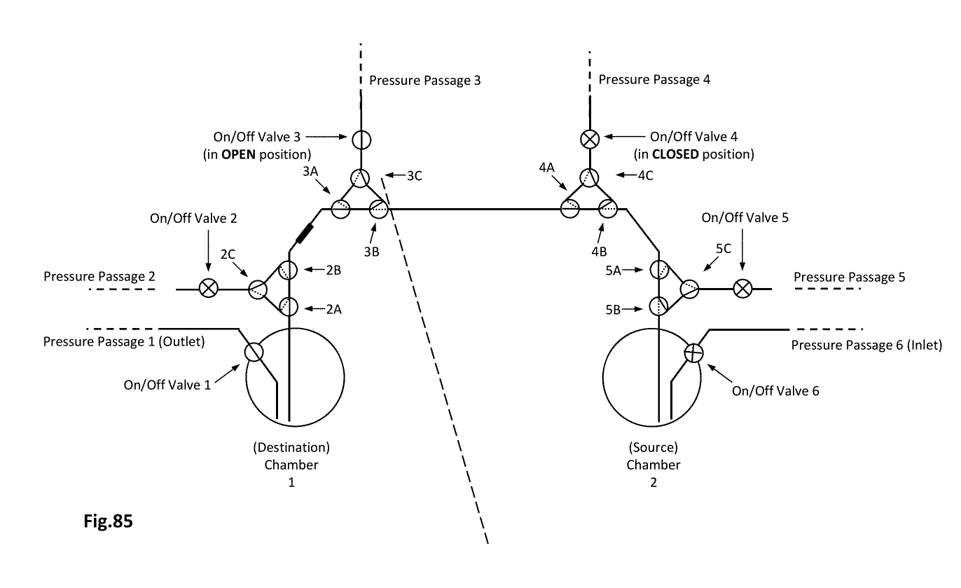

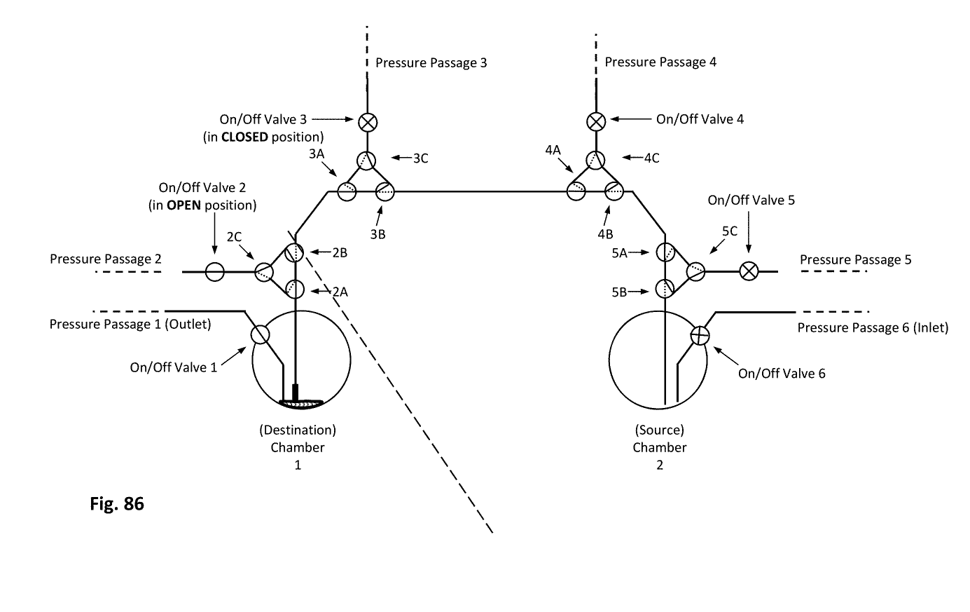

Further as to FIGS. 84-86, the status of operation of arrangement of FIG. 74 can now be regarded as being functionally portioned as suggested by the further-rotated long dashed dividing line tangent to valve 4B in FIG. 34, tangent to valve 3B in FIG. 85, and tangent to valve 2B in FIG. 86. At this point in the transport process, affairs to right and above the long dashed dividing line are still involved with the transport of the fluid towards Chamber 1, while affairs to left and below the long dashed dividing line are no longer involved with the transport of the fluid towards Chamber 1. As before, as far as the transport task is concerned the state of the valves can remain or be assigned any valve state. The choices can again include (1) power off all the valves so as to conserve electrical power, (2) leave each valve in the state it was last changed to (as will be considered shortly), and (3) actively start some sort of beneficial process, for example returning any unused fluid back into Chamber 1, or to invoke a clearing/cleaning/drying sequence.

Alternatively, the sequences described above can be modified so that pressure passage 6 provides a vacuum draw at Chamber 2, drawing fluid into Chamber 2 from Chamber 1 through the transport line with pressure passages 1 through 5 sequentially providing incoming-pressure venting.

Alternatively, the sequences described above can be modified so that is applied as presented in the example and additionally pressure passage 6 provides a vacuum draw at Chamber 2, drawing fluid into Chamber 2 from Chamber 1 through the transport line with pressure passages 1 through 5 sequentially providing incoming-pressure.

### 5.3 Clearing, Cleaning, and Drying Operations Using the Triangular-Topology Valve-Cluster

In addition to the highly-controlled bi-directional transport capabilities illustrated above in part with the examples provided in Section 4.2, as discussed in the introduction to this section (Section 4) the example “triangle”-topology valve-cluster arrangement of FIG. 58 and its operation (shown in the examples of FIG. 11) are advantageous over the example arrangements shown in FIGS. 56 and 57 with respect to preventing contamination as well as bi-directional clearing, cleaning, and drying.

As discussed in the introduction to this section (Section 4), the example valve-state arrangement depicted in the top portion of FIG. 10 for the valve arrangement of FIG. 57 can provide passive bi-directional transport flow and the valve arrangement can prevent inflow contamination. Additionally:
The valve-state arrangement depicted in the middle portion of FIG. 60 shows example clearing/cleaning/drying flow delivered to the conduit to the right of valve B. However, any material left in the interconnection passage between valve A and valve B from an earlier transport flow cannot be cleared, cleaned, and dried.
The valve-state arrangement depicted in the lower portion of FIG. 60 shows example clearing/cleaning/drying flow to the conduit to the left of valve A. However, any material left in the interconnection passage between valve A and valve B from an earlier transport flow cannot be cleared, cleaned, and dried.

The example arrangement shown in FIG. 61 for the improved triangle-topology valve-cluster arrangement depicted in FIG. 8 (where the orientation of the “common” port of two of the SPDT valves are flipped from that of FIG. 10) illustrates an example transport flow (top drawing) can also provide passive bi-directional transport flow, and the valve arrangement can also prevent inflow contamination. Additionally:
The valve-state arrangement depicted in the middle portion of FIG. 61 shows example clearing/cleaning/drying flow between valve A and valve B and the conduit to the right of valve B.
The valve-state arrangement depicted in the lower portion of FIG. 61 shows example clearing/cleaning/drying flow between valve A and valve B and the conduit to the left of valve A.

Thus, any material left in the interconnection passage between valve A and valve B from an earlier transport flow is inherently cleared, cleaned, and dried employing the example triangle-topology valve-cluster arrangement of FIG. 58.

Further, by first passing a fluid flow through a triangle-topology valve-cluster arrangement of FIG. 58 and then blocking the source and subsequently propelling the tail of the fluid flow with gas pressure introduced into the third port of the triangle-topology valve-cluster (adapting the discussion associated with FIGS. 76-78), the example triangle-topology valve-cluster arrangement of FIG. 58 can be used to create small-volume fluid bursts when the fluid source is not limited as in the example of Section 4.2.

Yet further, as discussed in of Section 4.2 with respect to the operation of the portion of the example arrangement to the right and above the long dashed angular dividing line in FIGS. 79-81, the example triangle-topology valve-cluster arrangement of FIG. 8 also can be used to facilitate the return of materials (that had been abandoned mid-transport) in conduits back to its source. In addition to implementing a clean-up function after transport (as depicted and described in conjunction with FIGS. 79-81), this “return of materials” capability complements the creation of small-volume fluid bursts described in the preceding paragraph.

Additionally, the example triangle-topology valve-cluster arrangement of FIG. 58 can perform a number of other nuanced functions of value in complex, specialized, or high-performance microfluidic and more general types of fluidic systems.

### 6. Process-Step and Configuration Representations, Commands, Data Structures and Specification Files

For a reconfigurable system, such as the reconfigurable microfluidics systems describe in New Renaissance Institute U.S. Pat. No. 9,636,655 and pending U.S. patent application Ser. No. 15/499,767, the designated configuration involves setting the states of valves and potentially the states and/or operating parameters of other elements in the system (for example as sensors, reaction chambers, pump directions, etc.). When system configuration and reconfiguration are placed under computer control, each configuration thus is equivalent to a list or list of lists (more generally, a list or array) of state values and/or parameter values.

Since systems such as those discussed in at least U.S. Pat. No. 9,636,655 and pending U.S. patent application Ser. No. 15/499,767 can be configured under software control, the resulting system is regarded as a “software-configurable” system or “software-reconfigurable” system. In more rigorous treatments or semantics, a system that is locked into a specific unchanging configuration for its operational lifetime can be more precisely regarded as a “software-configurable” system, while a system whose configuration is changed at least once during its operational lifetime can be more precisely regarded as a “software-reconfigurable” system. Importantly it is also noted that fixing states of specific valves (for the duration of a process interval) in New Renaissance Institute microfluidic bus U.S. Pat. Nos. 8,032,258, 8,606,414, and 8,812,163 so as to define associated fixed pathways through a microfluidic bus can also be explicitly used to effectively define and invoke a particular system configuration under software control.

Similarly, system operation while in any given configuration can also involve a sequence of setting or changing the states of valves and potentially the states and/or operating parameters of other elements in the system (for example as sensors, reaction chambers, pump directions, etc.). Correspondingly, when system operation is placed under computer control, each actionable process operating step enacted under computer control is thus also equivalent to a list or list of lists (more generally, a list or array) of state values and/or parameter values.

The invention provides for the use of process operating step representations information, for example contained within “process-specification” files, to specify and/or store an actionable process step.

Similarly, the invention provides for the use of configuration representation information, for example contained within “configuration-specification” files, to specify and/or store a representation system configuration.

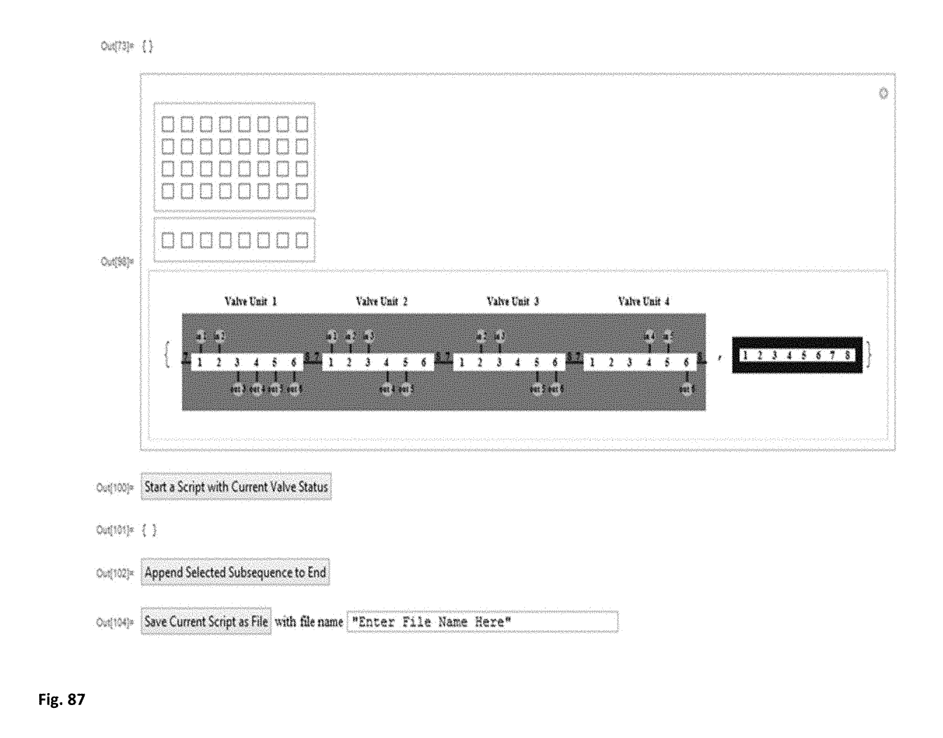

As a second example, the reader is first referred to the control (and as will be discussed later, script-authoring) example “process step” or “configuration” set by an interactive user interface depicted in FIG. 87; in this example:
All valves of Valve Unit 1 are enabled
Valve 6 of Valve Unit 2 is disabled, all other valves of Valve Unit 2 are enabled
Valves 1 and 4 of Valve Unit 3 are disabled, all other valves of Valve Unit 3 are enabled
Valves 1, 2 and 3 of Valve Unit 4 are disabled, all other valves of Valve Unit 4 are enabled.

As an example representation of this second “process step” or “configuration” as an array of (state and/or parameter) values, contained within a specification file for this scenario is the list of lists (or equivalently, the nested array) of: {1,1,1,1,1,1},{1,1,1,1,1,0},{0,1,1,0,1,1},{0,0,0,1,1,1}

where “1” designates an enabled valve and “0” designates a disabled valve.

A third example associated with the selections depicted in FIG. 87 is a specification of input and output. For example, one-way-flow check-valves can be introduced under software control, pump flow can be set under software control, etc. For example, again referring to FIG. 87:
Enabled valves 1 and 2 of Valve Unit 1 are inputs, enabled valves 3, 4, 5, and 6 are outputs
Enabled valves 1, 2, and 3 of Valve Unit 2 are inputs, enabled valves 4 and 5 are outputs
Enabled valves 2 and 3 of Valve Unit 3 are inputs, enabled valves 5 and 6 are outputs
Enabled valves 4 and 5 of Valve Unit 4 are inputs, enabled valve 6 is an output.

As an example representation of this third “process step” or “configuration” as an array of (state and/or parameter) values, contained within a specification file for this scenario is the list of lists (or equivalently, the nested array) of: {1,1,−1,−1,−1,−1},{1,1,1,−1,−1,0},{0,1,1,0,−1,−1},{0,0,0,1,1,−1}

where “1” designates an enabled input valve, “−1” designates an enabled output valve, and “0” designates a disabled valve.

The above are simple examples of “process step” or “configuration” representations, process step or configuration data, and specification file contents, but the invention provides for process step or configuration capabilities of far greater range, complexity, scope, and diversity. For example, elements and/or interconnections among elements in a complex system such as that depicted in FIGS. 2 and 3a-3d can be arranged to be configured and operated under software control using such representational schemes.

It is noted that the list of lists (or equivalently, the nested arrays) considered above could be of the entire system, or of only portions of the entire system. The latter are useful in multithreaded operations, however resource allocation and other provisions can in some situations be necessary; these topics are considered in New Renaissance Institute U.S. Pat. No. 9,636,655 and U.S. patent application Ser. No. 15/499,767.

7. “Macros” via Logic Electronics, Firmware, and/or Software has Higher-Level States and Control Messages

Much or all of the operation of the valve systems discussed in the present patent application involve choreographed and/or feedback-control of groups of a large number of valves and other entities (for example pumps, mixers, electrically controlled photochemical reactors, etc.), and these controlled operations can be implemented through the execution of computational algorithms.

In some implementations it can be useful and most flexible to provide direct controllability of each valve, and to provide each valve with its own unique address.

In some implementations it can be useful (for example faster performance, simplified programing, etc.) to provide “simultaneous-event macro” controllability for operating groups of valves at the same time. In various implementations, such “macro”-based control could be implemented in software, firmware, and/or hard-wired logic.

Note that the list of lists (or equivalently, nested array) considered in Section 5 could in some constructions be considered a “simultaneous-event macro.”

In some implementations it can be useful (for example faster performance, simplified programing, etc.) to provide “sequential-event macro” controllability for operating groups of valves that involve a time-defined sequence. In various implementations, such “macro”-based control could also be implemented in software, firmware, and/or hard-wired logic.

Note that a time-scripted list of the list of lists (or equivalently, nested array) considered in Section 5 could in some constructions be considered a “sequential-event macro.” (Such time-scripted list of Section 5 lists of lists (or equivalently, nested arrays) will be defined in the next section as a type of “script.”)

In implementations involving one or both of “simultaneous-event macro” control or “sequential-event macro” control, it can additionally be useful (for example faster performance, simplified programing, etc.) to provide conditional inputs or parameters for the macros. Such implementations involving “macro” control for operating groups of valves can include provisions for at least one parameter that can affect the behavior of the group operation by a macro.

In various implementations, such “conditional-macro” and/or “parameterized-macro” control could also be implemented in software, firmware, and/or hard-wired logic.

Any of the above can be used individually or in combination. Additional extensions and variations along these lines are anticipated and provided for by the invention.

### 8. Scripts

Regarding at least multi-step microfluidic control software, a descriptor for the outcome of such multi-step control software algorithm (or an individual thread or component co-executing process) can be represented in full non-ambiguous detail in the form of an adequately-specified flow chart (mathematically equivalent to an annotated graph) or an adequately-specified conditional event list or “script.” These will be discussed in this section.

For a given process-step or configuration, valves and other elements can be put into various states (for example off/on, non-energized/energized SPDT valves, pump direction, etc.) and/or put into other types of non-binary parameterized operation (for example pump speed, illumination intensity, operating temperature, etc.) under software control.

The system can be stepped through a sequence of steps comprising one or more such modes by listing the modes into an array or file which operates as a time-driven, event driven, or combined list of configurations. This will be referred to as a “script.”

Such a script can be organized, structured, and/or populated in various ways. As a few examples of this:
A script can be structured so that the steps are read out and enacted by the system, one after another, at periodic intervals. This type of script can be referred to as “time-driven” or “clock-driven;”
A script can be structured so that the steps are read out and enacted by the system, one after another, for a specific time interval provided in the script for that specific step. This type of script can be referred to as “duration-specified;”
A script can be structured so that the steps are read out and enacted by the system, one after another, after a specific time delay provided in the script for that specific step. This type of script can be referred to as “delay-specified;”
A script can be structured so that at least actions taken in at least some of the steps depend on specific conditions, for example ranges of sensor values and/or the value of one or more of outside control signal(s), user interface events, and user interface settings. This type of script, or aspect of a script, can be referred to as “conditional;”
A script can be structured to be purely time-driven, purely event-driven, or a combination of time-driven and event-driven aspects;

Many other types of scripts and script features of various levels of sophistication are of course possible and are anticipated and provided for in the invention. For example, the script can comprise conditional-logic statements, temporal-logic statements, calculation statements, etc. As another example, a script can comprise a multithreaded algorithm, real-time regulatory numerical control calculations, etc. For example
A script can be hierarchical in structure (for example, include subroutines, procedure calls, etc;
A script can specify states or parameters for specific elements and/or can specify states or parameters for “macros” defined above
Employing various approaches, a script could be regarded as a thread in a parallel or multitask system; alternatively, a script could be defined in a way to include multiple threads involved in the operation of a parallel or multitask system. Additionally, special multi-thread and parallel execution operations such as thread-split, thread rejoin/merge, parallel-“Do,” etc. can be included. The invention provides for scripts to include configuration information. Thus such a configuration-script can be created that includes conditional and/or time-driven reconfiguration events.

As an early step towards a standardizable framework for multi-step microfluidic control software, the present invention employs the use of scripts for representing multi-step microfluidic control software. The invention further provides an example script authoring tool. The invention further provides example (timer-including) script execution system for control outputs that can optionally include external control inputs and sensing inputs; one of these examples is configured to operate an example simulation, and the other is configured to operate one or more actual microfluidic device(s) and/or emulating prototypes.

### 9. Script Execution and Associated Control of Hardware and Software Systems

Scripts can be enacted or executed by an entity acting as a script reader. Such a script reader produces a temporal sequence of control signals or control messages directed to one or more target systems, for example a microfluidic system, a prototype fluidic system, an emulation of a fluidic system, a model of a fluidic system, a simulation of a fluidic system, a status-depicting visualization of a fluidic system, etc. as suggested in FIGS. 1 and 2 and as described in New Renaissance Institute U.S. Pat. No. 8,396,701 and pending U.S. patent application Ser. No. 13/757,662.

In some implementations, such a script reader can be additionally arranged to receive one or more of incoming control signals from a user interface, incoming actual sensor and status information from an actively-operating microfluidic device, incoming actual sensor and status information from an actively-operating microfluidic emulation system, incoming control signals from a simulation, incoming control signals from another executing process, or incoming control signals from other hardware or software entities.

In example implementations, a script reader can be formally interfaced to one or more of these commercial software systems, languages, and protocols:

Lab View™

Mathematica™

MatLab™

I²C

Serial Peripheral Interface (SPI)

Dallas One-Wire™

9.1 Interfacing with Microfluidic Devices and Systems and Their Control from Control Scripts

The invention provides for interfacing with a script reader and for the control of individual microfluidic devices from the execution of scripts. Such arrangements are suggested in FIGS. 1 and 2 and are described in New Renaissance Institute U.S. Pat. No. 8,396,701 and pending U.S. patent application Ser. No. 13/757,662.

The script reader executes a provided script that is compatible with the design, features, control message set, and any sensing message set associated with the particular microfluidic device to be interfaced.

Interfacing with and operation of software-controlled microfluidic devices and system technologies are discussed in at least the following New Renaissance Institute U.S. Pat. No. 8,396,701 “Software Systems for Development, Control, Programming, Simulation, and Emulation of Fixed and Reconfigurable Lab-on-a-Chip Devices.”

In an aspect of the invention, the script reader can be responsive to resource allocations. In another aspect of the invention, script reader can provide resource allocations. In yet another aspect of the invention, the script reader produces temporal sequences of control signals for operating microfluidic devices, emulation hardware, simulation software, process visualization, etc. In still another aspect of the invention, the script reader can be responsive to real-time regulatory control calculations.

9.2 Visualization Systems and Their Control from Control Scripts

The invention provides for interfacing with the same script reader and for the control of visualization systems from the execution of scripts. Such arrangements are suggested in FIGS. 1 and 2 and are described in New Renaissance Institute U.S. Pat. No. 8,396,701 and pending U.S. patent application Ser. No. 13/757,662.

The script reader executes a provided script that is compatible with the design, features, control message set, and any sensing message set associated with the particular microfluidic device to be visualized.

Visualization graphics can be abstract, schematic, representational, or combinations of these. Visualizations of fluid flows and fluid accumulations that respond directly to only control messages from the script reader can often be stateless (memoryless) and avoid calculations, but for all but the simplest visualizations some state and some calculation is needed to graphically convey for example the evolving locations of the heads and tails of fluid flows, the amount of fluids in reaction chambers and reservoirs after flow events, etc.

In one implementation, the visualization system directly accepts and directly renders from the control message set that would be used to control the particular microfluidic device to be visualized. In another implementation, the visualization system receives translated control message produced by a message translator which in turn directly accepts and renders from the control message set that would be used to control the particular microfluidic device to be visualized.

Additionally:
the visualization system can be arranged to receive actual sensor and status information from an actual microfluidic device that can be operated in parallel from very same control messages, so that the visualization system and actual microfluidic device are simultaneously controlled by the output from the script reader;
the visualization system can be arranged to receive simulated sensor and status information from a simulation of the same microfluidic device that the visualization system represents, with the simulation system and visualization system operated in parallel from very same control messages, so that the visualization system and simulation system are simultaneously controlled by the output from the script reader.
the visualization system can be arranged to receive emulated sensor and status information from a hardware emulation of the same microfluidic device that the visualization system represents, with the emulation system and visualization system operated in parallel from very same control messages, so that the visualization system and emulation system are simultaneously controlled by the output from the script reader.
Any two or more of these arrangements can also be combined in various ways; for example part of a process could be emulated and another part could be simultaneously simulated.

Functional interfacing with and operation of rendered visualizations of software-controlled microfluidic devices and system technologies are discussed in at least New Renaissance Institute U.S. Pat. No. 8,396,701 “Software Systems for Development, Control, Programming, Simulation, and Emulation of Fixed and Reconfigurable Lab-on-a-Chip Devices.”

9.3 Simulation Systems and Their Control from Control Scripts

The invention provides for interfacing with the same script reader and for the control of simulation systems from the execution of scripts. Such arrangements are suggested in FIGS. 1 and 2 and are described in New Renaissance Institute U.S. Pat. No. 8,396,701 and pending U.S. patent application Ser. No. 13/757,662.

The script reader executes a provided script that is compatible with the design, features, control message set, and any sensing message set associated with the particular microfluidic device to be simulated.

In one implementation, the simulation system directly accepts and directly renders from the control message set that would be used to control the particular microfluidic device to be simulated. In another implementation, the simulation system receives translated control message produced by a message translator which in turn directly accepts and renders from the control message set that would be used to control the particular microfluidic device to be simulated.

Additionally:
the simulation system can be arranged to receive actual sensor and status information from an actual microfluidic device that can be operated in parallel from very same control messages, so that the simulation system and actual microfluidic device are simultaneously controlled by the output from the script reader;
the simulation system can be arranged to receive emulated sensor and status information from a hardware emulation of the same microfluidic device that the simulation system represents, with the emulation system and simulation system operated in parallel from very same control messages, so that the simulation system and emulation system are simultaneously controlled by the output from the script reader.
the simulation system can be arranged to provide simulated sensor and status information to a conditional software and macros provided by the output from the script reader;
the simulation system can be arranged to provide simulated sensor and status information to a visualization of the same microfluidic device that the visualization system represents, with the simulation system and visualization system operated in parallel from very same control messages, so that the visualization system and simulation system are simultaneously controlled by the output from the script reader.
Any two or more of these arrangements can also be combined in various ways; for example, part of a process could be emulated and another part could be simultaneously simulated.

Functional interfacing with and operation of simulations of software-controlled microfluidic devices and system technologies are discussed in at least New Renaissance Institute U.S. Pat. No. 8,396,701 “Software Systems for Development, Control, Programming, Simulation, and Emulation of Fixed and Reconfigurable Lab-on-a-Chip Devices.”

9.4 Interfacing with Emulation Systems and Their Control from Control Scripts

The invention provides for interfacing with the same script reader and for the control of fluidic emulation systems from the execution of scripts. Such arrangements are suggested in FIGS. 1 and 2 and are described in New Renaissance Institute U.S. Pat. No. 8,396,701 and pending U.S. patent application Ser. No. 13/757,662.

Software-controlled emulation of microfluidic system technologies are discussed in at least the following New Renaissance Institute U.S. patents and Applications:
U.S. Pat. No. 8,560,130 “Software-Controlled Lab-on-a-Chip Emulation”
U.S. Pat. No. 9,802,190 “Modular computer-controlled multistep chemical processing system for use in laboratory automation or chemical production spanning a plurality of scales”
U.S. Pat. No. 8,594,848 “Reconfigurable Chemical Process Systems”
U.S. patent application Ser. No. 15/717,024 “Modular Computer-Controlled Multistep Chemical Processing System for Use in Laboratory Automation or Chemical Production” (PGP 2018/0015463)
U.S. Pat. No. 8,396,701 “Software Systems for Development, Control, Programming, Simulation, and Emulation of Fixed and Reconfigurable Lab-on-a-Chip Devices.”

The present invention provides for interfacing with an emulation system configured to emulate another fluidic system. In some embodiments the emulating system can comprise sensors or other measuring instruments. In some embodiments the emulating system can interface with sensors or other measuring instruments. In some embodiments, signals or measurements from sensors or other measuring instruments comprised by and/or interfacing with the emulating system can provided to a user interface. In some embodiments, signals or measurements from sensors or other measuring instruments comprised by and/or interfacing with the emulating system can recorded and stored, for example in the form of a recorded and/or stored in a file, for example, as an event log file, data-log file, data stream file, recorded animation graphic, etc.

Additionally:
The emulation system can be arranged to receive actual sensor and status information from an actual microfluidic device that can be operated in parallel from very same control messages, so that the simulation system and actual microfluidic device are simultaneously controlled by the output from the script reader;
the emulation system can be arranged to receive emulated sensor and status information from a simulation of the same microfluidic device that the emulation system represents, with the emulation system and simulation system operated in parallel from very same control messages, so that the simulation system and emulation system are simultaneously controlled by the output from the script reader.
The emulation system can be arranged to provide measured sensor and status information to a conditional software and macros provided by the output from the script reader;
The emulation system can be arranged to provide measured sensor and status information to a visualization of the same microfluidic device that the visualization system represents, with the simulation system and visualization system operated in parallel from very same control messages, so that the emulation system and simulation system are simultaneously controlled by the output from the script reader.
Any two or more of these arrangements can also be combined in various ways; for example part of a process could be emulated and another part could be simultaneously simulated.

Further along the same lines of consideration:
In some embodiments, the invention provides for both interfacing with an emulation system and a model and/or numerical simulation.
In some embodiments, part of a fluidic system under design, review, or analysis can be partially emulated and partially modeled and/or numerically simulated.
In some embodiments, part of a fluidic system under design, review, or analysis can be simultaneously emulated and modeled and/or numerically simulated.

Functional interfacing with and operation of emulations of software-controlled microfluidic devices and system technologies are discussed in at least New Renaissance Institute U.S. Pat. No. 8,396,701 “Software Systems for Development, Control, Programming, Simulation, and Emulation of Fixed and Reconfigurable Lab-on-a-Chip Devices.”

9.5 Interfacing with Combinations of Two or More of Microfluidic Devices, Emulation Systems, and Simulation Systems and their Control from Shared Control Scripts

The invention provides for interfacing with combinations of two or more of microfluidic devices, emulation systems, visualization systems, and/or simulation systems and their control from shared control scripts as suggested in FIGS. 1 and 2 and as described in New Renaissance Institute U.S. Pat. No. 8,396,701 and pending U.S. patent application Ser. No. 13/757,662. Additional examples of this have been provided in sections 8.1-8.4. Further variations and combinations, for example involving multiple microfluidic simulations and/or multiple microfluidic devices and/or multiple microfluidic emulations each relating to distinct portions of an overall system under development, are anticipated and are provided for by the invention.

### 10. Example Combined Authoring, Editing, and Visualization Tools and Example User Experiences

The invention provides for authoring tools for the creation of scripts and editing tools for the modification of scripts. The invention additionally provides for models and/or numerical simulation tools for examining and/or confirming aspects of the execution of scripts. In some embodiments the outputs of a model and/or numerical simulation can drive real-time graphical visualizations, auditory indications, etc. In some embodiments the outputs of a model and/or numerical simulation can be recorded and/or stored in a file, for example, as an event log file, data-log file, data stream file, recorded animation graphic, etc. In some embodiments, information store in a file can additionally or alternately include:

measurements;

calculated qualities;

model outputs;

simulation outputs;

interpreted data;

user annotations.

The invention further provides for authoring tools and editing tools to comprise a status-depicting graphic or visualization of a fluidic system for examining and/or confirming aspects of the execution of scripts. The status-depicting graphic can be driven only from the script, or in some embodiments comprise graphic representation of one or more of:

measurements;

calculated qualities;

model outputs;

simulation outputs;

interpreted data;

user annotations.

FIGS. 87-95 depict a first simple example user interface and example script authoring user experience. The depicted software authoring and editing tool was used in a similar way to create the operating scripts for lab-table-scale fluidic system emulations of examples provided earlier in the present patent application.

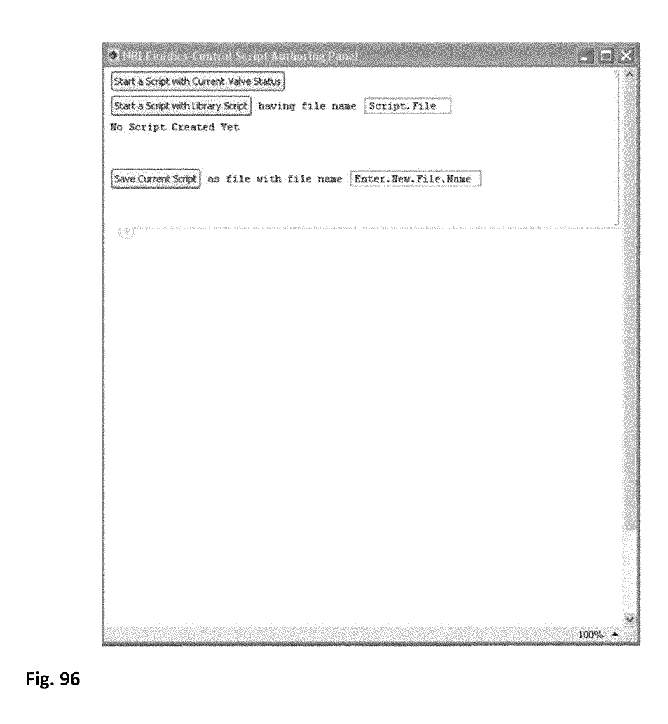

FIGS. 96-103 depict a second example user interface and example user experience that entails the creation, use, editing, and storage of new scripts as well as the importing of, incorporation of, and editing of previously created scripts and library elements.

Additionally, the example user interface and user experiences depicted in FIGS. 87-95 and 97 include authoring and editing tools in the lower portion and a simple real-time (state-less, schematic-style) fluidic process visualization that respond to each authoring or editing action and further responds to the execution of a script in real time. It turns out to be extremely useful to have at least this level of fluidic process visualization responsive to each authoring or editing action during script creating, and further responds to the execution of a script in real time during refinement, modification, and debugging of an authored script.

### 10.1 First Example Temporal and Event-Driven Control Sequence Script Authoring and Editing Tools

FIGS. 87-95 depict a first simple example user interface and example script authoring user experience. Each added step invokes process-step or configuration commands, and a slider (which for example overridden by a numerical entry field) or other input means can be used to set the time duration until a next step is taken in the script. Step-by-step a script is built up by this process. Note an existing step or selected group/range of steps can be copied and pasted as a next step in the script, appended to the script beginning. Also any existing step can be later edited or deleted altogether.

FIGS. 87-95 depict an example structure and operation of example temporal and event-driven control sequence scripting, functional libraries, and script creation tools implementations.

FIG. 87 depicts a selected computer screen shot of the fluidics system software created using “Mathematica.” Once the software is launched, the keys “shift” and “enter” are pressed and the picture of the 4 units with their 8 ports is shown with the 8 SPDT valves on the right side of the 4 units. On the top of the valves picture, 5 rows of 8 little squares can be selected to open the valves. Row 1 represents unit 1 with its 8 ports in the increasing order of port 1 on the left side and port 8 on the right side. The same way, units 2, 3, and 4 are represented in row 2, 3, and 4 respectively. The last row represents the 8 SPDT valves connected to the units 1-4. The 8 squares in row 5 represent in the following order T1, T2, T3, T4, T5, T6, T7, and T8 which are connected to U₁-7, U₁-8, U₂-7, U₂-8, U₃-7, U₃-8, U₄-7, and U₄-8 respectively.

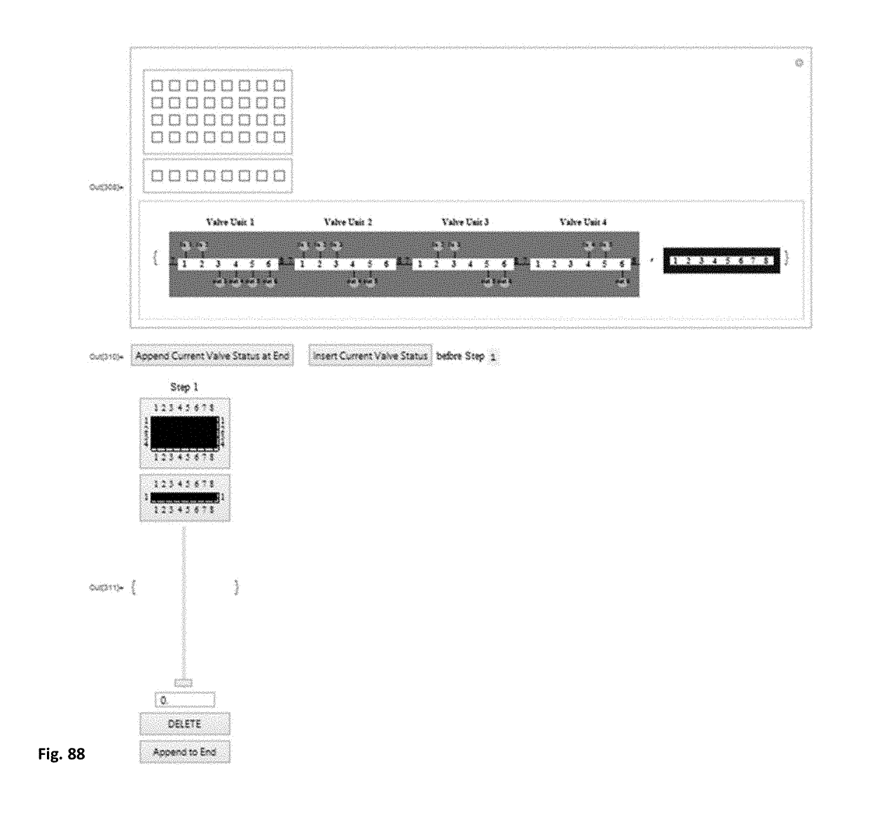

FIG. 88 depicts a selected computer screen shot of the fluidic system software after selecting the first step of the script by clicking on the “Start a Script with Current Valve Status”. In this first step none of the valves are selected as in the default setting. An image of 2 black rectangular appears showing that none of the valves are selected. The different steps can be deleted by clicking “delete” or duplicated at the end by clicking “Append to End”. This represents the idle state of the fluidic bus transport where all ports 7 and ports 8 are connected to the NO port of all SPDT valves.

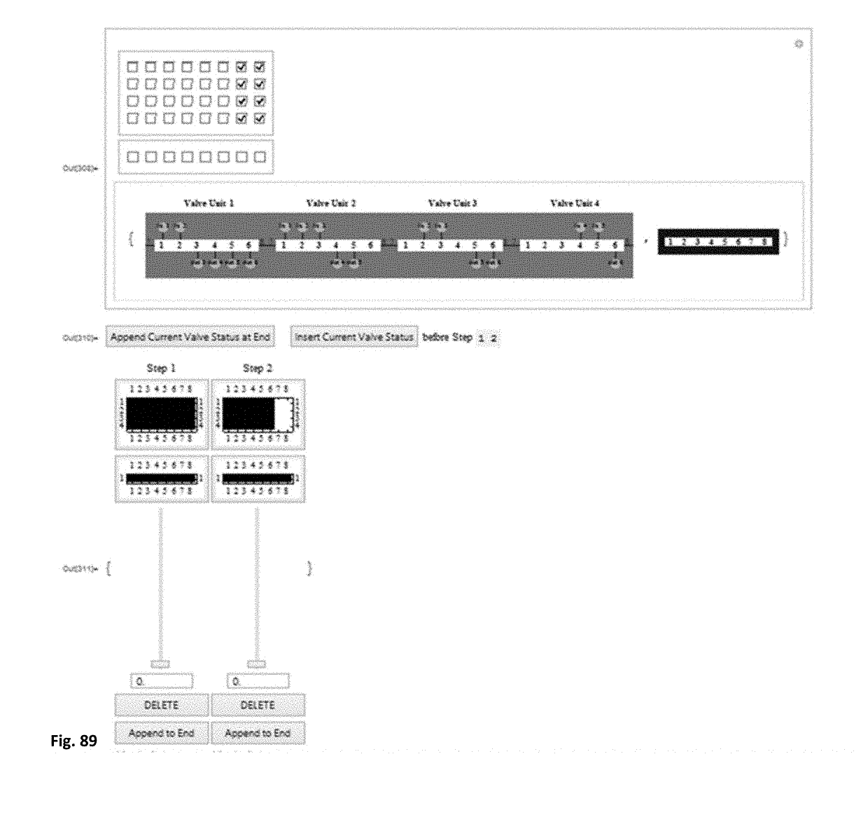

FIG. 89 depicts a selected computer screen shot of the fluidic system software after selection of the second step of the script. This second step shows that all ports 7 and ports 8 of the 4 units are selected. On the main valves picture, the selected valves are colored in red. After clicking on the “Append Current Valve Status at End”, the step 2 image appears on the right side of the step 1 image. The blank in the black rectangular image of step 2 represents the open ports 7 and open ports 8 of the 4 units. This also represents the idle state of the fluidic bus transport where all ports 7 and ports 8 are connected to the NC port of all SPDT valves.

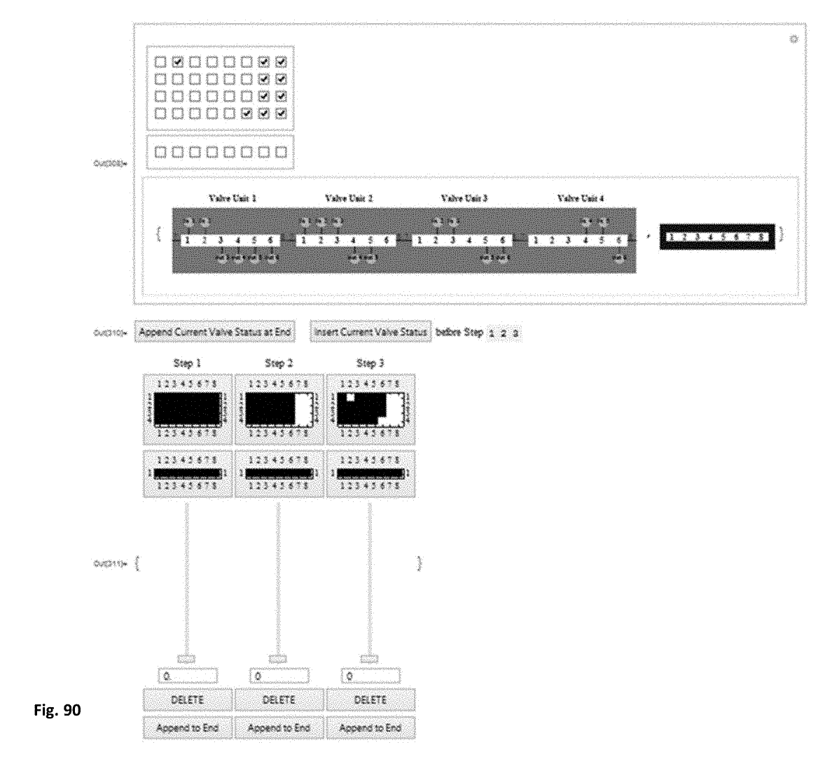

FIG. 90 depicts a selected computer screen shot of the fluidic system software after selection of the third step of the script. This third step shows that in addition to all ports 7 and 8 of all 4 units, U₁-2 and U₄-6 are selected as well. After clicking on the “Append Current Valve Status at End” the step 3 image appears next to the step 2 with the blank representing the corresponding open valves. This represents the fluid flow state of the fluidic bus transport. Note that different(s) step(s) can be inserted before any step already written by clicking on the “Insert Current Valve Status—before step . . . ”.

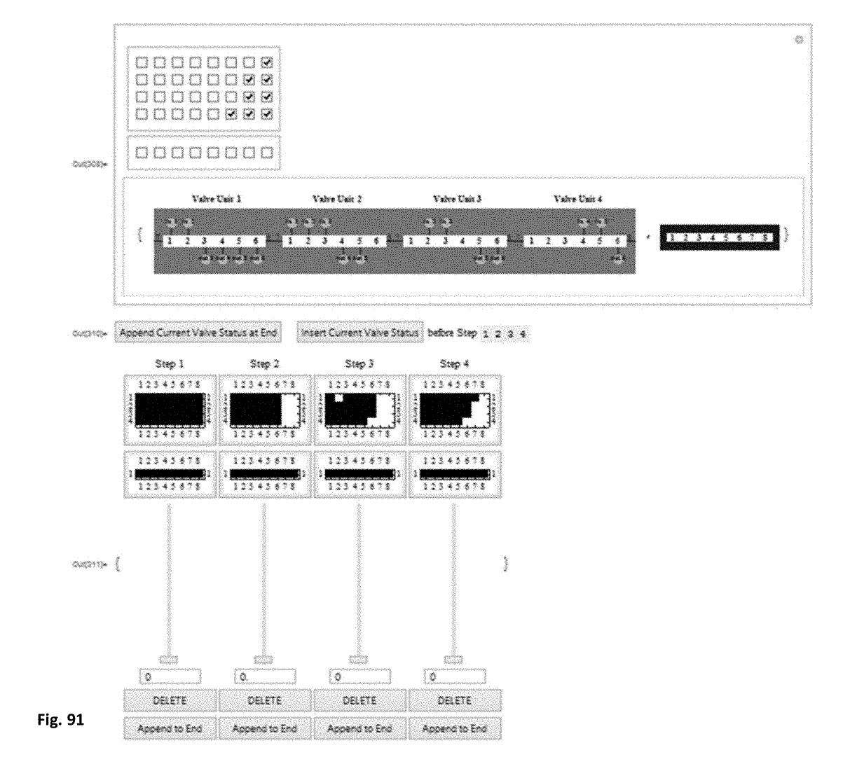

FIG. 91 depicts a selected computer screen shot of the fluidic system software after selection of the fourth step of the script. In this fourth step U₁-2 and U₁-7 are unselected leaving its represented square blank again. This represents the gas-pressure clearing state of the fluidic bus transport.

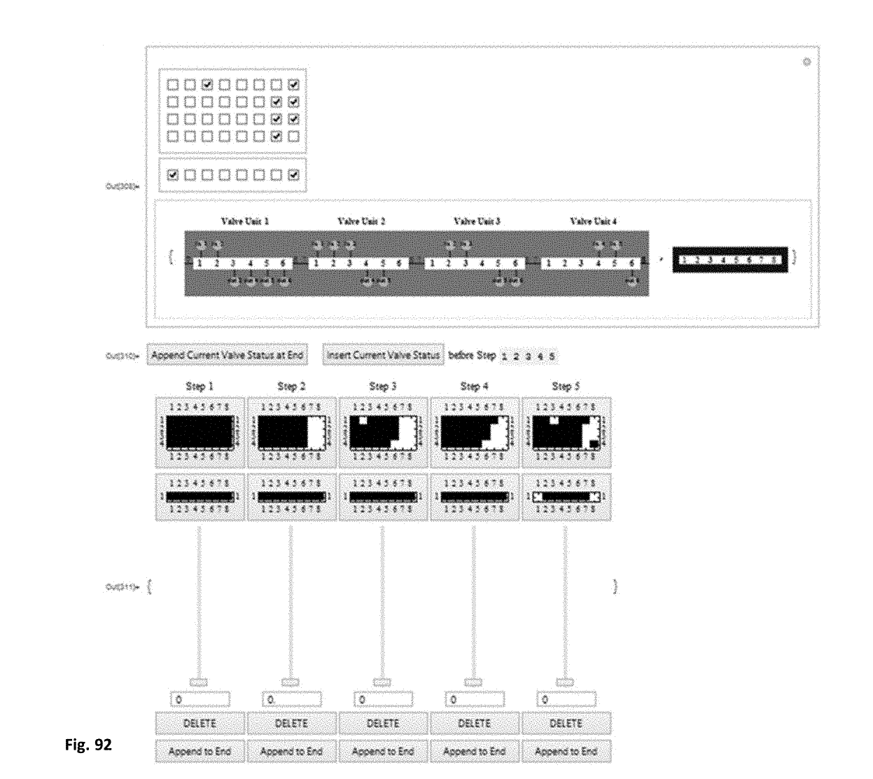

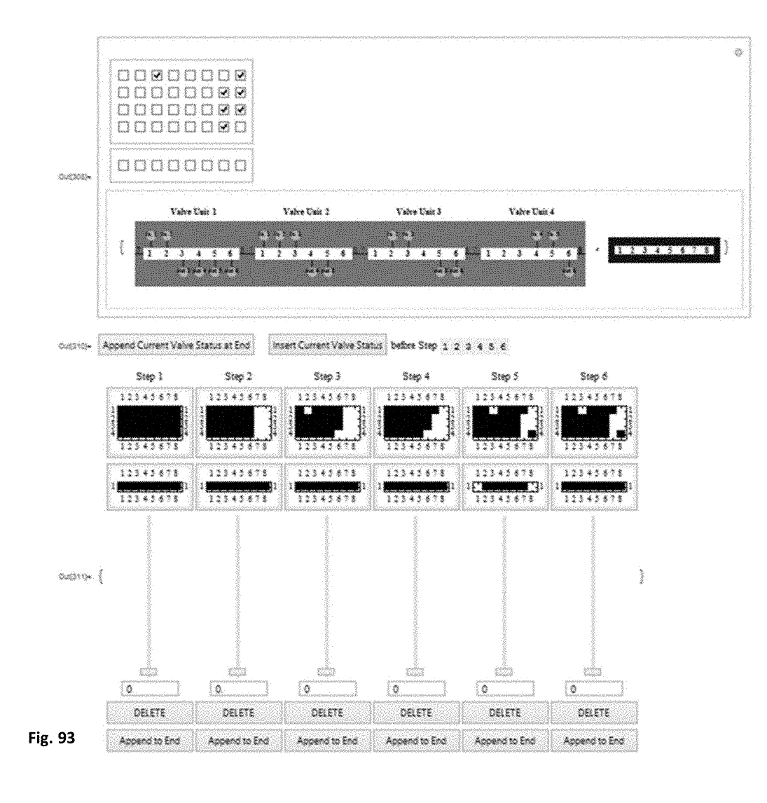

FIG. 92 depicts a selected computer screen shot of the fluidic system software after selection of the fifth step of the script. In this Fifth step U₁-3, T1, and T2 are selected and U₄-8 is unselected. This represents the solvent-based cleaning state of the fluidic bus transport.

FIG. 93 depicts a selected computer screen shot of the fluidic system software after selection of the sixth step of the script. In this sixth step T1 and T2 are unselected. This represents the gas-based drying state of the fluidic bus transport.

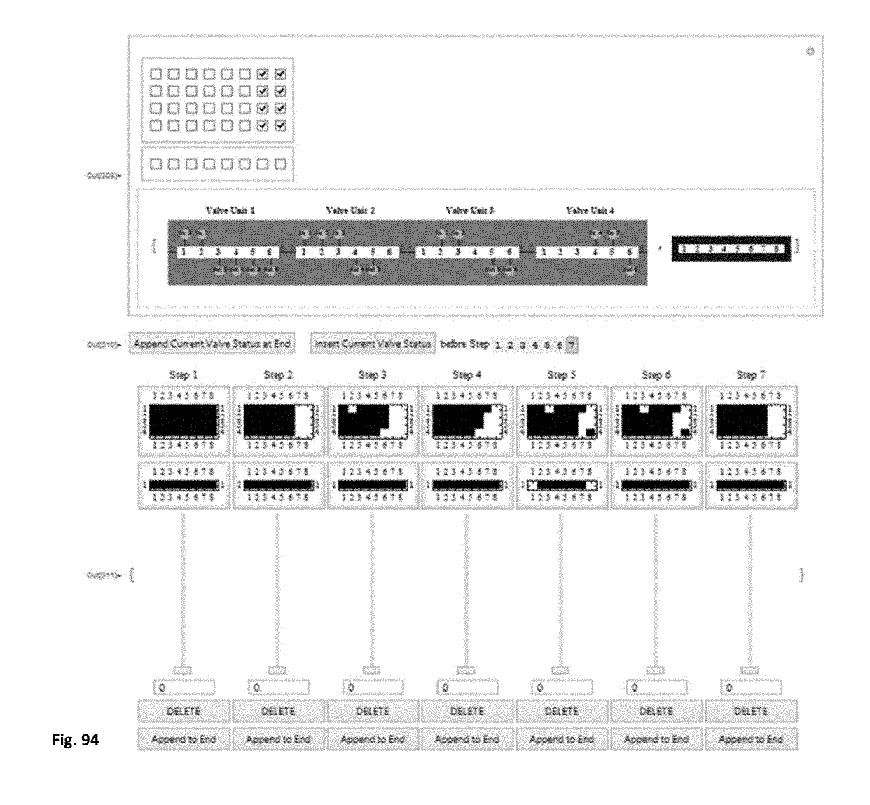

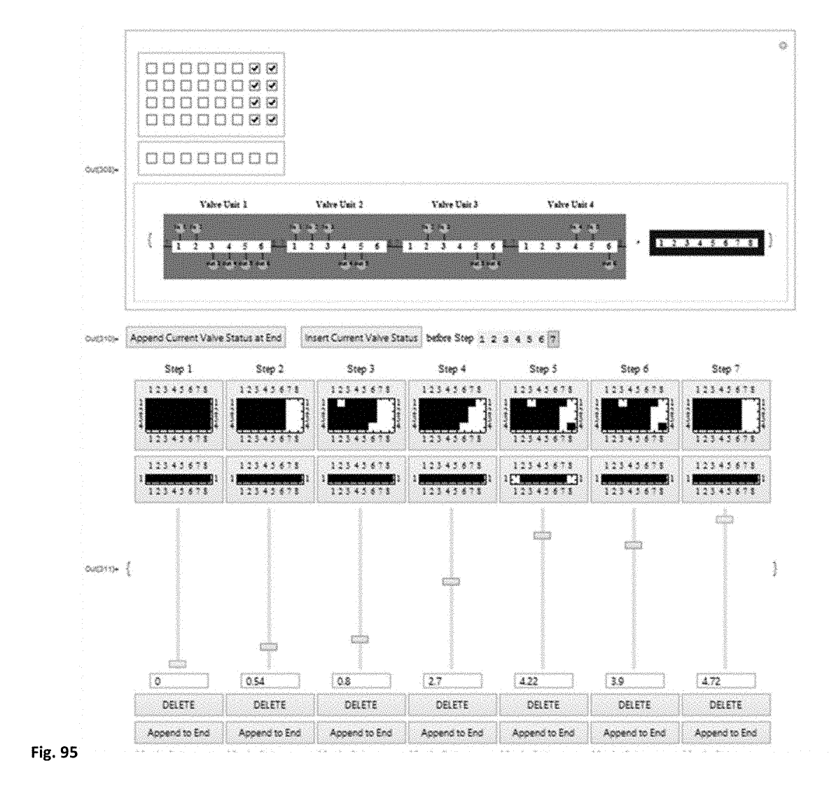

FIG. 94 depicts a selected computer screen shot of the fluidic system software after selection of the seventh step of the script. In this seventh step the valves U₁-7 and U₄-8 are selected again to go back to the idle state of FIG. 89.

FIG. 95 depicts a selected computer screen shot of the fluidic system software after selection of time (sec) for each step. In this software the time chosen under each step will be the time gap before that same step starts. In this particular example all the times are chosen, in order, as:

Step 1 duration: 0 seconds

Step 2 duration: 0.54 seconds

Step 3 duration: 0.8 seconds

Step 4 duration: 2.7 seconds

Step 5 duration: 4.22 seconds

Step 6 duration: 3.9 seconds

Step 7 duration: 4.72 seconds.

The above provides only an example user experience; many variations in actions, results, display, format, appearance, etc. are of course possible and are provided for by the invention.

Although the examples shown above are entirely time-driven, extensions can be provided to respond to sensor measurements, user interface controls, analog control system outputs, and other input stimulus that can be used for event-driven process control. Additionally, scripts can be supplemented to invoke function calls to external software process. Further, scripts can also be supplemented (as mentioned above) to receive outputs and interrupts from external software process.

In example implementations, the authoring and editing tools and/or script readers can be formally interfaced to one or more of these commercial software systems, languages, and protocols:

Lab View™

Mathematica™

MatLab™

I²C

Serial Peripheral Interface (SPI)

Dallas One-Wire™

### 10.2 Second Example Temporal and Event-Driven Control Sequence Scripting, Functional Libraries, and Script Creation Tools Implementations

FIGS. 96-103 depict a second example user interface and example user experience that supports the creation, use, editing, and storage of new scripts as well as the importing of, incorporation of, and editing of previously created scripts and library elements.

FIG. 96 depicts example content of a scripting window at the start of an authoring and/or editing session wherein nothing has yet been created or imported. The current state of a specified step can be used to start a script, Alternatively, a stored previously created script or stored library element can be imported and used to create a script. After importing, a stored previously created script or stored library element can be edited if needed.

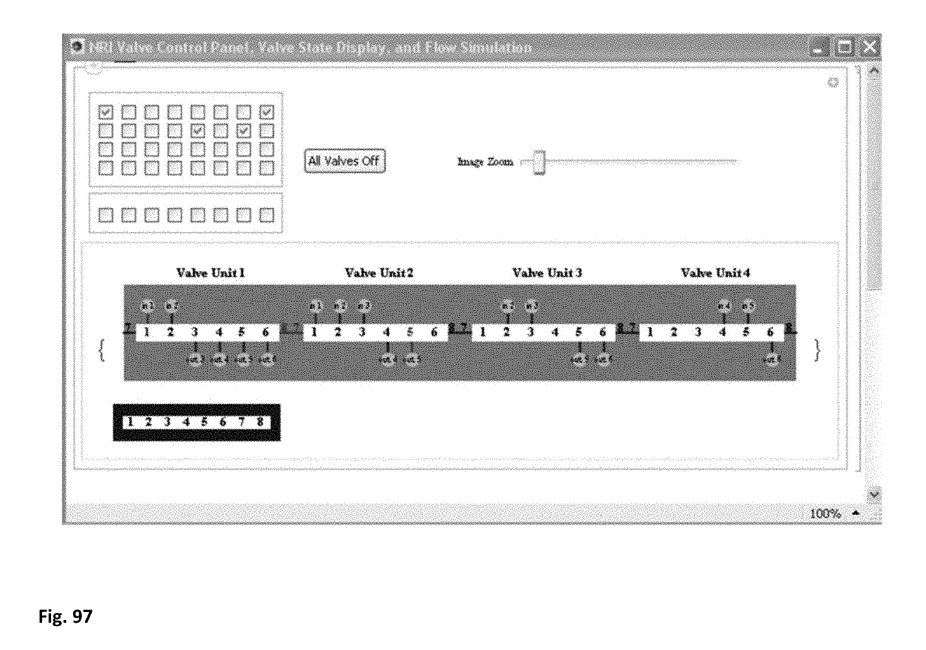

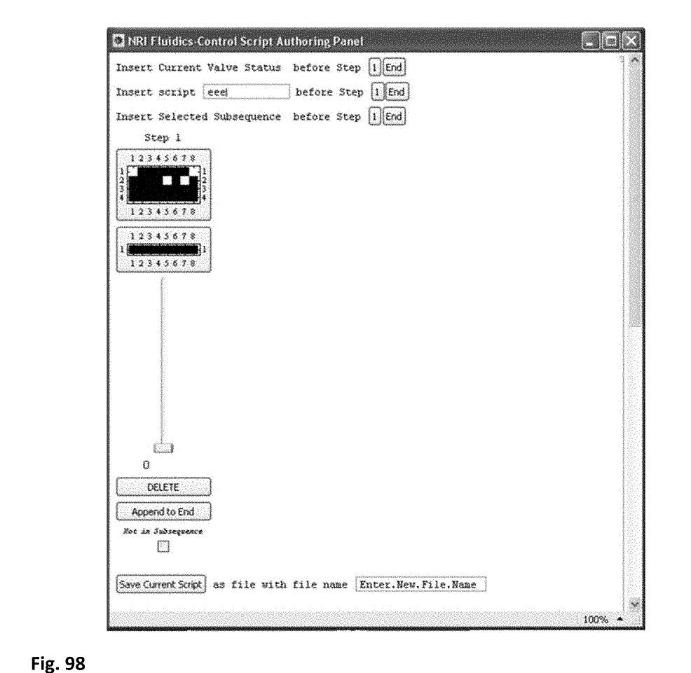

FIG. 97 depicts a visualization of an example specification of an example first step in a script to be created. The specification of this step can be done, as shown here, in a window that is different and separate from the scripting window of FIG. 96.

FIG. 98 depicts the result of an example capture of the current state of the example first step created by user interaction actions and operations associated with FIG. 97. Graphics depicting the state can be display as shown. In an embodiment, the graphic can also operate as a “pushbutton” to at a later time recall this state for reuse in current or subsequently edited form. A temporal quantity, such as step time-duration or pre-step time-delay, can be entered at this time or a later time, either by means of the graphically-responsive user interface slider or by selecting the numerical quantity beneath the slide (shown here as “0”) and typing a numeric time value. In an example embodiment, a positive numeric time value exceeding the range of the slider can be entered by typing in a value in this manner.

Additionally, FIG. 98 also depicts the result of a user typing “eee” in a field associated with the import of a previously-created script or library element. The user could insert the sequence of steps in previously-created “eee” either before the current step 1 by selecting the “1” button depicted or after the current step 1 by selecting the “End” button.

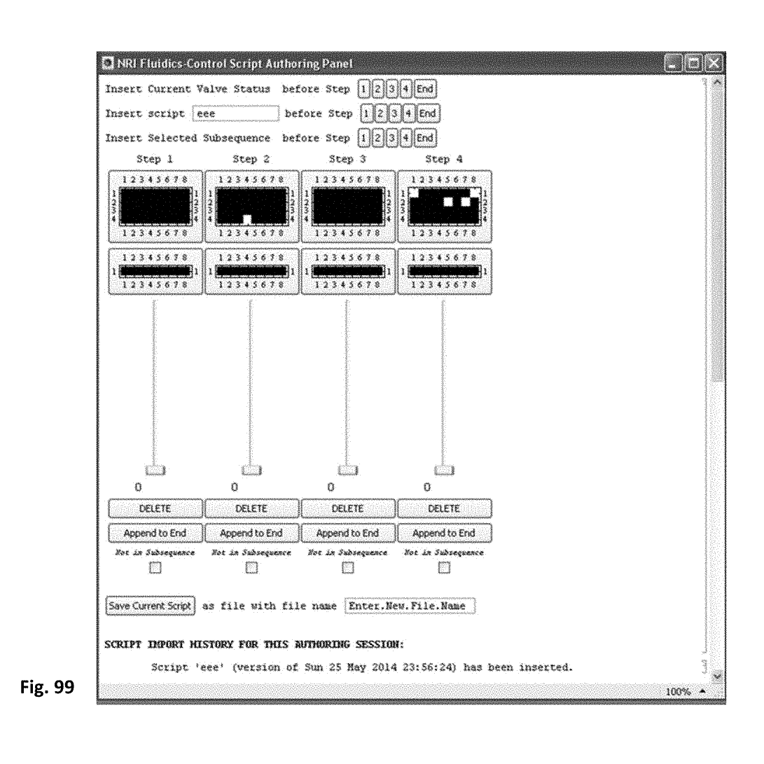

FIG. 99 depicts the result of executing the import of a three-step previously-created script or library element “eee” that had been entered in FIG. 98 by selecting the “1” button. The three steps of previously-created script or library element “eee” have now as a result been inserted prior to the former step 1, and the former step 1 is now step 4 of a four-step script. In this example previously-created script, the temporal specification for each step had been stored having zero values, but in various embodiments non-zero time values can be stored and automatically or selectively retrieved when a previously-created script or library element is imported. In some embodiments, details of the importing of the previously-created script or library element can be displayed, for example as shown in FIG. 99.

Note further in FIG. 99 that any of the four steps in the four-step script can be deleted or appended to the end of the current script. Additionally, an ordered subsequence of any subset of the entire script (or the full script itself) can be selected (for use in later editing) by clicking on the small boxes under the text “Not in Subsequence.” When such a box is clicked, the text can be configured to change to provide indication signifying that step is now designated as an element of the selected subsequence. Note the user interface options for appending the selected sequence, the current valve state in the user interface such as that depicted in FIG. 97 can be added prior to any step in the current script or at the end of the current script.

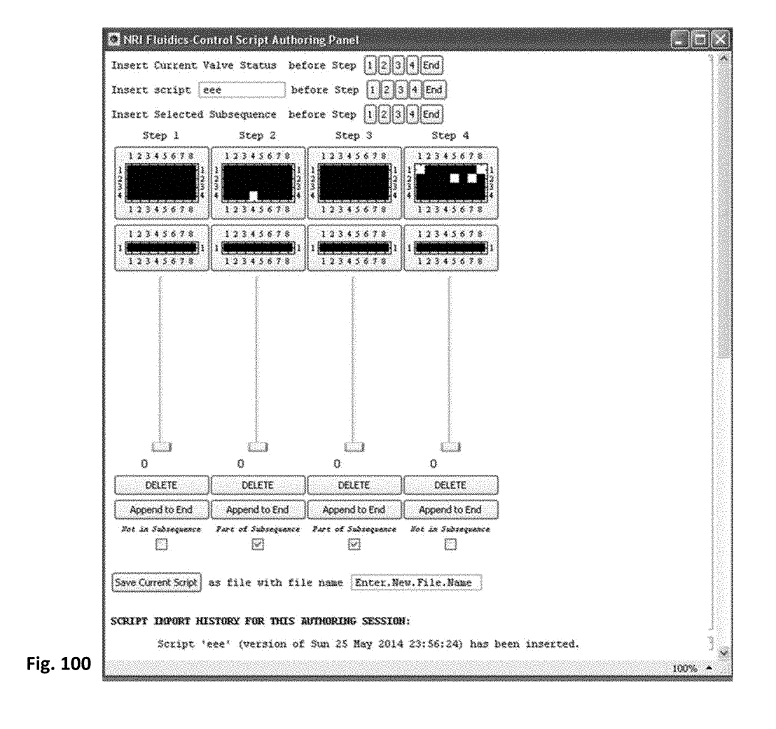

FIG. 100 depicts an example result of selecting of steps 2 and 3 as part of a subsequence that can be used in later editing. Note these selected steps (2 and 3) display text signifying that those steps are now designated as elements of the subsequence. (Other user-selected choices can be freely supported—for example steps 2 and 4 could have been selected (skipping step 3), as well as all of steps 1-4 so as to copy the entire script.)

FIG. 101 depicts an example result of selecting to insert the subsequence (selected in FIG. 100) at the end of the current script depicted in FIG. 99. Note that copies of the selected steps (2 and 3) are appended in the same order at the end of the previous four-step script, making the script now six steps in length.

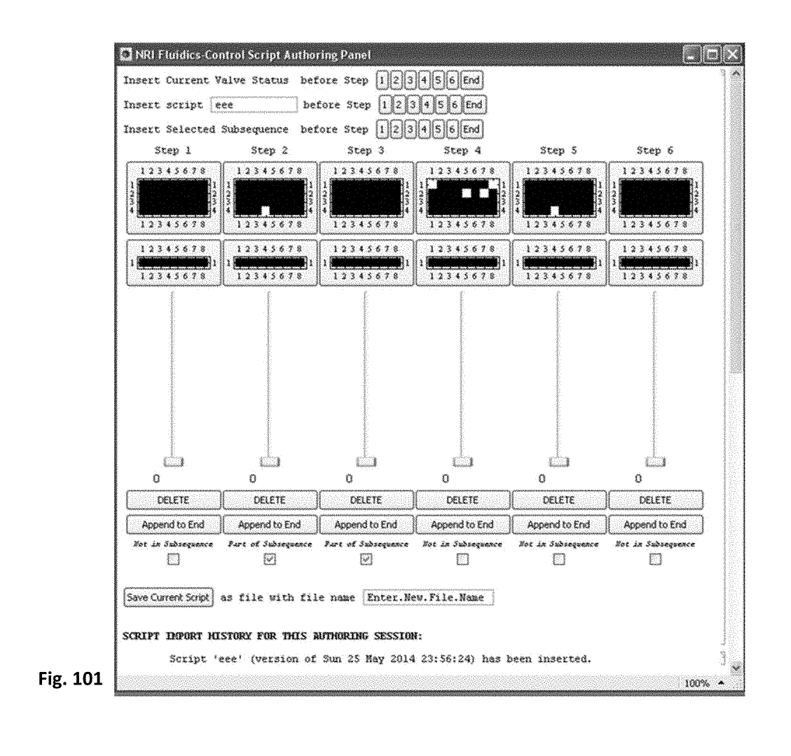

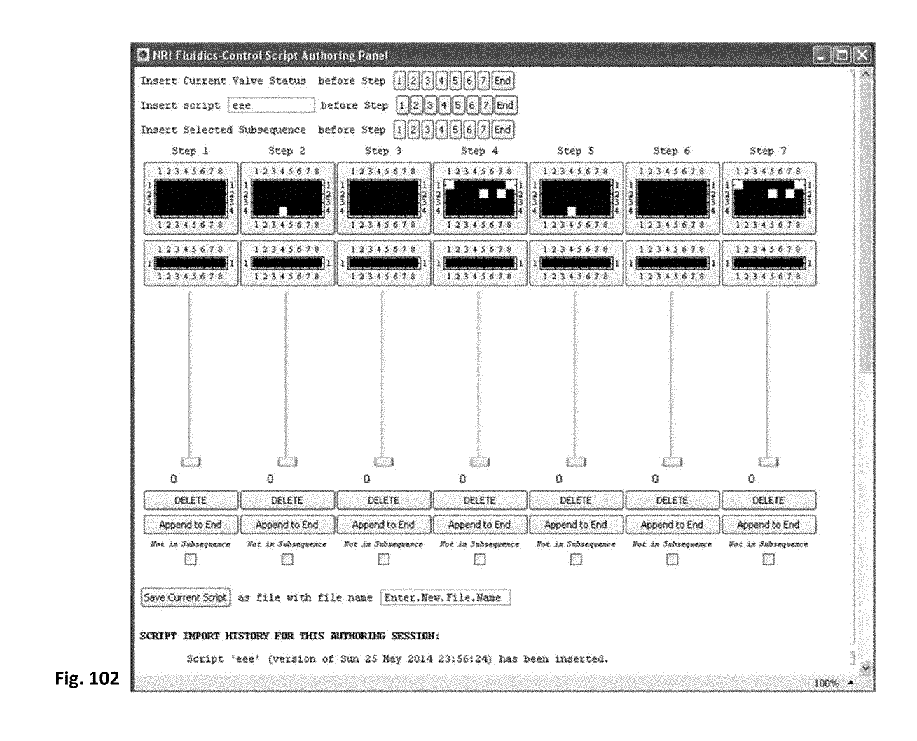

FIG. 102 depicts an example result of selecting to append a copy of step 4 at the end of the six-step script depicted in FIG. 101.

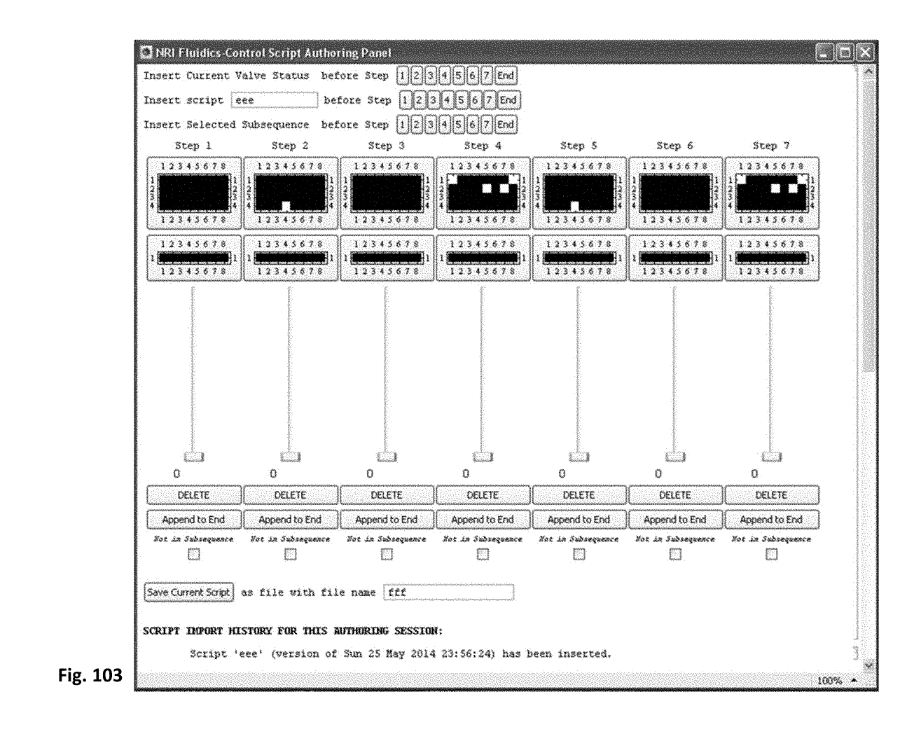

FIG. 103 depicts the result of a user typing the text string “fff” in a field associated with saving the current script. Upon clicking the “Save Current Script” button, the current seven-step script will be saved with a filename comprising “fff” or other naming use of this text string.

The above provides only an example user experience; many variations in actions, results, display, format, appearance, etc. are of course possible and are provided for by the invention.

### INVENTOR ATTRIBUTIONS

Inventor Ying Chen worked on prototype construction and on extensive coding of the simulator graphics rendering software using Mathematica. Inventors Catherine Luk and Sulu Lalchandani worked on prototype construction, and the engineering, scripting, and documentation of the detailed operational examples provided in this patent specification. All other aspects of the invention are due to the first-named inventor.

### CLOSING REMARKS

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

While the invention has been described in detail with reference to used embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be, considered in all respects as illustrative and not restrictive, the scope of the invention being indicated by the appended claims rather than by the foregoing description and all changes which come within the meaning and range of equivalency of the claims are therefore intended to be embraced therein.

Although exemplary embodiments have been provided in detail, various changes, substitutions and alternations could be made thereto without departing from spirit and scope of the disclosed subject matter as defined by the appended claims. Variations described for the embodiments may be realized in any combination desirable for each particular application. Thus particular limitations and embodiment enhancements described herein, which may have particular advantages to a particular application, need not be used for all applications. Also, not all limitations need be implemented in methods, systems, and apparatuses including one or more concepts described with relation to the provided embodiments. Therefore, the invention is properly to be construed with reference to the claims.

Further, a program can be stored and provided to a computer using any type of non-transitory computer readable media. Non-transitory computer readable media may include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be also provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

What is claimed is:

1. A system for software-controlled transport and operation processes for microfluidic systems that comprise a plurality of controllable elements, each of the controllable elements controlled by a control signal, the control signal comprising at least two control values, the system comprising:
a data structure comprising a plurality of data values, each value associated with a particular controllable element from the plurality of controllable elements, the value in the data structure for controlling the control value of a control signal to be generated at a later time;
a first instance of the data structure comprising a first plurality of data values;
a second instance of the data structure comprising a second plurality of data values;
a list of a plurality of instances of the data structure, the list comprising at least the first instance of the data structure and second instance of the data structure, the list further comprising one or both of at least a time value and at least a conditional statement; and
a computational processor for executing an algorithm, the computational processor and algorithm arranged to process the list of pluralities of instances of the data structure and responsive to the list to produce a plurality of control signals for providing to the plurality of controllable elements within the microfluidic system,
wherein the computational processor and algorithm are further configured so that the control values comprised by one or more control signals that are associated with an instance of the data structure are responsive to the plurality of data values comprised by that instance of the data structure, and
wherein the one or more control signals that are associated with that instance of the data structure begin transmission to the microfluidic device at a time determined by the computational processor and algorithm, the transmission time determination responsive to one or both of the at least a time value and the at least a conditional value.

2. The system of claim 1, wherein the list does not include a time value.

3. The system of claim 1, wherein each instance of at least some of the data structures comprised by the list is associated with a separate individual time value.

4. The system of claim 1, wherein the time value represents a time duration from an incoming starting indication.

5. The system of claim 1, wherein the time value represents a time duration from time of the transmission of the at least one control signal associated with a previous instance of the data structure in the list and the beginning of the transmission of the at least one control signal associated with a next instance of the data structure in the list.

6. The system of claim 1, wherein the list does not include a conditional statement.

7. The system of claim 1, wherein the computational processor and algorithm are arranged to be able to receive and respond to incoming input information.

8. The system of claim 7, wherein each instance of at least some of the data structures comprised by the list is associated with a separate individual conditional statement.

9. The system of claim 8, wherein the transmission of at least one control signal associated with an instance of the data structure in the list begins after at least some received input information satisfies the conditional statement associated with that instance of the data structure.

10. The system of claim 9, wherein the transmission of at least one control signal associated with an instance of the data structure in the list does not begin until after a time condition responsive to a time value in the list is also satisfied.

11. The system of claim 1, wherein the list further comprises temporal-logic.

12. The system of claim 1, wherein the list further comprises calculations.

13. The system of claim 1, wherein the list further comprises a hierarchical structure.

14. The system of claim 1, wherein the list further comprises a subroutine.

15. The system of claim 1, wherein the list further comprises a macro operation.

16. The system of claim 1, wherein the list further comprises a macro.

17. The system of claim 1, wherein the list further comprises a multi-thread operation.

18. The system of claim 1, wherein the list further comprises a parallel execution operation.

19. The system of claim 1, wherein the list further comprises a procedural call.

20. The system of claim 1, wherein each control signal is transmitted as a control message.
